(19) United States
(12) Patent Application Publication
(10) Pub. No.: US 2026/0001980 A1
(43) Pub. Date: Jan. 1, 2026

(54) MOLECULARLY ENGINEERED BRUSH-LIKE GRAFT COPOLYMERS AND COMPOSITIONS AND METHODS THEREOF

(71) Applicant: The University of North Carolina at Chapel Hill, Chapel Hill, NC (US)

(72) Inventors: Erfan DASHITIMOGHADAM, Chapel Hill, NC (US); Andrew KEITH, Chapel Hill, NC (US); Mohammad V. VARNOSFADERANI, Chapel Hill, NC (US); Sergei S. SHEIKO, Chapel Hill, NC (US); Mitchell MAW, Chapel Hill, NC (US)

(73) Assignee: The University of North Carolina at Chapel Hill, Chapel Hill, NC (US)

(21) Appl. No.: 19/113,830

(22) PCT Filed: Sep. 21, 2023
(86) PCT No.: PCT/US2023/074802

§ 371 Date: Mar. 20, 2025

Related U.S. Application Data
(60) Provisional application No. 63/408,791, filed on Sep. 21, 2022.
(60) Provisional application No. 63/482,739, filed on Feb. 1, 2023.
(60) Provisional application No. 63/578,752, filed on Aug. 25, 2023.

(51) Int. Cl. C08F 290/06; C08F 285/00; C08F 290/04; C09D 151/00; C09J 151/00

(52) U.S. Cl. CPC C08F 290/068; C08F 285/00; C08F 290/044; C09D 151/003; C09J 151/003

(57) ABSTRACT

The subject matter described herein is directed to molecularly engineered brush-like graft copolymer elastomers and applications thereof. The developed formulation platform is based on the synthesis of brush-like graft copolymer networks with engineered macromolecular architecture composed of brush-like polymers, such as combs and bottlebrush polymers, and block copolymers composed of combinations of brush and linear blocks, with capability of bearing desired chemical functionalities, for example, brush side-chains, chain-ends, and/or brush backbone.

### STATEMENT OF GOVERNMENT SUPPORT

This invention was made with government support under Grant Nos. DMR2004048, DMR1921835 and DMR1407645 awarded by the National Science Foundation. The government has certain rights in the invention.

### FIELD

The subject matter described herein is directed to molecularly engineered brush-like graft copolymer elastomers and applications thereof.

### BACKGROUND

The properties of polymers can vary over a wide range as a consequence of the interactions of individual molecular building blocks comprising the polymer structure and the broad variation of encoded macromolecular parameters. The particular state and performance of distinct polymeric materials at any instance depends both on the systematically programmed features such as the specific chemistry, architecture and connectivity, and external stimuli such as temperature and deformation rate of the material. Combining various desired properties and performances into one material can be achieved through simple physical mixing of various distinct chemical species (molecules, particles, solvents, and polymers) into a composite material or a polymer blend, yet such approaches have many limitations. Specifically, shortcomings of the art to programmably incorporate and independently control traditionally oxymoronic properties such as softness and firmness, adhesion and elasticity, or swellability and stiffness. In conventional materials based on linear polymers and the physical mixing approach, many of these properties are interdependent, i.e. targeted shifting of one property results in undesired changes of other properties.

Therefore, there is a present need for a molecularly engineered copolymer platform that provides the flexibility to enable precise, programmable, and independent control over various orthogonal functions into one single macromolecule followed by self-assembly of such macromolecular building blocks in a multifunctional, leachable-free, additive-free material. The present disclosure addresses these shortcomings in the art.

### BRIEF SUMMARY

In certain embodiments, the subject matter described herein is directed to an engineered hybrid brush-like graft copolymer, which may comprise multiple residues of chemically dissimilar macromonomers serving different functions including, but not limited to: residues of macromonomers that are mechanical regulators of the mechanical properties of the copolymer, wherein the architectural parameters of the copolymer [n_{sc}, n_{g}, n_{A}, ϕ_{A}, nₓ, n_{bb}] are programmably pre-determined; residues of macromonomers that control material tackiness, residues of macromonomers that control solvent, e.g., water sorption; residues of macromonomers that control network elasticity; residues of macromonomers that are tailored with specific chemistries at side chain ends.

In certain embodiments, the subject matter described herein is directed to a composition comprising: a single molecule copolymer with heterogenous chemistries as described herein, wherein said composition may be used as adhesives, sealants, vibration management devices, biomedical implants, and soft robotic digits.

In certain embodiments, the subject matter described herein is directed to a method of preparing a hybrid brush-like graft copolymer, the method comprising: i. forming a mixture of various macromonomers and monomers with different functionalities and chemistries; and, ii. subjecting the mixture to combinations of polymerization methods selected from the group consisting of free radical polymerization (FRP), atom transfer radical polymerization (ATRP), SARA ATRP, anionic polymerization, and reversible addition-fragmentation chain-transfer polymerization (RAFT), wherein, a hybrid multicomponent brush-like copolymer is prepared.

In certain embodiments, the subject matter described herein is directed to compositions/formulations for a myriad of practical medical and non-medical applications including but not limited to biomedical devices with tissue-like mechanical properties, pressure-sensitive adhesives, sealants, surgical glues, wound dressing, bandages, patches, grounding pads, ostomy appliances, prostheses, fillers, chondral fracture repairs, tissue fixation, scaffolds for tissue regeneration, coatings of substrates, synthetic tissue for soft robots, wearable electronics, and anti-vibration elastomers.

Other embodiments are also described.

### BRIEF DESCRIPTION OF THE FIGURES

FIG. 1A-C depicts (A) Co-polymerization of chemically different (macro)monomers yields (B) brush-like graft copolymers with chemically different side chains randomly distributed along the backbone that self-assemble into (C) a physical network, i.e. thermoplastic elastomer. Given multiplicity of chemically different side chains, these elastomers demonstrate a tailored combination of different functions and physical properties such tissue-mimetic mechanics, controlled water uptake, adhesion, and strength. In addition to the difference in chemical composition, the A-E macromonomers differ in size: chemically different side chains may have different degrees of polymerization n_{sc}. As outlined in Panel a, each chemically different side chain makes distinct contribution to elastomer physical properties: A—small monomers, e.g., n-butyl acrylate, form a spacer between neighboring side chains with a degree of polymerization n_{g}, which controls elastomer mechanical properties (modulus, extensibility, firmness), B—hydrophobic side chains such as polyisobutylene or polydimethylsiloxane control adhesion and softness, C—hydrophilic side chains, e.g. poly(ethylene glycol) control water sorption, D—longer side chains microphase separate to form physically crosslinked network, while their molar fraction determine the degree of polymerization of the network strand backbone n_{bb}, which controls mechanical properties, E—end-functionalized side chains enable specific interactions and functions, e.g. anchoring to substrates and chemical crosslinking.

FIG. 2A-C depicts (A) Evolutionary augmentation of mechanical properties starting with super-softness of covalent bottlebrush elastomers through adding firmness in self-assembled ABA networks to superior strength of molecularly interconnected A-g-B elastomers. The mesh interconnectivity is highlighted by a bold backbone of an A-g-B macromolecule. Interplay of multiple architectural parameters, such as length and grafting density of side chains in the B block as well as A block dimensions, permits unparalleled control of equilibrium and viscoelastic mechanical properties. Chemistries chosen for application specific functions, such as adhesion, moldability, or water uptake, can be implemented within specific mechanical phenotypes. (B) Stress-elongation curves of selected covalent bottlebrush elastomer (E₀=9.9 kPa and β=0.07) and a thermoplastic ABA brush copolymer (E₀=13.3 kPa and β=0.77) samples. Although, the ABA system demonstrate very high firmness that may reach β=0.9 on par with skin (dashed line), both systems exhibit low strength (σₘₐₓ<0.1 MPa). (B) Self-assembled networks of A-g-B brush-like graft copolymers display a unique combination of softness, firmness, and strength (ESI, Table S1). A sample of PBA-ran-PMMA-g-(PDMS/PS) graft copolymer exhibits strength ˜8 MPa on par with aorta (dashed line), surpassing many other strong tissues.

FIG. 3 depicts (A) Grafting through copolymerization of four different macromonomers (as shown) each carrying distinct functions. (B,C) Oscillatory shear at 0.5% strain of a poly(dimethylsiloxane) side chain brush-based material randomly containing butyl acrylate (n_{g} =8) backbone spacers with 5 wt % degree polymerization (DP)=70 poly(styrene) side chains (black squares), 5 wt % DP=140 poly(styrene) side chains (red circles), 5 wt % DP=70 poly(styrene) side chains with 5 wt % DP=9 poly(ethylene glycol) side chains (blue triangles). (B) Storage modulus G′ and (C) tan δ=G″/G′ as a function of frequency for three different formulations (Table). This test shows the ability to independently vary the damping factor (C) at nearly constant stiffness (A).

FIG. 4A-B depicts (A) Grafting through copolymerization of three different macromonomers (as shown) each carrying distinct functions. For example, microphase separation of polystyrene macromonomers results in physical crosslinking which controls mechanical properties of the resultant thermoplastic elastomers. By increasing the molar fraction of PS macromonomers, there is a decrease in n_{bb} and respectively an increase number of elastic repeat units (z=n_{bb}/nₓ) leading to concurrent increase in stiffness, firmness, and strength. (B) True stress-elongation curves performed at 0.005 s⁻¹ of a poly(dimethylsiloxane) side chain (n_{sc}=14) based adhesive with poly(butyl acrylate) spacers (n_{g}=8) and an increasing weight fraction (ϕ_{A}=2.5, 5, 10, 15 and 25 wt %) of poly(styrene) (n_{sc}=70) macromonomers to provide network elasticity. This test shows the ability to reach strength of nearly 10 MPa which is on par with that of strong tissues like skin.

FIG. 5 depicts mechanical characteristics including softness (Young's modulus, E₀), firmness (strain-stiffening parameter β) and strength (@max) extracted from stress-elongation curves of various brush-based elastomers (gray cubes), biological tissues (red spheres) and thermoplastic elastomers composed of brush-like graft copolymers described herein and shown in FIG. 4 (black cubes). Elastomers with comb-like and bottlebrush polymer strands show comparable softness and strength to tissue but are confined to low firmness (β<0.2). In contrast, thermoplastic elastomers self-assembled from brush-like graft copolymers show enhanced firmness (β≈0.7) and strength (ϕₘₐₓ≈10 MPa) (FIG. 4) due to the concurrent variation of architectural parameters outlined in FIG. 1.

FIG. 6A-B depicts (A) Grafting through copolymerization of four different macromonomers (as shown) each carrying distinct functions. For example, the poly(ethylene glycol) macromonomer is responsible for swelling in water. (B) Water uptake of a brush-like adhesive containing poly(dimethylsiloxane) side chains and butyl acrylate (n_{g}=8) backbone spacers with controlled fractions of poly(styrene) and poly(ethylene glycol) side chains. This test shows the ability to precisely tune water uptake by controlling fraction of hydrophilic side chains C (FIG. 1a).

FIG. 7 depicts independent control of strength by changing the overall stand length, n_{bb}. The backbone with PDMS side chains were grafted through while A-blocks were subsequently grafted-from. The backbone length was varied from 210 to 1935 with A-blocks randomly dispersed an average of every 149 repeat units. Thus, the number of A-blocks per chain varied from 1.4 to 13. The E₀ and β remained near constant at ˜45 kPa and 0.5, respectively, while the strength increased 24-fold (\dot{ε}=0.005 s⁻¹).

FIG. 8A-B depicts (A) the evolution of storage (G′) and loss (G″) moduli for graft brush copolymers with various chemistries and increasing temperature (f=1 Hz). Implementing temperature dependent A-blocks, such as polystyrene (PS) in the graft brush copolymer system with PDMS or PIB side chains permitted A domains disorganization and fluidity at high temperatures. The melt temperature was dependent on ϕ_{A}, as well as the interaction energy between PS and the B-block. (B) The temperature dependence of PS enabled melt preparation techniques such as molding, additive manufacturing, and fused filament fabrication 3D printing of complex shapes. Post-annealing of filaments from a 3D printed dog bone maintained identical deformation response to a solvent caste film.

FIG. 9A-B depicts (A) oscillatory frequency sweeps of graft brush copolymers. Choice of side chain chemistry can prepare materials for time-dependent and time-independent applications while architecture will still determine E₀ and β. Polyisobutylene (PIB) side chains elicit a dramatic increase in G′ and tan (δ) while PDMS side chains exhibit minimal change in G′ and tan (δ) ramins under ˜0.3. (B) Time-dependence in the viscoelastic window (10⁻² to 10² Hz) translates to good pressure sensitive adhesion. The probe tack test displays graft brush copolymer samples with either PIB or PDMS side chains. Graft brush copolymers with PIB side chains displayed great work of adhesion in comparison to samples with PDMS side chains. (T=25° C., \dot{ε}=1 s⁻¹, h₀=1 mm).

$${W}_{adh} = {h}_{0} {\int }_{0}^{{ε}_{max}} {σ}_{eng} ( ε ) d ε = 563 J / {m}^{2} .$$

FIG. 10A-C depicts (A) independent control of adhesion by varying ϕ_{A}. Independent variation in ϕ_{A} greatly impacts the probe tack test profile of graft brush copolymer pressure sensitive adhesives (PSAs) with PIB side chains. Lower ϕ_{A} increases tack and strain-at-break for the adhesive bond. Work of adhesion decreases as ϕ_{A} increases. (B) Independent control of adhesion by varying n_{sc}. While tack increased with n_{sc}, there was minimal change in work of adhesion. This is ascribed to the decrease in modulus from diluting the side chains being compensated by early detachment of the adhesive from increased strain stiffening. (C) Independent control of adhesion by varying n_{g}. The n_{g}=8 sample had a greater modulus at the frequency of depending while being below the crital modulus for spontaneous wetting of the surface. This resulted in increased tack while the increased strain stiffening of the n_{g}=4 sample caused a decreased strain-at-break. (T=25° C., \dot{ε}=1 s⁻¹, h₀=1 mm).

FIG. 11 depicts frequency dependence on architectural parameters for samples with PDMS side chains, PBA spacers, and PMMA A-blocks through rheology. The samples were synthesized via sequential RAFT grafting through the backbone followed by ATRP grafting-from of PMMA A-block. Mechanical properties, such as G′ and tan (δ) at small deformations, remain relatively constant with variation in n_{bb}. Increasing ϕ_{A} results in a concurrent increase in G′ and decrease in tan (δ). A less densely grafted backbone (n_{g}˜4,8) increases the stiffness of the material though damping increases slightly due to greater acrylate weight fraction.

FIG. 12 depicts frequency dependence on architectural parameters for samples with PDMS side chains, PBA spacers, and PS A-blocks through rheology. The samples were synthesized via FR grafting through the backbone of all macromonomers. Increasing n_{bb} and ϕ_{A} while decreasing nₓ produces much stiffer materials while the damping factor matches that of many living tissues (see FIG. 14)

FIG. 13 depicts frequency dependence on architectural parameters for samples with PIB side chains, PBA spacers, and PS A-blocks through rheology. The samples were synthesized via FR grafting through the backbone of all macromonomers. Increasing n_{bb} and ϕ_{A} while decreasing nₓ produces much stiffer materials while the damping factor matches that of many living tissues (see FIG. 14)

FIG. 14 depicts samples that mimic both elastic and viscoelastic response of living tissue. Stress-elongation curves of a sample with PDMS side chains, PBA spacers, and PS A-blocks directly mimics tissue softness and strain stiffening of human aorta. Likewise, varying sample chemistry can mimic viscoelasticity within the frequency range 10⁻² to 10² as displayed with ligament, pericardium, and brain tissue.

FIG. 15A-B depicts polymerization of A-g-B brush-like graft copolymers with controlled grafting density of the brush (B) block and fraction of linear A blocks distributed as long side chains in the brush block. A) The controlled radical polymerization (CRP) of assorted macromonomers yields poly[nBA-ran-MMA-g-(PDMS/PMMA)] brush copolymers, while B) the free radical polymerization (FRP) produces poly[nBA-ran-MMA-g-(PIB/PS)] brush copolymers with controlled DP of the brush block. See ESI for complete synthetic procedures. The parameter nₓ is defined as a ratio of molar ratio of A and B macromonomers, including spacers.

FIG. 16 is a Kelen-Tüdös plot for PDMS and PEGOH macromonomers during ATRP at 45° C. Reactivity ratios determined using the Kelen-Tüdös method¹⁰ reveal gradient distribution of PDMSMA (r₁) and PEGMA (r₂) into a brush backbone. From this CRP method, we expect gradient distribution for RAFT used in this study us well due to differences in size and chemistry.

FIG. 17A-E depicts structural characterization of A-g-B brush copolymers by atomic force microscopy (AFM) and small angle X-ray scattering (SAXS). (A) AFM micrograph of a Langmuir-Blodget monolayer of PMMA-g-PDMS (n_{g}=1, n_{A}=81, nₓ=149) shows densely packed worm-like macromolecules separated by a distance d≅2R_{sc,max}, where R_{sc,max} is a contour length of PDMS side chain. The cross-sectional profile was measured perpendicular to the molecular orientation (dashed line). (B) AFM micrograph of a sparse monolayer exhibits star-like aggregates due to association of A-blocks. (C) Dimensions of A-g-B network morphology: d₁—interbrush distance, d₂—A-domain diameter, d₃—interdomain distance, Sᵢₙ interfacial area per brush strand at the domain surface, S₀—bottlebrush packing area in the bulk. (D) SAXS curves of PMMA-g-PDMS (n_{g}=1) samples with identical [n_{sc}=14, n_{A}≅60, nₓ=149] yet different numbers of A-blocks per bottlebrush (z) as indicated. The n_{bb} variation does not cause any significant effects on the network morphology. The deviation of the green curve (top line) is due to z=1.4<2, indicating that some molecules may have only one A block (loose ends) that lead to a smaller domain size (d₂) and correspondingly smaller distance between the domains (d₃) (Table 1-X). (E) SAXS curves of PS-g-PDMS (n_{g}=8) samples with identical [n_{sc}=14, n_{g}=8, n_{A}=60] yet different nₓ and corresponding ϕ_{A} values. For this sample series, the bottlebrush peak is broader and shifts towards higher d₁ values because of possible interpenetration of side chains and backbone folding inside the bottlebrush envelope promoted by the decrease in grafting density. The increase of ϕ_{A} at a given n_{A} results in the corresponding increase in the aggregation number, Q, and decrease of the interfacial area per brush strand, Sᵢₙ (Table 1-X).

FIG. 18A-D depicts (A) Strength of PMMA-g-PDMS (n_{g}=1) elastomers systematically increases with the number of A blocks per A-g-B macromolecules, z, at a constant DP between A blocks of nₓ=149 (Table 1-X). (B) Stress-elongation curves of PS-g-PDMS (n_{g}=8) samples with different nₓ (and correspondingly ϕ_{A}) values as indicated (Table 1-X). The decrease of nₓ at a given n_{A}=60 results in progressively increasing strength. (C) Frequency sweeps of the storage modulus (G′) and damping factor (tanδ) of the PS-g-PDMS samples with different nₓ and ϕ_{A} values from panel b. (D) PS-g-PDMS elastomer (n_{g}=8, nₓ=86, n_{A}=60) replicates the frequency dependence of the paracardium and ligament damping factors. Replacing of PDMS with PIB in the PS-g-PIB elastomer (n_{g}=8, nₓ=216, n_{A}=60) allows closely matching the damping of brain tissue (Table A-1).

FIG. 19A-D depicts in situ SAXS monitoring A-g-B elastomer deformation of PMMA-g-PDMS (n_{g}=1, n_{bb} =1935, ϕ_{A}=0.044). (A) ID SAXS curves and 2D patterns captured during uniaxial extension at different elongation ratios λ=L/L₀, as indicated. Normalized (B) inter-domain distance (C) domain diameter, and (D) brush diameter as a function of λ. Filled squares and hollow squares are measurements in the parallel and perpendicular plain, respectively.

FIG. 20A-E depicts (A) Copolymer structure of distinct A-g-B macromolecules utilized as mesoblocks for enhancing thermostability, moldability at lower temperatures, and adhesive and damping applications. (B) Temperature dependence of storage (G′) and loss (G″) moduli of A-g-B elastomers with chemically different A-blocks (PMMA and PS) yet the same bottlebrush B block with PDMS side chains (f=1 Hz). Unlike the PS-g-PMMA sample, PS-g-PDMS (n_{g}=8) elastomers undergoes melting at ˜150° C. (C) Fused filament fabrication 3D printing was performed on a PS-g-PIB (n_{g}=8) sample at 150° C. (D) Time-dependent and independent A-g-B brush copolymers in the PSA viscoelastic window. (E) Probe tack test of the PS-g-PIB and PS-g-PDMS samples (T=25° C., \dot{ε}=1 s⁻¹, h₀=1 mm) reveals a considerable difference in the work of adhesion

$${W}_{adh} = {h}_{0} {\int }_{0}^{{ε}_{max}} {σ}_{eng} ( ε ) d ε of J / {m}^{2}$$

and 50 J/m², respectively.

FIG. 21 depicts 3D printed dog bones experience identical stress-elongation response after annealing to solvent caste preparation. Sample 030722_2. \dot{ε}=0.001, T=22° C.

FIG. 22 depicts exemplary purification of A-g-B brush copolymers, poly[nBA-ran-MMA-g-(PIB/PS)].

FIG. 23 shows that composite PSA design entails hazardous leaching and property drift. A commercial ostomy adhesive was formed into an X shape and applied to skin. After 30 minutes, the adhesive was removed. Though invisible to the naked eye, residual additives were left on the skin at risk of penetrating an open wound. For clear observation of the migratory components, a fluorescent powder was spread over the skin surface where it adhered to the residue and was revealed by a black light.

FIG. 24A-F show additive-free control of adhesive performance. (a) Pressure sensitive adhesives integrate the elasticity of rubber and the tackiness of viscous liquids, which can be implemented in two orthogonal ways (b,c). (b) Linear polymer networks require large quantities (up to 50 w. %) of loose additives to dilute chain entanglements, resulting in surface residues upon debonding. Entropic elasticity of polymer network hinders wetting of nanoscopic cavities (inset). (c) Grafted side chains act as non-leachable diluents of chain entanglements and concurrently facilitate nanoscale wetting (inset). (d) Stress-elongation curves (\dot{ε}=0.005 s⁻¹) of exemplary linear (red) and brush (black) polyisobutylene (PIB) elastomers. Even though both networks have similar degrees of polymerization (DP) between crosslinks nₓ≅300, brush elastomers are considerably softer and exhibit much stronger strain-stiffening. The modulus of linear networks is controlled by chain entanglements characterized by the entanglement DP nₑ≈150, whereas architecturally disentangled brush networks extend their softness through side chains of DP n_{sc} and grafting density n⁻¹. (e) Frequency sweeps of the storage (G′, solid lines) and loss (G″, dashed lines) moduli for the linear and brush PIB elastomers from d. Linear chain networks demonstrate the elastic response defined by an entanglement plateau modulus of Gₑ˜10⁵ Pa. In contrast, side chains in brush elastomers lower the modulus and extend the window of viscoelastic response towards the PSA frequency range. (f) Adhesive stress (σ_{eng}) as a function of pull-off strain (ε) for the linear and brush PSAs from d,e measured by probe tack testing (\dot{ε}˜1 s⁻¹) and hanging loads (insets) at 20° C. where ε is defined by the ratio of pull-off distance Δh to initial PSA thickness h₀. Linear PIB witnesses minimal tack and work of adhesion (W_{adh}), as indicated under the red curve (line indicated as Linear PIB), and is unable to uphold a load above 12 lb/in². The ability of brush architecture to concurrently regulate elastic (softness and firmness) and viscoelastic (relaxation time) properties results in greater tack and W_{adh}, as well as the ability to withstand a hanging load of 53 lb/in² for sample [n_{sc}=18, n=1, n=300]. The work of adhesion is determined as

$${W}_{adh} = {h}_{0} {\int }_{0}^{{ε}_{max}} {σ}_{eng} ( ε ) d ε$$

where, εₘₐₓ is the maximum strain before adhesion failure.

FIG. 25 depicts mediating adhesion through architecturally controlled polymer relaxation. (a) Frequency sweeps of exemplary PBA brush elastomers display shifts in the viscoelastic spectrum caused by increasing the side chain length (˜n_{sc}). The corresponding effects of n_{g} and nₓ are shown in FIGS. 32-37. The brush PSAs reach softness of G′˜1 kPa below the Dahlquist criterion _{g} and simultaneously shift the onset of the elastic plateau to lower frequencies leading to variable stickiness. (b) Rouse times for PIB and PBA brush PSAs follow linear dependence on architecture according to eq 1 (Table 2-B, FIGS. 38-40). The sample legend is displayed to the right of the plot for both b and d. (c) Adhesive stress-strain curves for PIB brush elastomers with varying grafting density (˜n⁻¹) measured by probe tack testing (\dot{ε}˜1 s⁻¹, 20° C.). Increasing the grafting density (˜n⁻¹) leads to a concurrent increase in σ_{tack} and W_{adh}. Insets: snapshots of hanging load tests just before debonding. (d) Normalized work of adhesion, W_{adh}/(h₀E₀), as a function of the normalized strain rate, \dot{ε}τ_{R}, for PBA and PIB brush PSAs defines a strain rate-dependent shift from elastic to viscoelastic deformation. (e) An overlay of probe tack stress-strain curves at different strain rates from d displays the combined effect of the architecture (τ_{R}) and strain rate (\dot{ε}) on the deformation mechanism, W_{adh}, and σ_{tack} of polymer networks. Brush PSAs enable the ability to scale debonding from elastic to viscoelastic mechanisms by changing architecture alone.

FIG. 26 depicts versatility of brush PSAs in addressing the needs of specific applications. (a) Adhesive and tensile (inset) stress-deformation curves of brush elastomers with different chemistries. The PBA brush elastomer (red) with [n_{sc}=11, n_{g}=3, nₓ=200] and PIB brush sample (black, line starting on top) with [n_{sc}=18, n_{g}=4, nₓ=100] produce identical softness and strain-stiffening (E₀=30 kPa, β=0.08), but show different adhesion profiles. The PIB sample displays almost double the W_{adh} and a much larger tack peak (dashed lines) than the PBA sample in agreement with the corresponding difference in their viscoelastic responses (FIG. 25b, FIGS. 33, 36). (b) Two samples of the same chemistry (PBA) yet different architectures, [n_{sc}=11, n_{g}=1, nₓ=100] (black, line starting on top) and [n_{sc}=11, n_{g}=2, nₓ=200] (red), reveal the effect of strain-stiffening on adhesion. The sample with larger β at the same E₀≅20 kPa (inset) exhibits a decrease in maximum pull-off strain, εₘₐₓ, while maintaining nearly the same Wadh≅400 J/m². (c,d) Frequency sweeps of G′ and G″ reveal the ability of brush elastomers to traverse the Chang window as exemplified by the variation in (c) side chain length (n_{sc}=11-41) in PBA elastomers and (d) grafting density (n_{g}=1-16) in PIB elastomers. The corners of the Chang window correspond to G′ and G″ measured at 0.01 and 100 Hz (inset in 3c). Varying the architecture at a constant chemical composition enables tuning of PSA performance for particular applications: I) classical adhesives like tapes, II) high shear resistant adhesives like mounting tapes, III) high peel resistant applications like labels, and IV) removable adhesives like protective films. (e) Acrylic and rubber-based commercial adhesives tapes leave residue on a substrate over time (18 hrs, 60° C.) revealed by fluorescent powder after tape removal (see FIG. 1 for details). Brush PSAs contain no leachable additives, resulting in a clean surface after removal.

FIG. 27 Expanding adhesion-by-architecture to hot-melt PSAs. (a) Brush-like graft block copolymers self-assemble into soft, firm, and strong physical networks. The A-g-B architecture enhances structural control of bottlebrush viscoelasticity by adding three parameters: number of A blocks per brush macromolecule z≅n_{bb}/nₓ, DP n_{A} and volume fraction ϕ_{A} of A-blocks. (b) Adhesive stress-strain curves of an exemplary A-g-B copolymer (PS-g-PIB, n_{sc}=18, n_{g}=8, nₓ=332, n_{A}=60, ϕ_{A}=0.07) compared to a PIB brush elastomer (n_{sc}=18, n_{g}=16, nₓ=100) reveal a considerable difference between the self-assembled and covalent brush PSAs. The PS-g-PIB physical network with a similar Young's modulus of E₀ ≅130 kPa but greater firmness of β=0.17 (inset) exhibits viscoelastic debonding with the emergence of a tack peak, while the brush elastomer undergoes elastic debonding with no tack and much lower W_{adh}. (c) Temperature variation of the storage (G′) and loss (G″) moduli as well as complex viscosity (η⁺) of a PS-g-PIB sample (n_{sc}=18, n_{g}=8, nₓ=216, n_{A}=60, ϕ_{A}=0.1) displays network disassembly at 126° C. denoted as the temperature where G″ surpasses G′ (f˜1 Hz, \dot{ε}=0.05). (d) Fused filament fabrication of brush HMPSAs is used for 3D printing of a reduced scale tracheostomy adhesive (150° C.).

FIG. 28A-F depict a) Linear triblock copolymers are entropically hindered from wetting nanoscale cavities (inset) so they require large quantities of plasticizers and tackifiers to attain softness capable of wetting the surface of a substrate, which results in leftover residue upon debonding. b) The storage modulus as a function frequency of a commercial ostomy adhesive reveals property variation as additives leach at 60° C. over a week. c) Adhesive stress (σ_{eng}) as a function of pull-off strain (ε) for the commercial HMPSA from b reveals a 3-fold decrease in the work of adhesion (W_{adh}). d) A-g-B brush graft copolymers instill additive-free, structural control of viscoelasticity through the parameters of the DP of side chains n_{sc}, of backbone spacers between neighboring side chains (n_{g}), between A-blocks (nₓ), of A block n_{A}, of the total brush strand n_{bb}, and the volume fraction of A block ϕ_{A}. Side chains facilitate nanoscale wetting (inset) and intrinsically dilute the network backbone to expand viscoelastic properties. e) A frequency sweep of storage modulus in the PSA frequency window of commercial SIS and an exemplary brush HMPSA with architectural parameters n_{sc}=18, n_{g}=1, n_{A}=96, ϕ_{A}=0.05, nₓ=180, n_{bb} =2000. While SIS is confined above the Dahlquist criterion, A-g-B brush graft copolymers enable the ability to reach modulus below 0.01 MPa at bonding frequencies by expanding the Rouse regime of time-dependent network properties. f) Adhesive stress as a function of pull-off strain for commercial SIS and an exemplary brush HMPSA displays a dramatic increase in adhesive performance. The A-g-B brush graft copolymer from e empowers over a 10× increase in W_{adh} calculated as

$${W}_{adh} = {h}_{0} {\int }_{0}^{{ε}_{max}} {σ}_{eng} ( ε ) d ε$$

compared to commercial SIS which was also demonstrated by a hanging load test (inset). The bond formed by linear SIS fails with the weight of the load-free hanging apparatus, while the brush HMPSA is able to uphold a load of 62 lb/in² (inset).

FIG. 29 depicts SAXS spectra of PIB elastomers from bottlebrush (SBB) to comb regimes. Densely grafted (n_{g}=1) PIB elastomers exhibit a defined interbrush peak, d₁, while the peak broadens with larger n_{g}. At n_{g}=8, a lower-q peak is ascribed to phase separation between the PIB side chains and PBA spacers in the backbone.

FIG. 30A-C depict a) Stress-elongation curves at various nₓ. As nₓ increases, E₀ and β decrease. (n_{g}=1, n_{sc}=18, \dot{ε}=0.0001 s⁻¹). b) Stress-elongation curves at various n_{g}. The E₀ increases with n_{g} while β decreases. (nₓ=100, n_{sc}=18). c) Stress-elongation curves at various n_{sc}. The E₀ decreases while n_{sc} and β increase. (n_{g}=8, nₓ=100). T=20° C. See E₀ and β values for each sample in Table 2-B.

FIG. 31A-C depict PBA brush elastomer mechanical analysis. a) Stress-elongation curves at various nₓ. As nₓ increases, E₀ and β decrease. (n_{g}=1, n_{sc}=11). b) Stress-strain curves at various n_{g}. The E₀ increases with n_{g} while β decreases. (nₓ=200, n_{sc}=11). c) Stress-strain curves at various n_{sc}. The E decreases while n_{sc} and β increase. (n_{g}=2, nₓ =100). T=20° C. See E₀ and β values for each sample in Table 2-B.

FIG. 32A-C depict a) Stress-elongation curves at various A-g-B brush graft copolymer PSAs (Table 2-C). \dot{ε}=0.001 s⁻¹, T=20° C. A-g-B brush copolymer are much stronger than the UV-cured elastomers. b) Frequency sweep of a sample A-g-B brush copolymer. c) Chang window for a sample A-g-B brush copolymer. The window shifts to the upper right indicating potential use as a high shear PSA.

FIG. 33 depicts PIB viscoelastic control with nₓ. As nₓ increases, energy dissipation increases disproportionately resulting in greater tan δ. All bottlebrush PIB samples witness the proper balance between energy storage and dissipation with tanδ˜1 within the frequency of the Chang window. T=20° C.

FIG. 34 depicts PIB viscoelastic control with n_{g}. As n_{g} increases, energy dissipation decreases disproportionately resulting in lower tanδ. Samples with greater grafting density of PIB macromonomer (i.e. n_{g}=1,2) witness the proper balance between energy storage and dissipation with tanδ˜1 within the frequency of the Chang window. T=20° C.

FIG. 35 depicts PIB viscoelastic control with n_{sc}. As n_{sc} increases, energy dissipation increases disproportionately resulting in greater tan δ. T=20° C.

FIG. 36 depicts PBA viscoelastic control with nₓ. As nₓ increases, energy dissipation increases disproportionately resulting in greater tan δ. All bottlebrush PBA samples witness the proper balance between energy storage and dissipation with tanδ˜1 within the frequency of the Chang window. T=20° C.

FIG. 37A-D depicts PBA viscoelastic control with n_{g}. A) and B) As n_{g} increases, energy dissipation decreases disproportionately resulting in lower tanδ. Samples with greater grafting density of PBA macromonomer (i.e. n_{g}=1,2,3) witness the proper balance between energy storage and dissipation with tanδ˜1 within the frequency of the Chang window. T=20° C. C) and D) PBA viscoelastic control with n_{sc}. As n_{sc} increases, energy dissipation increases disproportionately resulting in greater tanδ. Brush PBA elastomer PSA samples exhibit the proper balance between energy storage and dissipation with tanδ˜1 within the frequency of the Chang window. T=20° C.

FIG. 38A-B depict Rouse time derivations from uniaxial tensile testing at various strain rates. a) Stress-elongation curves at various strain rates for a sample PBA brush PSA. b) Determining Rouse time from the slope-transition of rate normalized stress defining deformation in the Rouse regime (slope-0.5) to deformation on the elastic plateau (slope=1). T=20° C.

FIG. 39 depicts stain rate normalized stress dependence on time for PIB brush PSA samples. The plots show a slope transition from 0.5 to 1 as the deformation of the sample transitions from the Rouse regime where the network can be approximated as a melt of polymer strands, to the elastic regime where contributions of crosslinks and entanglements must be considered. The τ_{R} of PIB brush elastomer PSAs was verified by differentiation and creation of a master curve in which all lines converge. T=20° C. 10 mm/s (black), 1 mm/s (red), 0.1 mm/s (blue), 0.01 mm/s (green), 0.001 mm/s (purple), 0.0001 mm/s (yellow). Linear rates were translated to strain rates based on the initial length of the sample in the clamps.

FIG. 40 depicts Stain rate normalized stress dependence on time for PBA brush PSA samples. The plots show a slope transition from 0.5 to 1 as the deformation of the sample transitions from the Rouse regime where the network can be approximated as a melt of polymer strands, to the elastic regime where contributions of crosslinks and entanglements must be considered. The τ_{R} of PBA brush elastomer PSAs was verified by differentiation and creation of a master curve in which all lines converge. T=20° C. 10 mm/s (black), 1 mm/s (red), 0.1 mm/s (blue), 0.01 mm/s (green), 0.001 mm/s (purple), 0.0001 mm/s (yellow). Linear rates were translated to strain rates based on the initial length of the sample in the clamps.

FIG. 41 depicts studies on contact pressure and dwelling time. The modified probe tack test was performed independently changing the contact pressure and contact time in effort to maximize the contact area of the PSA bond. The PIB brush elastomer PSA with architecture [18,1,300] was used because it had the greatest τ_{R} and would achieve the largest contact area at the interface. The contact area, represented through the W_{adh}, plateaued ˜ 600 J/m². Parameters of 1 MPa contact pressure and 100 s contact time were used for further experimentation. T=20° C.

FIG. 42A-B depict a) Brush PSAs display greater work of adhesion than a commercial ostomy bag and b) adhesion does not change after extraction in toluene and after exposure to high temperatures for a sample PBA brush PSA. T=20° C.

FIG. 43 depicts raw modified probe tack test spectra for PIB brush PSAs. All PIB brush elastomer PSAs were subjected to modified probe tack testing at variable strain rates. As you increase nₓ, fibril elongation before catastrophic failure of the adhesive bond increases though the stress from the fibrils decreased. Increasing the grafting density of the PIB side chains also increased the tack and fibril elongation. With increased n_{sc}, fibrillar stress increased and the fibril elongation increases minimally. T=20° C. Note: some samples were measured from v=10−0.01 mm/s rather than v=1−0.001 mm/s, see Table 2-E.

FIG. 44 depicts raw modified probe tack test spectra for PBA brush PSAs. All PBA brush elastomer PSAs were subjected to modified probe tack testing at variable strain rates. As you increase nₓ, fibril elongation before catastrophic failure of the adhesive bond and tack increase. Increasing the grafting density of the PBA side chains also increased the tack and fibril elongation. With increased n_{sc}, fibril elongation increases and tack peaks manifest. Note: all samples were measured from v=1−0.001 mm/s, 1 mm/s (top line, black), 0.1 mm/s (second line from top, red), 0.01 mm/s (third line from top, blue), 0.001 mm/s (bottom line, green).

FIG. 45 depicts normalized work of adhesion before experimental Rouse time shift with architecture compared to FIG. 25d. Changing architecture alone yields ˜4-decade shift in the normalized work of adhesion for a given strain rate. All samples show a concurrent increase in normalized work of adhesion with strain rate. Scaling for each sample depends on relaxation dynamics elicited in FIG. 25d,e.

FIG. 46 depicts Onset of viscoelastic debonding mechanism defined by manifestation of the tack peak. This is of a subset of PIB brush PSAs where tack=σ_{tack}.

FIG. 47 depicts different chemistry and the same work of adhesion. From left to right: uniaxial tensile tests display different equilibrium mechanical properties of softness and firmness (Table 2-B). Their rheological curves also vary greatly within the Chang window. However, the work of adhesion is nearly identical through four decades of strain rate. This can be attributed to different modes of debonding and resistance to deformation as well as the difference in thermodynamic work of adhesion between the adhesive and probe. T=20° C.

FIG. 48A-C depict a) Atomic force microscopy and b) small angle X-ray scattering of PS-g-PIB (n_{g}=1) samples with identical B-blocks (n_{sc}=18, n_{g}=1, nₓ=180, and n_{bb} =2000) and variable n_{A} as indicated. The AFM micrographs display a granular structure ascribed to microphase separation of PS A-domains uniformly dispersed in the bottlebrush matrix of PIB B-blocks. Both the domain size and interdomain distance increases with n_{A}. b) SAXS spectra verify brush topology of PS-g-PIB (n_{g}=1) samples with variable n_{A}. The inter-brush distance (d₁), A-domain diameter (d₂), and interdomain distance (d₃) of the networks corroborate results observed by AFM where the d₂ and d₃ peak increase with n_{A} while the d₁ peak remains constant (Table 2). c) A-domain diameter (d₂) scaling with n_{A} corroborated by AFM and SAXS. The d₂ from AFM was calculated as a mean of >100 protruding domains from the height profiles for each sample. Both methodologies show the increase of domain size as d_{A}˜n_{A}^{0.41} by AFM and d_{A}˜n_{A}^{0.36} by SAXS. Exaggerated d₂ from AFM is a result of convolution with the tip shape.

FIG. 49A-B depict that brush HMPSAs melt at moderate temperatures dependent on n_{A} and ϕ_{A}. a) Storage (G′) and loss (G″) moduli as a function of temperature for brush HMPSAs with constant n_{sc}=18,n_{g}=1, nₓ=163, n_{bb}=900 and variable n_{A}. The transition to melt state (T_{flow}), denoted as the temperature where G″ surpasses G′, increases with n_{A} prompting a target n_{A}=60 for T_{flow}˜100° C. b) SAXS spectra for the sample with n_{A}=54 from panel a at different temperatures. The d₂ peak shifts to higher q and the peak intensity decreases indicating domain dissociation.

FIG. 50A-E depict additive-free brush HMPSAs architecturally tune adhesive performance. a) Frequency sweeps of storage modulus (G′) in the PSA frequency window for PS-g-PIB (n_{g}=1) samples with varying n_{A}. Decreasing n_{A} produces an extension of time-dependent mechanical properties which lowers the elastic plateau. b) Rouse time (τ_{R}) scales with A-g-B brush architectural parameters. The τ_{R} of PS-g-PIB (n_{g}=1) samples scale with previously determined parameters of the brush strand,³³ and an additional structural coefficient. a) Normalized work of adhesion as a function of strain rate for all brush HMPSA samples. Work of adhesion can be programmed over three orders of magnitude by tuning macromolecular structure alone without the use of additives for samples in the legend on the lower right (Table B1). b) Normalized work of adhesion as a function of normalized strain rate for brush HMPSAs. All data fall on a single line where a rate-dependent shift from elastic to viscoelastic debonding is revealed at

$$\dot{ε} = {τ}_{R}^{- 1} \cdot c )$$

Overlaying probe tack west curves of all brush HMPSAs according to the normalized strain rate (\dot{ε}τ_{R}) reveals systematic control of debonding mechanisms. Debonding the probe below the Rouse rate

$$( {τ}_{R}^{- 1} )$$

results in an elastic debonding mechanism where cavity growth is dominated by crack propagation in the plane of the interfacial bond. At higher rates, viscoelastic debonding occurs where interfacial cavities are able to expand into the bulk and form fibrils with increased strain.

FIG. 51A-B depict control over debonding mechanisms and firmness. a) Comparing stress-elongation curves of brush HMPSAs to linear networks and biological tissue. Intrinsically entangled linear SIS networks demonstrate a conventional stress-strain behavior characterized by a relatively high modulus above 10⁵ Pa and stiffness decay with deformation (top line). Architecturally disentangled brush HMPSAs demonstrate lower modulus followed by intense stiffness increase with deformation (second line from top), which mimics the softness and firmness of biological tissue (blue squares) displayed by the sample. b) Independently controlling Rouse time (τ_{R}) and firmness (β) leads to distinct probe tack test profiles when being de-bonded at strain rates above or below their Rouse rate

$$( {τ}_{R}^{- 1} ) .$$

The sample [n_{sc}=18, n_{g}=8, nₓ=332] with τ_{R}=3.9 s undergoes viscoelastic debonding (τ_{R}\dot{ε}<1) with a characteristic tack peak followed by a decaying yielding plateau (second line from top). At the same pulling rate of \dot{ε}=1 s⁻¹, the sample [n_{sc}=18, n_{g}=4, nₓ=149] with τ_{R}=0.8 s undergoes elastic debonding (τ_{R}\dot{ε}<1) without a tack peak followed by an increase of stress due to higher firmness (β=0.37) (top line). The sample [n_{sc}=18, n_{g}=8, nₓ=450] with characteristics (β=0.24, τ_{R}=2.5 s) shows an intermediary behavior with a smaller tack peak and a slight increase of stress with deformation (third line from top).

FIG. 52A-C depict moldability at moderate temperatures empowers thermal processing to manufacture additive-free brush HMPSA tapes and biomedical adhesives. a) Manufacturing of brush HMPSA tapes. Brush HMPSAs samples with n_{sc}=18, n_{g}=8, n_{A}=60, n_{bb} =1270 and variable ϕ_{A}=0.05, 0.07, 0.10 were pressed into to ˜10 μm films at 140° C. on a cellulose backing reducing the use of VOCs. The layered films were subsequently wound on a spool to manufacture tape roles. b) Zero-degree shear loads for brush HMPSA tapes with variable ϕ_{A}. The adhesive performance of the manufactured tapes dependent on architecture where the applied load (4 L-0.5 L solvent, left to right) appears to scale inversely in the ϕ_{A}. c) Fused filament 3D-printing of a transdermal drug delivery system (TDDS) adhesive. The low viscosity of the brush HMPSAs at increased temperatures allows mixing in active agents (nicotine) which diffuse into the skin of a patient applied at room temperature. The TDDS may be processed via hot-melt press into a film backing or 3D-printing into unique shapes to aid in flexibility and mobility while applied to the patient.

### DETAILED DESCRIPTION

The hybrid brush-like graft copolymers, such as A-g-B brush graft copolymers, described herein display extraordinary tunable control over viscoelastic properties and adhesive performance in an additive-free system to formulate materials for a wide range of applications without the use of chemical additives or altering the types of chemistries, and without the detrimental effects of uncontrolled leaching and phase transformations. Brush architecture unlocks unprecedented property control over viscoelastic and adhesive properties for a wide range of applications without the use of chemical additives. Specifically, the A-g-B architecture empowers wide-ranging control of network modulus, the Rouse time, and strain-stiffening with deformation by varying a distinct set of architectural parameters including side chain length, grafting density, and volume fraction of the A block. This compels unprecedented structural control of adhesive performance of materials covering almost 4 order of magnitude of the work of adhesion and 6 orders of magnitude of debonding rates, spanning both viscoelastic elastic debonding mechanisms. The ability to enhance the strain-stiffening behavior at large deformation prevents cohesive rupture, which in combination with the lack of additives, results in no residue on a substrate after debonding. The physical nature of A-g-B networks allows for hot-melt preparation and 3D printing of these PSAs with complex shapes. The ability to independently control n_{A} and ϕ_{A} allows tuning the flow temperature, T_{flow}, for molding at moderate temperatures. Utilizing brush architecture, new chemistries to improve properties, such as solvent and UV resistance, can be introduced into HMPSA networks that had been previously thought unworkable for adhesives.

Described herein is the molecular design of hybrid brush-like graft copolymers with tissue-like mechanical properties and additive-free non-leachable formulations adaptable for molding, additive manufacturing, and recycling. Specifically, the disclosed hybrid brush-like graft copolymers include molecularly engineered non-leachable adhesive formulations and tissue-like elastomers with fine-tunable features (e.g., stress-strain behavior, adhesiveness, tackiness, firmness, viscoelasticity, chemical functionality). Embodiments described herein include compositions comprising hybrid brush-like graft copolymers that self-assemble into polymer networks with multiple chemically different side chains attached to network strands.

The side chains are programmed to play distinct roles such as, but not limited to, diluents, crosslinkers, plasticizers, tackifiers, or water uptake agents. Thus, these properties can be added to the copolymers without the use of additives. Chemical composition, architectural dimensions, and fractions of the chemically different side chains may be varied to enable accurate and independent tuning of physical characteristics including, but not limited to stress-strain response, storage modulus, loss modulus, adhesion, tackiness, softness, firmness, water sorption, softening temperature, and chemical functionality. Embodiments also include formulations comprising various building units (monomers, macromonomers, polymers, and copolymers) that are chemically and/or physically integrated into a brush-like polymer network. Other embodiments include the design of brush-like polymers (combs and bottlebrush polymers) and block copolymers (combinations of brush and linear blocks) capable of bearing desired chemical functionalities (e.g., on brush side chains, chain-ends, and/or brush backbone). Embodiments also include polymer network delivery methods including pre-molded bulk materials and injectable solution melts.

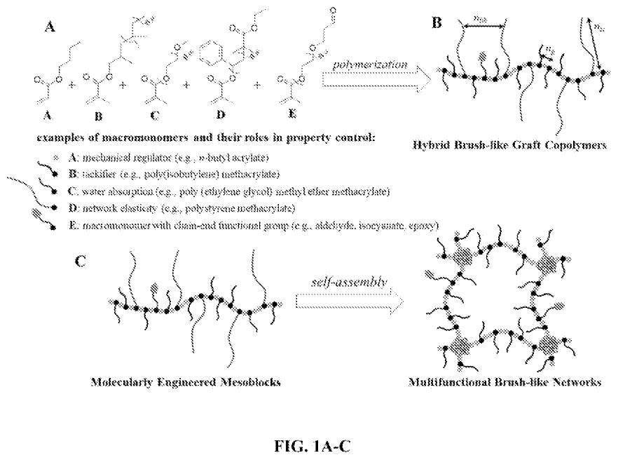

The subject matter described herein is also directed to a general materials design platform for molecular engineering of additive-free non-leachable materials with tissue-mimetic mechanical properties, strong adhesion, tunable water uptake, and molding, injection, and casting capabilities. The developed platform is based on the synthesis of brush-like graft copolymers as functional mesoblocks (e.g., sidechains, bottlebrush chains, comb polymers, linear-bottlebrush diblock copolymers, asymmetric/symmetric linear-bottlebrush-linear triblock copolymers, etc.) (FIG. 1a) that self-assemble into a polymer network (FIG. 1b) with chemically different side chains attached to brush-like network strands that play distinct roles such as, but not limited to diluents, crosslinkers, plasticizers, tackifiers, or water uptake agents (FIG. 1c). Architectural dimensions include side chain grafting density (n_{g}), side chain length (n_{sc}) and brush length between network elasticity nₓ (FIG. 1) total strand length (n_{bb}) and the degree of repeat units of elasticity (z=nₛ/n_{bb}). Chemical composition, architectural dimensions and molar fractions of chemically different side chains are purposely selected to enable accurate and independent tuning of different physical characteristics such as adhesion, tackiness, storage modulus, loss modulus, firmness, softness, water sorption, softening temperature, and chemical functionality. Unlike current technologies based on mixing of assorted chemicals such as crosslinkers, tackifiers, and water-sorbents, the technology described herein is based on the design of multifunctional mesoblocks that integrate a set of different structural elements each carrying distinct functions. These additives such as small molecules (e.g., tackifiers) or colloidal particles (e.g., cellulose microcrystals) inevitably leach unlike the current invention's side chains chemically bound to network strands performing distinct functions Thus, this invention offers a methodology for controlled polymerization of monomers and macromonomers with different chemistries into a brush-like architecture to afford a novel highly tunable material platform with vast functionality and applicability.

In embodiments, the subject matter described herein is directed to polymeric networks used for various biomedical applications, from reconstructive surgery to wearable electronics. Some materials may be soft, firm, strong, or damping however, implementing all four properties into a single material to replicate the mechanical properties of tissue has been inaccessible. Herein, we present the A-g-B brush-like graft copolymer platform as a framework for fabrication of materials with independently tunable softness and firmness, capable of reaching a strength of ˜10 mpa on par with stress-supporting tissues such as blood vessel, muscle, and skin. These properties are maintained by architectural control, therefore diverse mechanical phenotypes are attainable for a variety of different chemistries. Utilizing this attribute, we demonstrate the capability of the A-g-B platform to enhance specific characteristics such as tackiness, damping, and moldability.

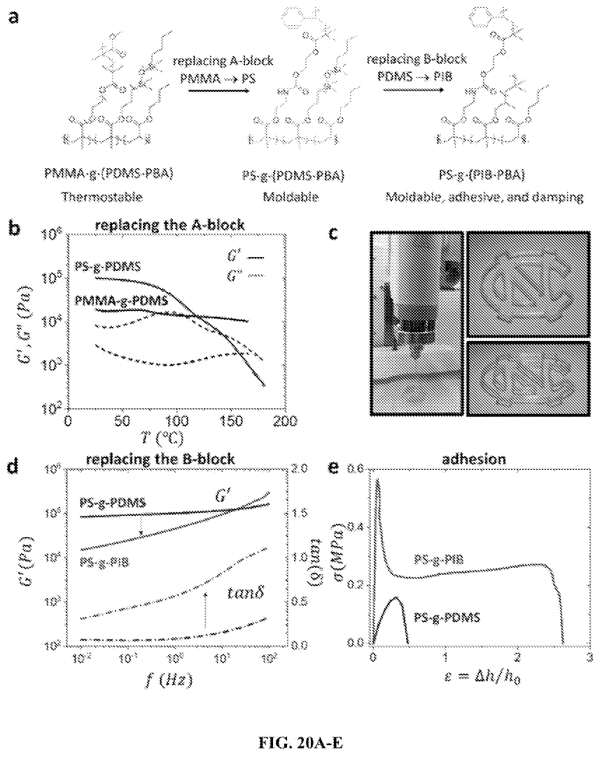

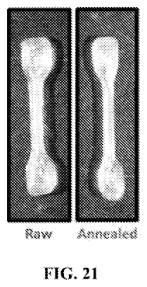

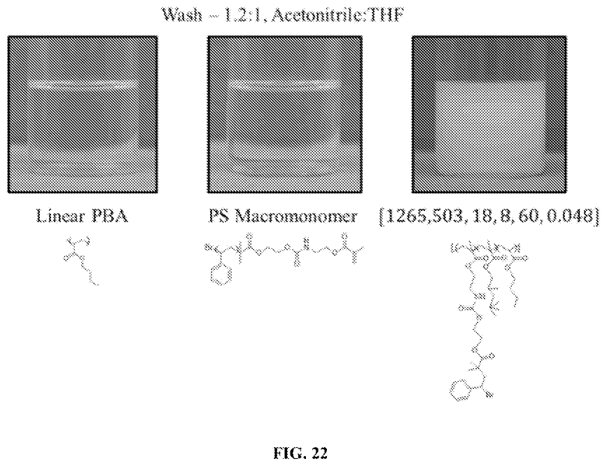

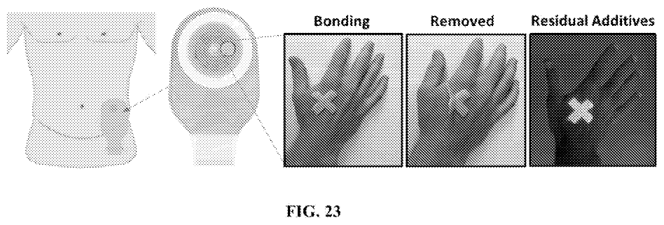

In certain embodiments, pressure sensitive adhesives and vibration damping, materials demonstrate a particular viscoelastic variance as a function of frequency (within the 10⁻² to 10² Hz range) at room temperature. This feature can be addressed by substitution of PDMS with polyisobutylene (PIB) side chains (FIG. 20a), which shifts the material relaxation dynamics toward the Rouse regime at room temperature (FIG. 20d). The combination of lowering the storage modulus (G′<0.1 MPa at 0.01 Hz) and enhanced viscoelasticity (increase of tan δ=G″/G′ from ˜0.1 to ˜1 range) facilitates substrate wetting and energy dissipation at a debonding rate of ˜ 1 Hz. This results in the increase of the overall work of adhesion (W_{adh}) of the material by probe tack testing showing potential as a pressure sensitive adhesive (FIG. 20e). The chemistries addressed are merely a subset of synthetic and application pathways capable of implementing A-g-B brush architecture and can be greatly expanded.

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated patents, literature and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety. In the drawings, the relative sizes of regions or features may be exaggerated for clarity. This subject matter may, however, be embodied in many different forms and should not be construed as limited to the aspects set forth herein; rather, these aspects are provided so that this disclosure will be thorough and complete, and will fully convey the scope of the subject matter to those skilled in the art.

### I. Definitions

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular aspects only and is not intended to be limiting of the invention. In case of a conflict in terminology, the present specification is controlling.

As used herein, the term “programmably predetermined” refers to encoding physical properties of polymer networks, such as modulus, damping factor, and work of adhesion in polymer network architecture through the selective, strategic incorporation of brush architecture into network strands. The purpose of programmably predetermined methods is to tune the viscoelastic and/or adhesive properties without changing the types of chemical components that make up the copolymer and/or without using additives. In certain embodiments, this programmability excludes the use of additives that materially affect viscoelastic and/or adhesive properties. In certain embodiments, architectural variations may lead to a change of chemical composition, which does not impact physical properties.

As used herein, “polymer network” refers to a polymer in which covalent cross-linking or non-covalent cross-linking (e.g., via chain entanglements, hydrogen bonding, or microphase separation) has occurred. Examples of polymer networks include, but are not limited to, polymer gels and elastomers.

As used herein, “polymer” refers to the product of a polymerization reaction in which one or more monomers are linked together. A polymer includes copolymers. Additionally, particular polymers are brush-like, crosslinked, or a mixture thereof.

As used herein, “copolymer” refers to a polymer resulting from the polymerization of two or more chemically distinct monomers.

As used herein, “linear polymer” refers to a polymer having side chains that are shorter than the spacer between neighboring side chains along the backbone or main chain of the polymer. When the spacer is negligibly short, “linear polymer” refers to a polymer having side chains that are shorter than the persistence length of the side chains. For example, a polymer chain with side chains, in which the spacer consists of two covalent bonds and side chain persistence length is ten covalent bonds long, is considered as a “linear polymer.” Examples of linear polymers include, but are not limited to, vinyl polymers with relatively short side chains or small side groups. When the side chains become longer than their persistence length, the polymer is no longer considered a linear polymer. Rather, the polymer is now considered a brush-like polymer as further detailed below. For example, poly(butyl acrylate) with n-butyl side groups is a linear polymer whereas poly(octadecyl acrylate) with n-octadecyl side chains is a brush-like polymer.

As used herein, “hybrid brush-like graft copolymer” refers to a copolymer comprising programmable combinations of different backbone monomers and grafted macromonomer side chains that serve different functions on the resulting properties, including oxymoronic properties such as softness and firmness, elasticity and adhesion, hydrophobicity and water uptake.

As used herein, “comb-like polymer block” refers to a brush-like polymer block in which the spacer length is significantly shorter than the side chain contour length, yet it is longer than the square-root of the side chain length. For example, a comb-like polymer block could have poly(butyl acrylate) side chains with a degree of polymerization of 100 separated by a poly(butyl acrylate) spacer with a degree of polymerization of 30 (30<<100).

As used herein, the term “bottlebrush-like polymer block” and the like refers to a polymer block having side chains that are significantly longer than the spacer between neighboring side chains along the backbone or main chain of the polymer. Thus, without wishing to be bound by theory, the side chains can be at least more than two monomeric units long, more than 3 monomeric units long, more than 4 monomeric units long, more than 5 monomeric units long, more than 6 monomeric units long, more than 7 monomeric units long, or more than 8 monomeric units long, so long as the spacer is shorter than the square-root of the side chain length. For example, a bottlebrush-like polymer block could have poly(butyl acrylate) side chains with a degree of polymerization of 100 separated by a poly(butyl acrylate) spacer with a degree of polymerization of 2 (2<<<100).

As used herein, “backbone” refers to a chain of covalently bound monomers used for copolymerization of macromonomers of A block, B block and spacers, g. The copolymer thus comprises the backbone and side chains or grafted chains.

As used herein, “binding functionality” refers to a chemical group capable of binding polymer blocks, e.g., linear polymer blocks. In various aspects, a binding functionality is capable of covalently binding polymer blocks; however, non-covalent binding (e.g., via hydrogen bonds, ionic bonds, and van der Waals forces) are also envisioned. Examples of binding functionality es include, but are not limited to, maleimide moieties, vinyl moieties, acrylate moieties, methacrylate moieties, hydroxyl moieties, amino moieties, carboxylic acid moieties, amide moieties, urea moieties, and furan moieties.

As used herein, “elastic modulus” refers to the degree of stiffness of a polymer network). Thus, in various aspects, a polymer network has an elastic modulus of less than about 10⁶ Pa, less than about 10⁵ Pa, or less than about 10⁴ Pa.

As used herein, “softness” refers to a polymer network's elastic modulus.

As used herein, “strain-stiffening parameter” refers to the ability of a polymer network to increase its stiffness, i.e., increase in the polymer network's elastic modulus during deformation.

As used herein, “firmness” refers to a polymer network's degree of strain-stiffening.

As used herein, “strength” refers to the degree of maximum load or stress a polymer network can withstand before rupture.

As used herein, “adhesion” refers to the degree of which a polymer network adheres to a substrate.

As used herein, “tackiness” refers to the degree of adhesion of a polymer network at short time scales.

As used herein, “reversible molding” refers to the ability of a polymer network to make a shape and then disassemble that shape, if needed, followed by re-assembly into a different shape. Without wishing to be bound by theory, molding can be done from solution state or from melt state.

As used herein, the term “engineered” refers to a predetermined shape or constituency of a composition, as opposed to random.

As used herein, the term “non-leachable” refers to a composition that does not appreciably leach components neither spontaneously nor under the effect of an external stimulus, e.g. deformation. Specifically, in certain embodiments, the compositions described herein do not appreciably leach components. Lack of appreciable leaching or substantially free of leaching are of the same degree.

As used herein, with respect to a pressure sensitive adhesive, the term “bonding” and “bonded” refers to the adherence of the pressure sensitive adhesive to a substrate, such that the pressure sensitive adhesive and the substrate are adhesively bonded.

As used herein, with respect to a pressure sensitive adhesive, the term “debonding” refers to an on-demand ability to reduce the strength of an adhesive bond at will for the purpose of facilitating the separation of the pressure sensitive adhesive from a substrate to which the pressure sensitive adhesive is adhesively bonded.

As used herein, “biocompatible” refers to materials that are not unduly reactive or harmful to a subject upon administration.

As used herein, the terms “contacting” and “mixing” and the like refer to reagents, such as macromonomers, in close proximity so that a reaction may occur.

As used herein, “ambient temperature” or “room temperature” refers to a temperature in the range of about 20 to 25° C.

As used herein, the term “substantially” refers to the complete or nearly complete extent or degree of a component, or an action, characteristic, property, state, structure, item, or result. The exact allowable degree of deviation from absolute presence of such a component, or an action, characteristic, property, state, structure, item, or result may in some cases depend on the specific context. However, generally speaking, “substantially” will be so near as to have the same overall result as if absolute and total extent or degree were obtained. The use of “substantially” is equally applicable when used in a negative connotation to refer to the complete or near complete lack of a component, or an action, characteristic, property, state, structure, item, or result. For example, a composition that is “substantially free of” leaching would either completely lack leaching or so nearly completely lacking that the effect would be the same as if it completely lacked leaching. In other words, a composition that is “substantially free of” leaching may still actually leach as long as there is no measurable effect thereof, for example, trace amounts, or may contain a de minimis amount or significantly reduced amount of an additive and still exhibit the desired property. As used herein, “essentially free” means a component, or an action, characteristic, property, state, structure, item, or result is not present or is not detectable. This is also referred to as “essentially additive free.” A composition that is “free of leaching” would not contain a leachate as a component. That is, the composition does not comprise a plasticizer or tackifier, or the like that modulates a viscoelastic property. This is also referred to as “additive free.”

As used herein, the term “single molecule composition” refers to a hybrid brush-like graft copolymer where only the components that make up the copolymer are present, as opposed to multicomponent systems that contain polymer blocks and additives that are used to obtain a desired viscoelastic profile.

As used herein, “and/or” refers to and encompasses any and all possible combinations of one or more of the associated listed items, as well as the lack of combinations when interpreted in the alternative (“or”)

The term “about” as used herein when referring to a measurable value, such as, for example, an amount or concentration and the like, is meant to encompass variations of 20%, ±10%, ±5%, ±1%, ±0.5%, or even ±0.1% of the specified amount. A range provided herein for a measurable value may include any other range and/or individual value therein.

Additional definitions may also be provided below.

### II. A-g-B Graft Copolymers and Methods of Preparation

Combining softness, firmness, strength, and damping into a neat material is incompatible with current polymer network designs, yet such a combination is commonplace in biological tissues. Initially very soft tissues (Young's modulus: E₀˜10²-10⁵ Pa) stiffen rapidly with deformation, empowering up to a 1000-fold modulus increase (aka firmness) and the ability to withstand >10 MPa stress-at-break for protection of delicate organs against accidental rupture. Additional protection is provided a relatively high damping factor (tan δ) ranging from 0.1 of skin to 0.7 of brain tissue, which allows for absorbing shocks and vibrations in a broad frequency range.

Soft tissues are protected from accidental trauma by two intrinsic defense mechanisms: strain-adaptive stiffening and shock absorbance. Although many synthetic materials can replicate tissue softness, matching tissue strength and viscoelastic response remains challenging. Disclosed herein is the A-g-B brush-like graft copolymer platform for the design of thermoplastic elastomers as a framework for full replication of tissue softness, firmness, strength, and energy dissipation. While the bottlebrush B-block facilitates material softness, microphase separation of randomly grafted A-blocks yields a reversible physical network that concurrently enhances mechanical resilience and damping. Unlike the conventional “one molecule-one strand” approach to the network construction, one A-g-B molecule spans multiple meshes, which reinforces the integrity of the stress-supporting scaffold. Furthermore, the design-by-architecture approach empowers architectural programming of mechanical properties at a given chemical composition by adjusting dimensions of the A and B blocks. Reciprocally, the platform allows tuning of the A-g-B chemistry at a given architecture for a desired mechanical profile to satisfy application specific needs, such as moldability, tackiness, and controlled swellability. The synergistic combination of the architectural and chemical control enables precise and predictable property regulation of elastomeric materials for a broad range of practical applications including but not limited to biomedical devices, pressure-sensitive adhesives, and additive manufacturing.

An A-g-B architecture refers to a copolymer having a backbone as described herein, wherein covalently attached to the backbone are B blocks as described herein, A blocks as described herein and g spacers as described herein, wherein the g is covalently attached to the backbone and, when present, is adjacent to a B block, and thus can separate different B blocks. In embodiments, the B block can be a so-called liquid polymer like PDMS, PIB, PBA, with glass transition below room temperature. The B block side chains can be separated by g spacers to control grafting density. The g spacers may be either regular monomers (acrylate, methacrylate, styrene, glycols, etc.) or macromonomers with very short side chains (much shorter than B chains). In embodiments, the A block side chains control phase separate and form network nodes. In embodiments, they should be at least two times longer than B chains. The molar fraction of the A block is relatively small, e.g. 1-15 mol %, or about 5, 10 or 15 mol %.

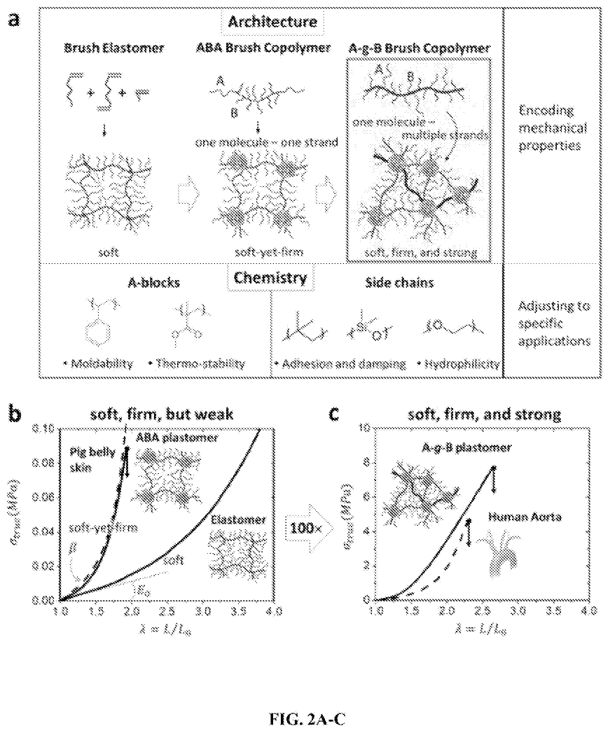

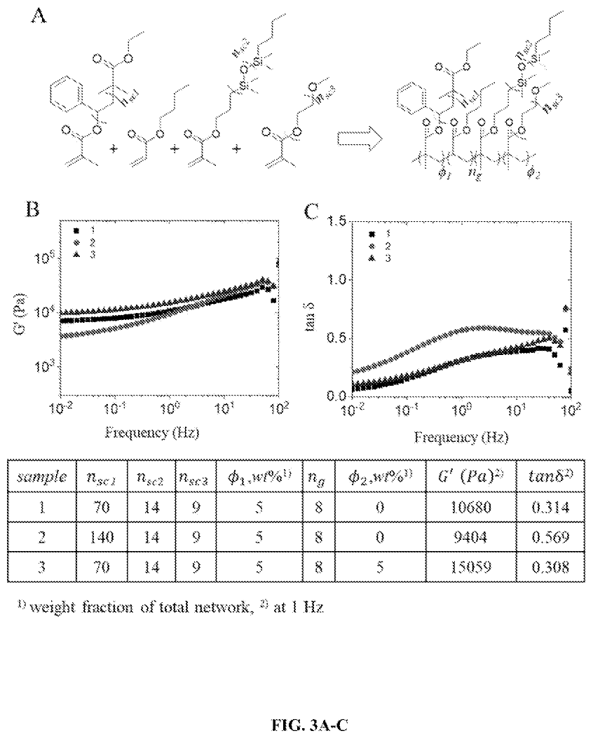

In certain embodiments, described herein is the bottlebrush graft copolymer (A-g-B) platform which delivers robust physical networks where a single molecule connects multiple meshes (as designated by the bold backbone) empowering a unique combination of softness, firmness, and strength (FIG. 2a). Furthermore, this platform accommodates broad chemical diversity of the A and B blocks to satisfy needs of specific applications such as tissue-mimetic elastomers for biomedical devices, soft robotics, wearable electronics, pressure-sensitive adhesives, and additive manufacturing.

The A-g-B brush platform enables immense expansion of the mechanical property scope of thermoplastic elastomers by independently tuning elastic and viscoelastic properties. Specifically, a unique combination of softness, firmness, and strength was attained through coordinated variation of the side chain length, grafting density, volume fraction of A blocks, and interconnectivity network cells. Furthermore, specific properties like molding, damping, and pressure sensitive adhesion were adjusted by varying the chemical composition of the A and B blocks. Specifically, A-g-B materials achieved strength of ˜10 MPa, exceeding that of blood vessels, and closely replicated frequency dependence of the damping factor of super soft brain and super-tough ligament tissues. The thermoplastic nature of A-g-B networks combined with reduced viscosity of brush-like macromolecules enables injection molding and 3D printing of shapes with molecularly tunable tissue mimetic elastic and dynamic mechanical properties.

The graft copolymerization approach allows selectively incorporating chemically dissimilar side chains each bearing a distinct function such as softness control, firmness control, adhesion control, and water uptake control (FIG. 1a).

Examples of chemical structures of side chains include, but are not limited to homopolymers and copolymers of polysiloxanes, polyacrylates, polymethacrylates, polyethers, polyolefins (e.g., polyisobutylene, polyethylene, ethylene/propylene copolymers), polyoxazolines, poly(glycerol sebacate), poly(α-esters), polyglycolide, polylactides, poly(lactide-co-glycolide), polycaprolactone, poly(ortho esters), polydioxanone, polyanhydrides, polyamides, poly(ester amide) s, polyurethanes, poly(propylene fumarate), poly(ethylene terephthalate), polycarbonate, polystyrene, poly(tetrafluoroethylene) and corresponding derivatives, copolymers and blends. Some examples of chemical composition of brush-like adhesive formulations include polydimethylsiloxane, polyisobutylene, poly(n-butyl acrylate), and polyethylene glycol (Table 1).

TABLE 1
Examples of chemical compositions of (macro)monomers in hybrid brush-like graft-
copolymers in FIG. 1 categorized based on their role in the brush-like networks.

| | | (Macro)monomer chemical |
|---|---|---|
| (Macro)monomer | (Macro)monomer role | structures |
| A | small monomers to form a spacer between | acry lates (e.g., n-butyl acrylate), |
| | neighboring side chains, which controls | methacrylates, olefins, siloxanes |
| | mechanical properties (modulus, | |
| | extensibility, firmness) | |
| B | hydrophobic side chains control adhesion, | polyolefins (e.g., |
| | tackiness and softness | polyisobutylene), polysiloxanes |
| | | (e.g., polydimethylsiloxane), |
| | | polyurethanes, polyacrylates, |
| | | polydioxanone |
| C | hydrophilic side chains to control water | polyethers (e.g., poly(ethylene |
| | sorption | glycol)), polyglycolide, |
| | | polyoxazolines |
| D | longer side chains microphase separate to | polystyrene, polymethacrylates, |
| | form physically crosslinked networks, while | polycaprolactone, polylactides |
| | their molar fraction determines the degree of | poly(propylene fumarate), |
| | polymerization of the network strand | polycarbonate, poly(lactide-co- |
| | backbone, which controls mechanical | glycolides), |
| | properties | poly(tetrafluoroethylene) |
| E | functionalized (macro)monomers enable | functionalized (macro)monomers |
| | chemical crosslinking and specific | with aldehyde, isocyanate, amine, |
| | interactions such as anchoring to substrates | diene, dienophile, epoxide, |
| | | cyanoacrylate, thiol, catechol, |
| | | oligonucleotide, hydrogen bond |
| | | donor/acceptor group, alkyne, |
| | | alkoxy, azide, vinyl, acrylate, |
| | | methacrylate, or hydroxyl |
| | | moieties |

In addition to the difference in chemical composition, the graft-copolymer assembly allows concurrently controlling architectural parameters such as degrees of polymerization n_{sc}, n_{g}, nₓ, n_{bb} of the different structural elements (FIG. 1b). As shown before, mechanical properties of elastomers are largely controlled by the brush-like network architecture determined by n_{sc}, n_{g}, nₓ and volume fraction of chemically different side chains [Sheiko, S. S., Vatankhah, M.; Daniel W. “Solvent-Free Supersoft and Superelastic Materials.” U.S. patent application Ser. No. 15/742,741, 2018].

Each type of side chains carries a distinct function and makes distinct contributions to physical properties of multifunctional thermoplastic elastomers (FIG. 1c). Examples of these functions and contributions are outlined below:

1) Multiple micro phase-separating side chains D randomly distributed along the backbone create a physical network with microdomains playing the role of crosslinks. These crosslinks are reversible, which allows different manufacturing technologies including molding, additive manufacturing, and recycling.

2) Dangling side chains B in network strands empower a multiplicity of distinct effects on materials properties. Specifically, they favor softness, enhanced firmness, control viscoelastic dissipation, and adhesion respectively empowered by the large strand size, backbone extension due to steric repulsion between densely grafted side chains, multiple relaxation modes, and larger contact area with a substrate.

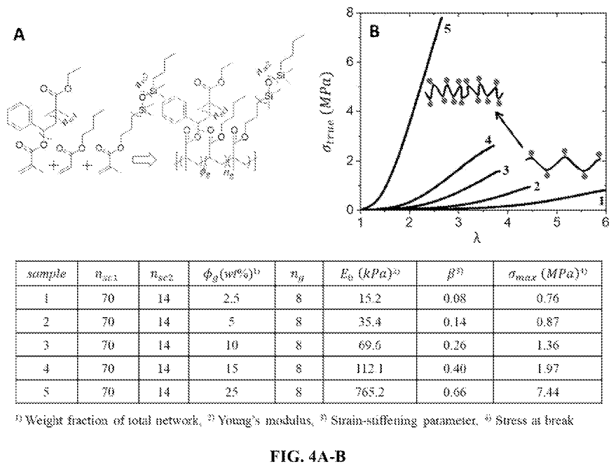

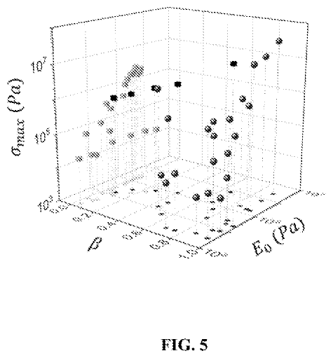

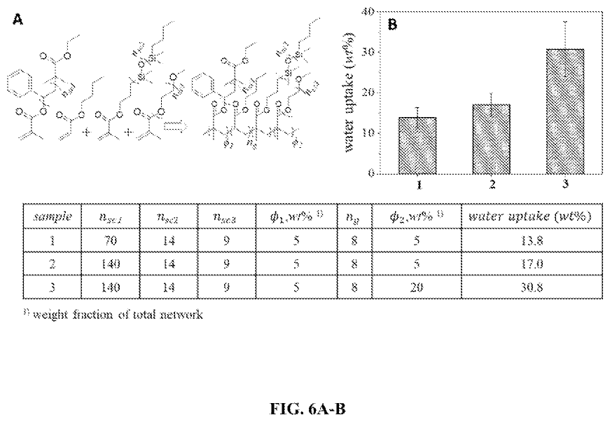

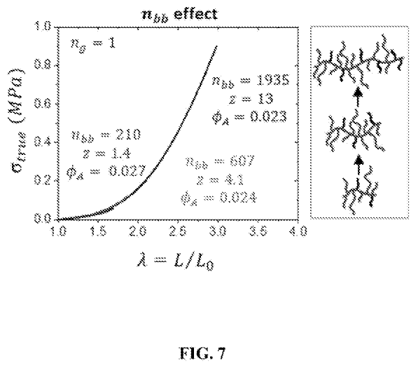

3) The ability to control fractions of chemically different side chains allows independent tuning of different mechanical properties. For example, FIG. 2 shows how to vary modulus at nearly constant damping/adhesion. FIG. 3 shows how to vary damping/adhesion at constant modulus. Simultaneous control of both elasticity and strength is demonstrated in various material stress-strain curves in FIG. 4, with the parameters of softness, firmness and strength graphically compared to brush-based elastomers and tissue in FIG. 5.

4) Unlike the conventional ABA triblock copolymers [Sheiko, S. S., Vatankhah, M. “Self-assembled elastomers with molecularly encoded tissue-like softness, strain-adaptive stiffening, and coloration” U.S. Patent App. 62/553,870 2017 Sep. 3], each macromolecule of brush-like graft copolymer (FIG. 1b) may contain multiple phase-separating side chains D and therefore becomes involved in multiple network strands. This enhances resilience and strength of physical networks as a single side chain withdrawal from a microdomain will not cause strand dissociation and hinder network fracture (FIG. 4). For examples, thermoplastic elastomers with a high fraction of side chains D demonstrate strength up to 10 MPa which is more than 10 times higher than ABA plastomers and on par with the strength of biological tissues such as skin.

5) The ability to insert chemically different side chains allows imparting specific features without significantly changing the architecturally controlled bulk mechanical properties. For example, inserting hydrophilic side chains C, enhances water sorption without significantly affecting mechanical properties.

6) The ability to add a controlled fraction of specific functional groups including, but not limited to isocyanates, epoxies, aldehydes, amines, and Diels-Alder couples to side chains to enable functionality such as in-situ curing, chemically anchoring/adhering to substrates, material sensing, and capturing and filtering small molecules.

7) The ability to enable solvent-free, leachable-free and injectable self-curing with minimal or no side products, desired curing duration at various environmental or physiochemical conditions.

Different types of material properties are required for a myriad of practical applications including pressure-sensitive adhesives, sealants and surgical glues, and synthetic tissue for soft robots. As an example, in biomedical applications, adhesives are used to attach medical devices (e.g., bandages, patches, grounding pads, ostomy appliances, and prostheses) to the body. Other biomedical applications such as tissue fixation, chondral fracture repairs, wound sealing, and replacement for sutures require chemically bonding to tissues (e.g., surgical glues). Present strategies to design these formulations mostly involve empirical combinations of assorted ingredients that typically contain leachable residues imparting several complications such as fluctuating mechanical properties and provoking an inflammatory response over time. Additionally, state-of-the-art biomedical formulations fail to adopt the mechanical properties (e.g., softness, strength, and firmness) of biological tissues, and their chemical inflexibility fails to resist influences from bodily fluid swelling, variable pH, salinity, and protein content. Thus, given the high environmental stability, tissue-mimetic mechanical properties, and solvent-free, non-leachable nature of the developed materials, their potential applications include both medical and non-medical sectors. In certain embodiments, the developed materials are readily applicable as non-leachable solvent-free pressure sensitive adhesives. As adhesives, the developed materials are readily applicable to attach both medical devices (e.g., bandages, topical patches, grounding pads, ostomy appliances, and prostheses) and non-medical devices (e.g., wearable electronics) together and to the body. In certain embodiments, the developed materials are readily applicable as surgical glues with precise adaption of the stress-strain behavior of surrounding tissue for soft and hard tissue fixation, and replacement for sutures to bond tissues. In certain embodiments, the developed materials are readily applicable as tissue scaffolds in multi-tissue regeneration applications with precise stress-strain behavior of surrounding tissue. In certain embodiments, the developed materials are readily applicable as biomedical and industrial sealants, both as pre-molded films/patches as well as injectable formulations to seal hard-to-reach regions. In certain embodiments, the developed materials are readily applicable for coatings of a broad range of substrates (e.g., polymers, metals, ceramics, and glass) for use in biomedical devices and biomaterials (e.g., antifouling and anti-inflammatory coating of implantable glucose sensors and pancreatic islet cells transplantation). In certain embodiments, the developed materials are readily applicable in the soft robotics industry as bodies to enable interaction with soft and fragile objects. In certain embodiments, the developed materials are readily applicable as anti-vibration elastomers for various applications including but not limited to automotive industry;

Incorporation of bottlebrush macromolecules into elastomers has led to a breakthrough in mechanical property control of polymer networks. Due to the architectural disentanglement of brush-like strands, it became possible to prepare supersoft elastomers with a modulus down to 100 Pa (FIG. 2b). However, brush networks with covalent crosslinks show relatively low firmness, β<0.2, defined by the strain-stiffening parameter

$$β = 〈 {R}_{in}^{2} 〉 / {R}_{max}^{2}$$

—a ratio of the mean square end-to-end distance,

$$〈 {R}_{i n}^{2} 〉 ,$$

of undeformed strands to their contour length, Rₘₐₓ. Firmness was subsequently increased through the design of ABA block copolymer networks (middle panel, FIG. 2a), where the bottlebrush backbones get additionally extended by microphase segregation of A and B blocks yet remain stretchable due to the “hidden length” of coiled A-blocks inside the network nodes. These thermoplastic elastomers with bottlebrush strands demonstrated unprecedented firmness up to β≅0.9 on par with biological tissues, while maintaining the tissue-like softness (E₀≅10³-10⁵ Pa) and extensibility (λₘₐₓ≅2-4) (FIG. 2b). However, the ABA systems possess a relatively low strength of σₘₐₓ<0.5 MPa, which is ˜10 times weaker than that of stress-supporting tissues such as skin and blood vessels (Table A-1). The low strength is ascribed to the “one strand-one molecule” construction, where the deformation-caused withdrawal of an A block from a network node leads to its coiling and strand removal from the load-bearing scaffold.

To address this issue, disclosed herein are A-g-B bottlebrush graft copolymers (“-g-” denotes long A-blocks randomly grafted to a bottlebrush backbone of block B), where one brush molecule may span multiple network cells to enhance network resilience (FIG. 2c). When an A-block is dislodged from an A-domain during deformation, the corresponding strand remains strained, which concurrently maintains the load-bearing scaffold, improves tension distribution, and allows for re-association of the loose A-block with neighboring A-domains. Even though the A-g-B networks are less perfectly organized than the ABA networks, they demonstrate ˜10-100× strength enhancement compared to ABA systems, attaining θₘₐₓ=8 MPa greater than human aorta (FIG. 2c, Table A-1). Furthermore, self-assembled A-g-B networks can be reversibly disassembled either by heating above the order-disorder temperature or dissolution in a good solvent, which facilitates materials processability.

TABLE A-1
Structural and mechanical parameters of soft biological tissue.

| Sample | E⁶⁾ (MPa) | β⁶⁾ | ${E}_{0}^{7 )} ( kPa )$ | σₘₐₓ⁹⁾ (MPa) |
|---|---|---|---|---|
| Human abdominal skin | 1.20 | 0.93 | 164 | 13 |
| Porcine brain tissue | 1.00 | 0.72 | 8.90 | 2.4 |
| Artery adventitia A | 0.35 | 0.91 | 28.8 | 2.5 |
| Pig belly | 5.46 | 0.45 | 13.8 | 1.2 |
| Porcine aorta | 19.8 | 0.67 | 128 | 2.0 |
| Bovine nuchal ligament | 0.15 | 0.93 | 20.0 | 5.0 |
| Vena cava | 3.40 | 0.75 | 37.4 | 4.5 |
| Carotid artery | 0.35 | 0.91 | 28.8 | 2.8 |
| Skeletal muscle tissue | 2.02 | 0.54 | 7.00 | 2.8 |
| Human aorta: superior | 21.0 | 0.72 | 185 | 6.7 |
| Human aorta: high | 105 | 0.55 | 380 | 4.6 |
| Human aorta: Sinotubular junction | 50.1 | 0.45 | 381 | 7.1 |

| | |
|---|---|
| Ligament | Frequency Sweep from Fig. 4d |
| Bovine Paracardium | Frequency Sweep from Fig. 4d |
| Porcine Brain | Frequency Sweep from Fig. 4d |

TABLE A-2
Architectural parameters and mechanical properties of A-g-B brush copolymers.

| | | | | | | | | | | | | |
|---|---|---|---|---|---|---|---|---|---|---|---|---|
| Sample | n_{g}¹⁾ | n_{sc} | nₓ²⁾ | n_{A}³⁾ | ϕ_{A}⁴⁾ | n_{bb}⁵⁾ | E⁶⁾ (kPa) | β⁶⁾ | ${E}_{0}^{7 )} ( kPa )$ | λ_{fit}⁸⁾ | λₘₐₓ⁹⁾ | σₘₐₓ¹⁰⁾ (kPa) |

poly[MMA-g-(PDMS/PMMA)]

| | | | | | | | | | | | | |
|---|---|---|---|---|---|---|---|---|---|---|---|---|
| 090320_2 | 1 | 14 | 149 | 27 | 0.015 | 1935 | 5.65 | 0.31 | 9.8 | 2.10 | 2.81 | 104 |
| 090320_1 | 1 | 14 | 149 | 62 | 0.034 | 1935 | 14.4 | 0.40 | 31.4 | 1.90 | 2.92 | 605 |
| 090320_4 | 1 | 14 | 149 | 81 | 0.044 | 1935 | 20.5 | 0.46 | 53.1 | 1.70 | 2.98 | 898 |
| 091720_2 | 1 | 14 | 149 | 46 | 0.025 | 607 | 12.2 | 0.26 | 18.9 | 1.57 | 2.34 | 51.2 |
| 091720_3 | 1 | 14 | 149 | 63 | 0.034 | 607 | 10.5 | 0.45 | 26.6 | 1.65 | 2.07 | 94.3 |
| 111620_2 | 1 | 14 | 149 | 82 | 0.044 | 607 | 14.2 | 0.52 | 45.8 | 1.44 | 1.87 | 122 |
| 111620_1 | 1 | 14 | 149 | 148 | 0.077 | 607 | 15.1 | 0.52 | 48.6 | 1.64 | 1.84 | 144 |
| 090420_3 | 1 | 14 | 149 | 53 | 0.029 | 210 | 7.30 | 0.42 | 16.9 | 1.80 | 2.04 | — |
| 090420_2 | 1 | 14 | 149 | 66 | 0.036 | 210 | 4.38 | 0.51 | 13.6 | 1.45 | 1.52 | 10.6 |
| 090420_1 | 1 | 14 | 149 | 99 | 0.053 | 210 | 11.7 | 0.54 | 40.7 | 1.28 | 1.69 | 36.8 |
| 090420_4 | 1 | 14 | 149 | 152 | 0.079 | 210 | 13.6 | 0.57 | 53.5 | 1.54 | 1.63 | 84.4 |

poly[nBA-ran-MMA-g-(PDMS/PMMA)]

| | | | | | | | | | | | | |
|---|---|---|---|---|---|---|---|---|---|---|---|---|
| 100920_2 | 4 | 14 | 139 | 85 | 0.131 | 1923 | 36.3 | 0.18 | 47.9 | 2.50 | 3.4 | 606 |
| 100920_1 | 4 | 14 | 139 | 178 | 0.241 | 1923 | 61.6 | 0.29 | 103 | 2.20 | 2.83 | 1223 |
| 100920_5 | 4 | 14 | 139 | 205 | 0.268 | 1923 | 77.3 | 0.33 | 142 | 1.96 | 2.96 | 2572 |
| 100820_3 | 8 | 14 | 142 | 48 | 0.112 | 1959 | 15.8 | 0.09 | 18.0 | 3.32 | 4.95 | 558 |
| 100820_2 | 8 | 14 | 142 | 147 | 0.278 | 1959 | 50.4 | 0.13 | 60.9 | 3.25 | 5.21 | 2653 |
| 100820_1 | 8 | 14 | 142 | 187 | 0.329 | 1959 | 68.6 | 0.15 | 86.1 | 3.00 | 4.62 | 2674 |

poly[nBA-ran-MMA-g-(PDMS/PS)]

| | | | | | | | | | | | | |
|---|---|---|---|---|---|---|---|---|---|---|---|---|
| 062022_1* | 8 | 14 | 844 | 60 | 0.03 | 1021 | 11.4 | 0.08 | 18.5 | 2.91 | 3.46 | 81.0 |
| 030822_1** | 8 | 14 | 502 | 60 | 0.05 | 1061 | 47.4 | 0.18 | 78.1 | 2.37 | 2.78 | 256 |
| 030822_2 | 8 | 14 | 315 | 60 | 0.08 | 2807 | 77.1 | 0.22 | 110 | 2.13 | 2.71 | 610 |
| 030822_3 | 8 | 14 | 155 | 60 | 0.15 | 2854 | 209 | 0.44 | 528 | 1.64 | 2.23 | 2588 |
| 030822_4 | 8 | 14 | 86 | 60 | 0.24 | 4425 | 210 | 0.72 | 1853 | 1.24 | 2.09 | 5430 |
| 030822_5 | 10 | 14 | 178 | 60 | 0.15 | 5573 | 286 | 0.50 | 858 | 1.52 | 2.57 | 6000 |

poly[nBA-ran-MMA-g-(PIB/PS)]

| | | | | | | | | | | | | |
|---|---|---|---|---|---|---|---|---|---|---|---|---|
| 030722_1 | 8 | 18 | 503 | 60 | 0.048 | 940 | 46.8 | 0.16 | 59.9 | 2.49 | 3.85 | 740 |
| 030722_2 | 8 | 18 | 216 | 60 | 0.108 | 1425 | 170 | 0.20 | 232 | 2.32 | 4.67 | 3520 |
| 030722_3 | 8 | 18 | 218 | 60 | 0.106 | 938 | 133 | 0.23 | 193 | 2.35 | 3.46 | 2040 |

¹⁾Grafting density of side chains on the backbone with BA spacer.
²⁾Number average degree polymerization of brush backbone between glassy block side chains that physical crosslink.
³⁾Number average degree polymerization of each glassy block side chain as determined by ¹H-NMR.
⁴⁾Volume fraction glassy block, ρ_{PMMA} = 1.15 g/mL, ρ_{PIB} = 0.92 g/mL, ρ_{PS} = 1.02 g/mL, ρ_{PDMS} = 0.96 g/mL, ρ_{PEG} = 0.94 g/mL,
ρ_{PBA} = 1.08 g/mL.
⁵⁾Number average degree polymerization of the total brush strand.
${}^{6 )} Structural modulus E ∼ 1 / ( {n}_{bb} ( {n}_{sc} + 1 ) ) and strain ‐ stiffening parameter β = 〈 {R}_{in}^{2} 〉 / {R}_{max}^{2} are fitting parameters in equation S 1.$ ⁷⁾Apparent Young’s modulus which can be determined either as tangent of a stress-strain curve at λ → 1 or from the fitting equation S2.
⁸⁾Elongation range used for fitting equation S1 before deviation from the theory.
⁹⁾Maximum true stress and elongation at sample rupture.
¹⁰⁾Maximum stress-at-break (strength) of A-g-B brush copolymer samples.
*Gₑ = 1.9 kPa.
**Gₑ = 5.1 kPa.

### III. Pressure Sensitive Adhesives and Methods of Preparation

Brush architecture allows varying the work of adhesion within many orders of magnitude without using additives and altering chemical composition.

Pressure sensitive adhesives (PSAs) are ubiquitous materials within a spectrum that span office supplies to biomedical devices. Currently, the ability of PSAs to meet the needs of these diverse applications relies on trial-and-error mixing of assorted chemicals and polymers, which inherently entails property imprecision and variance over time due to component migration and leaching. Described herein is a precise additive-free PSA design platform that predictably leverages polymer network architecture to empower comprehensive control over adhesive performance. Utilizing the chemical universality of brush-like elastomers, we encode work of adhesion ranging five orders of magnitude with a single polymer chemistry by coordinating brush architectural parameters-side chain length and grafting density. This is a design-by-architecture approach.

Adhesives fall into two main categories: structural adhesives, such as glues, and pressure sensitive adhesives (PSAs), such as mounting tapes, both relying on large interfacial contact area to bond with a substrate. Structural adhesives achieve interfacial contact by administering fluid resins that readily wet surface pores and subsequently cure, permanently binding to the substrate. However, many adhesive applications require removability or merely prohibit the use of fluids. These issues are addressed by the employment of solid PSAs where the contact area increases over time through viscoelastic compliance under applied pressure. The range of viscoelastic behaviors for these materials encompasses a diverse class of adhesives, from easily removable adhesive paper note cards to shear resistant ostomy bags. Current approaches to navigate through this wide property space rely on the exploratory mixing of polymer networks with additives, such as tackifiers and plasticizers, which entails property drift and surface contamination due to chemical migration (FIG. 1). This presents a challenge to develop an alternative route to regulate material viscoelasticity without using additives and altering chemical composition.

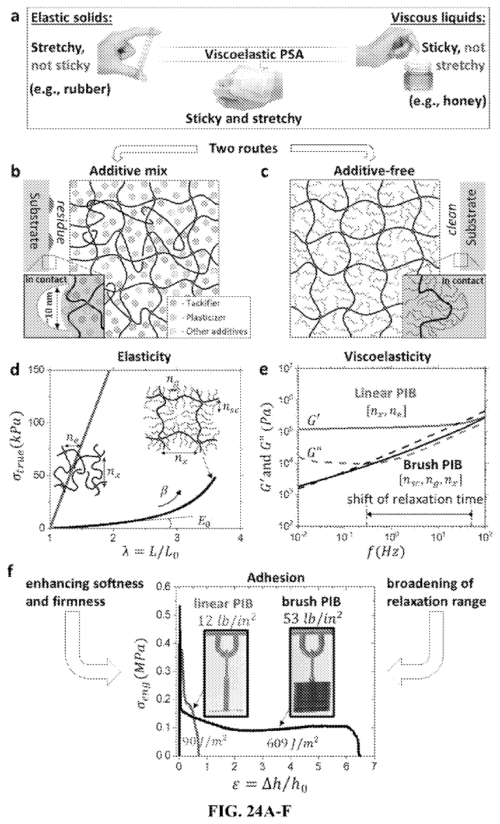

Viscoelasticity defines both bonding behavior under pressure and PSA deformation upon debonding accompanied by cavitation and fibrillation processes. The bonding-debonding dualism makes optimization of performance especially challenging, as it mandates a convolution of oxymoronic properties. PSAs should be sticky like viscous liquids, yet removable like elastic solids to leave a clean surface after debonding (FIG. 24a). They should also be simultaneously soft and strong to facilitate substrate wetting upon bonding and withstand cohesive rupture upon debonding, respectively. Additionally, bonding and debonding typically occur at different time scales-slow bonding and much faster peel off, which imposes specific requirements for frequency dependence of the storage and loss moduli within the PSA-relevant frequency range of 0.01 Hz to 100 Hz. Current PSA designs manage this interplay of conflicting demands through controlled mixing of polymers with specific types of low molecular weight additives. Polymer networks alone are too stiff due to chain entanglements (Gₑ˜10⁵ Pa), so large quantities (up to 50 wt %) of tackifiers and plasticizers are required to dilute the network strands and satisfy the Dahlquist criterion (shear modulus G<10⁵ Pa) for spontaneous wetting of the surface roughness (FIG. 24b). However, additives are prone to migration and trigger considerable shifts in the modulus frequency spectrum, which may alter the debonding behavior or even completely forfeit adhesion. Moreover, balancing the conflicting effects in multicomponent materials is an arduous feat with limited resources for property precision, predictability, and stability over time.

Described herein is an alternative approach to PSA design by introducing brush architecture into network strands (FIG. 24c). This empowers encoding of viscoelastic properties without changing chemical composition or using additives. In particular, tethered side chains facilitate both bonding and debonding on different length and time scales. During bonding, side chains effectively play the role of diluents that disentangle brush backbones to decrease Young's modulus (E₀) from 10⁵ to 10² Pa and promote wetting of microscopic pores. In addition, the free-ended side chains experience less entropic penalty upon wetting nanoscopic pores than dual-end anchored linear strands further increasing the contact area (FIG. 24b,c insets). In the case of debonding, steric repulsion between the densely grafted side chains enhances strain-stiffening (β=0.01-0.2), which in turn promotes cohesive strength (FIG. 24d). In parallel with the elastic response, brush architecture fundamentally changes the network viscoelastic profile by shifting both the characteristic relaxation times (e.g., Rouse time, τ_{R}) and the entanglement plateau to ensure concurrent increase of the storage and loss moduli within the PSA frequency range (FIG. 2e). By independently controlling elastic and viscoelastic properties (FIG. 2f), the utility of brush elastomers for a range of applications from removable adhesives to high shear PSAs is demonstrated, which span five orders of magnitude of W_{adh} for chemically identical materials as discussed below.

This approach enables: (i) single component non-leaching materials, (ii) a wide property range for a given chemistry, (iii) precise property control, (iv) the ability to adjust elastic and viscoelastic properties independently, and (v) stability of the adhesive performance over time. This is achieved by directly linking the work of adhesion (W_{adh}) and tack stress (σ_{tack}) to macromolecular architecture through the relaxation dynamics of brush polymer networks. Furthermore, this strategy can be advanced to physically crosslinked networks, such as thermoplastic elastomers, for hot-melt PSA molding and 3D printing.

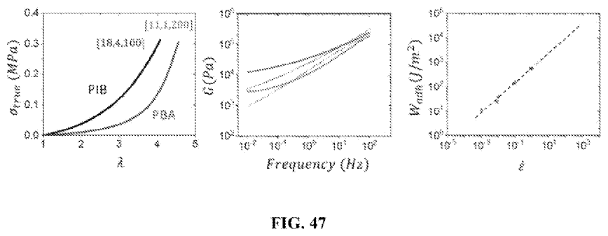

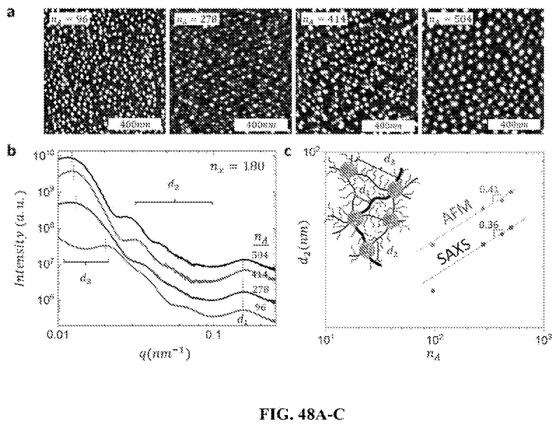

To elucidate the effect of architecture on adhesion, a broad series of brush networks with systematically varied side chain degree of polymerization (DP), n_{sc}, and grafting densities, n⁻¹, (Table 2-B) spanning different brush conformation regimes from comb to bottlebrush were prepared. To demonstrate universality of the architectural control, two series of chemically different elastomers with poly(n-butyl acrylate) (PBA) and polyisobutylene (PIB) side chains (Scheme 19) were prepared. Network structure was verified by small-angle X-ray scattering (SAXS), where the distance between brush backbones correlates with grafting density and length of the side chains (FIG. 47).

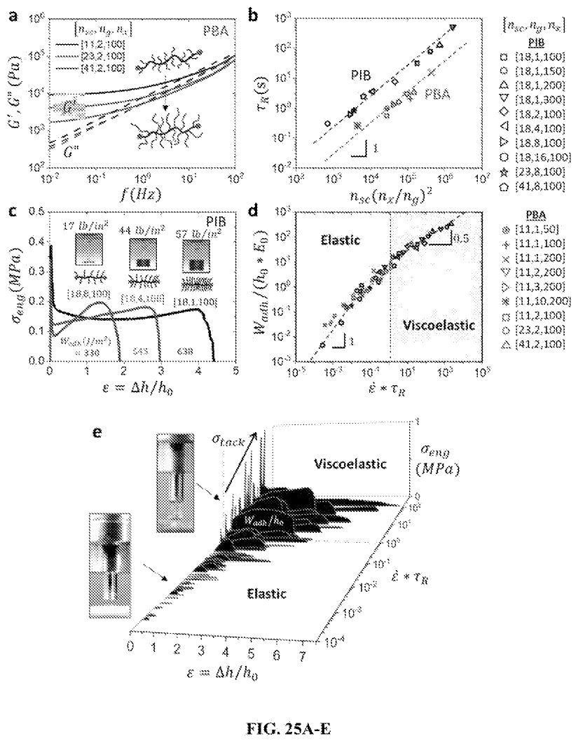

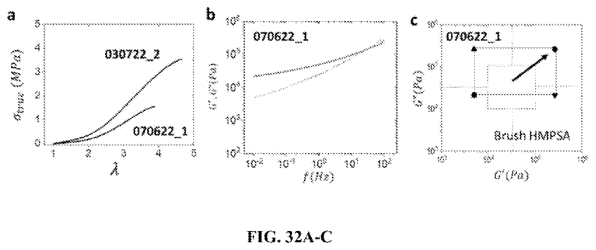

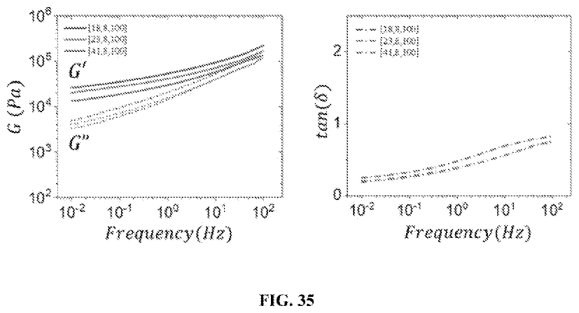

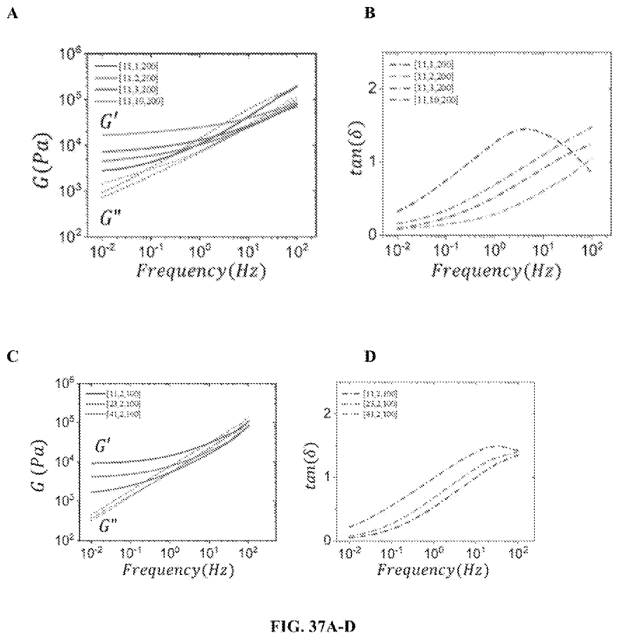

As noted above, viscoelastic properties of linear polymers are constrained by chain entanglements that set limits for both elastic modulus and the Rouse relaxation time of network strands as G>Gₑ and τ_{R}<τ₀n², where G≅0.1 MPa and n≅100 are the entanglement modulus and DP of linear polymers, whereas τ₀ is the characteristic relaxation time defined by monomer chemistry. These restrictions were overcome by covalently attaching side chains to the strand backbone, which provides two advantageous benefits for PSA performance. First, side chains effectively dilute chain entanglements by increasing nₑ˜500-2000 (depending on the side chain length and grafting density), which in turn lowers entanglement modulus, allowing synthesis of ultra-soft networks (FIG. 25a and FIGS. 32-37). Second, the side chain parameters (n_{sc} and n_{g}) provide additional degrees of freedom in controlling the relaxation times as

$${τ}_{R} \approx {τ}_{0} {{n}_{s c} ( \frac{{n}_{x}}{{n}_{g}} )}^{2} \qquad I$$

(Equation S14), allowing significant broadening of the Rouse regime with τ_{R} varying over four orders of magnitude (Table 2-B).

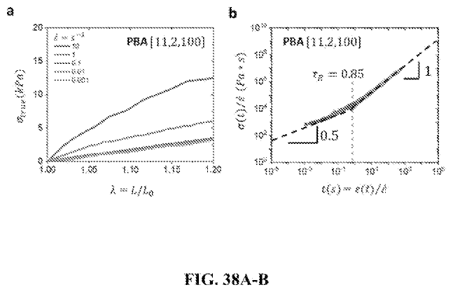

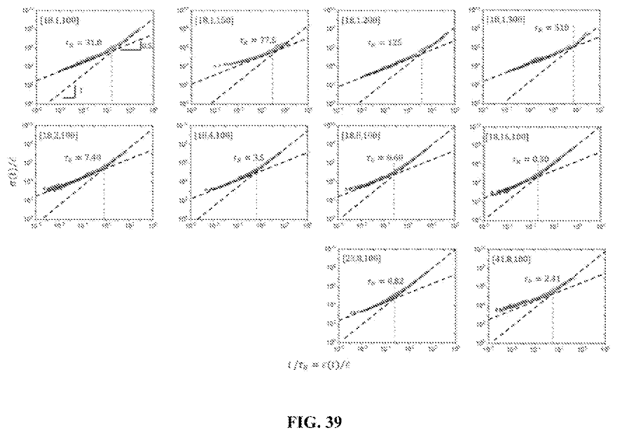

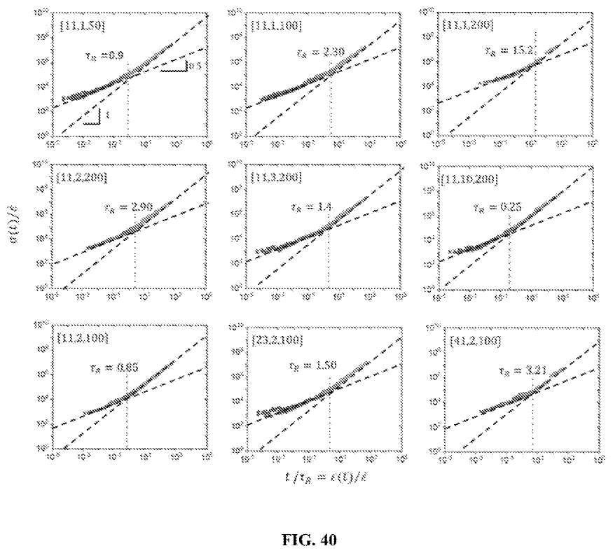

To quantify τ_{R} as an onset of Rouse relaxation, we conducted tensile tests in a broad range of strain rates (\dot{ε}=10⁻⁴-10¹ s⁻¹) for PIB and PBA brush elastomers with systematically varied n_{sc}=11-41, n_{g}=1-16, and nₓ=50-300 (FIGS. 38-40). For both brush chemistries, all architectures collapse on a respective single line according to eq. 1 (FIG. 25b), where the horizontal shift between the PIB and PBA lines is due to the change in τ₀, defined by monomer chemistry. The concomitant architectural regulation of both Gₑ and τ_{R} enables a two-decade increase in both storage (G′) and loss (G″) modulus within the PSA viscoelastic range meeting the requirements for softness, strength, and energy dissipation.

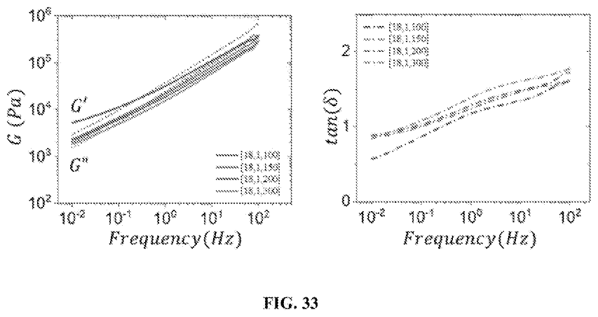

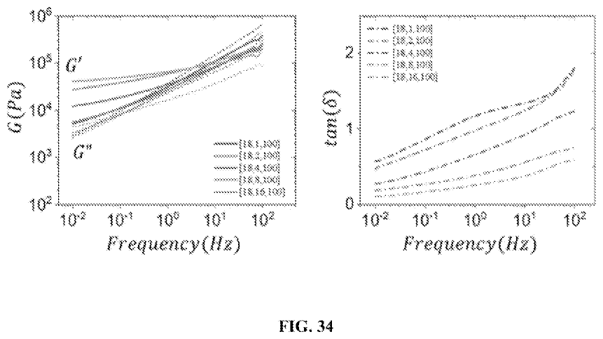

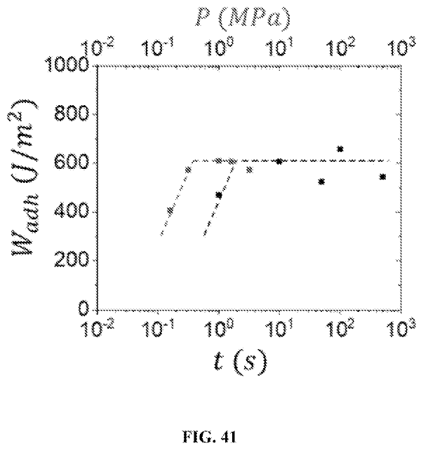

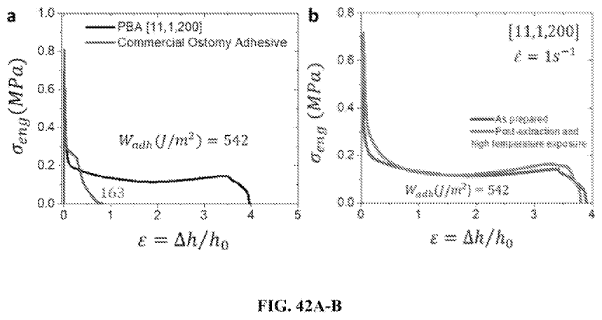

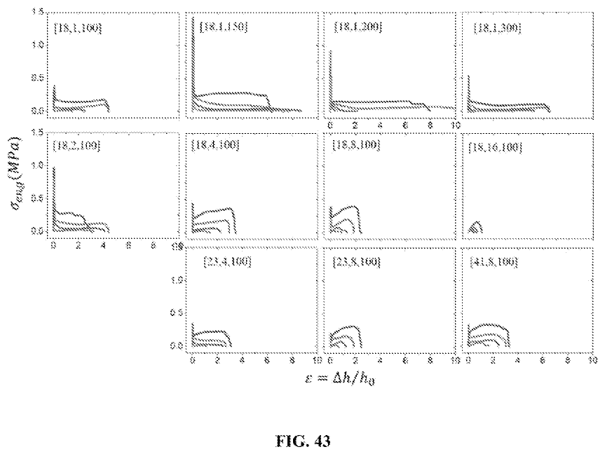

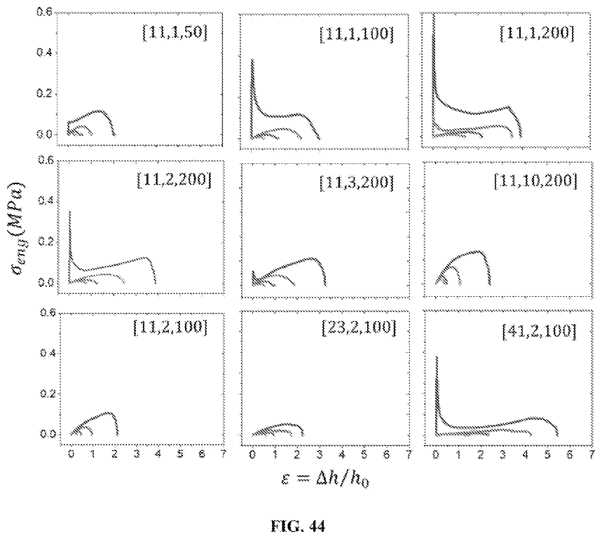

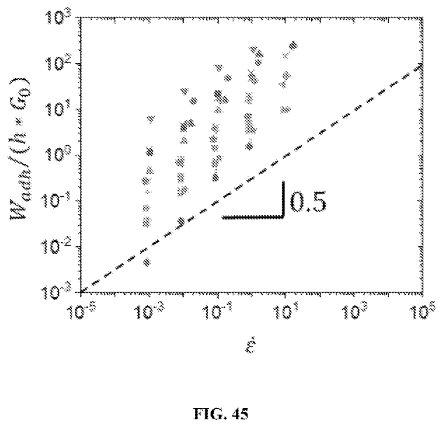

The effect of brush architecture on the adhesive performance is demonstrated by probe tack testing of the PIB and PBA elastomers at different debonding rates (FIGS. 33-45). For example, decreasing grafting density at constant n_{sc}=18 and nₓ=100 leads to a 2-fold increase in W_{adh}, σ_{tack}, and εₘₐₓ (FIG. 25c), which is consistent with the corresponding decrease of G and τ_{R} (FIG. 25a,b, FIG. 33). For a full range of the studied brush architectures and debonding rates, the architecture-controlled Rouse time allows for W_{adh} variation within five orders of magnitude (FIG. 25d, FIG. 44). Such large variations are achieved by tuning the architecture alone without altering chemical composition or using additives. Furthermore, all W_{adh} data points measured for the two chemically distinct brush PSA series at different strain rates (0.001-1 s⁻¹) fall on a single line, which corroborates the universal nature of the adhesion-by-architecture approach. There is also an apparent switch from elastic to viscoelastic debonding mechanisms observed with increasing strain rate and identified by the slope change at

$$\dot{ε} ≅ {τ}_{R}^{- 1} .$$

Below the Rouse rate

$$( \dot{ε} < {τ}_{R}^{- 1} ) ,$$

a given brush PSA debonds elastically through crack propagation along the surface where W_{adh}/E₀˜\dot{ε}τ_{R}. At higher rates

$$( \dot{ε} > {τ}_{R}^{- 1} ) ,$$

debonding occurs in the viscoelastic regime through cavitation and fibrillation, where normalized work of adhesion scales as W_{adh}/E₀˜(\dot{ε}τ_{R})^{1/2}. The ability to traverse from elastic to viscoelastic debonding through changes in a strand architecture is further corroborated by the emergence of the tack peak (FIG. 25e), which corresponds to the onset of PSA yielding. The peak vanishes at

$$( \dot{ε} < {τ}_{R}^{- 1} ) ,$$

where polymer chains have enough time to adjust to macroscopic deformation and maintain uniform stress distribution.

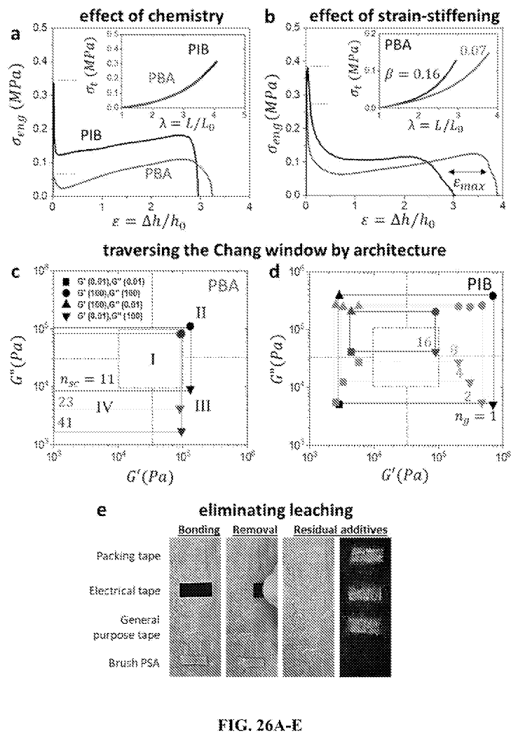

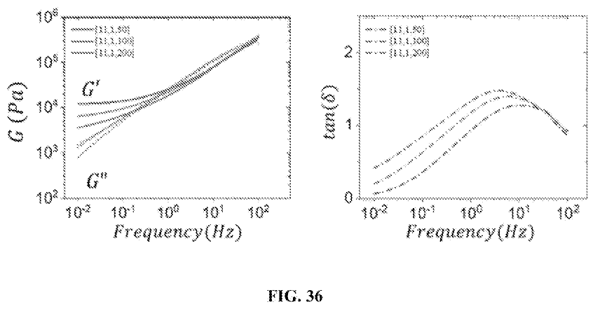

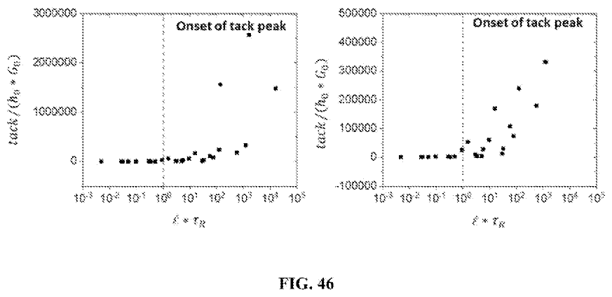

The wide-ranging control of material viscoelasticity at a given chemical composition without using additives empowers many benefits to adjust PSA performance for specific applications. For example, brush architecture permits control over the bulk deformation and adhesive response independently of one another. In FIG. 26a, two brush PSAs of different chemistries (PIB and PBA) are architecturally programmed for almost identical non-linear elastic response (E₀=30 kPa and β˜0.08) yet demonstrate considerably different W_{adh} values due to their distinct viscoelastic behaviors (FIGS. 33, 36). Antithetically, the brush architecture of PIB and PBA samples can be adjusted to nearly identical adhesion with different elastic mechanical properties (FIG. 46). The chemistry-independent control over the PSA performance is essential for applications that require a specific chemistry with desired thermomechanical stability, solvent resistance, or biocompatibility.

For a fixed chemistry, brush PSAs with the same softness for optimal bonding yet different strain-stiffening behaviors were prepared to control their debonding processes (FIG. 26b). The firmer sample, β=0.16, displays a larger σ_{tack}, but lower εₘₐₓ, resulting in nearly identical W_{adh} ≅400 J/m² (FIG. 26d). The intense strain-stiffening of bottleneck PSAs prevents cohesive fracture upon debonding. Further tuning of performance by architecture is demonstrated by the ability to traverse the so-called Chang window, which acts as a map to identify specific PSA application areas (FIG. 26c,d). And yet, all the studied additive-free brush PSA do not leave residue over time or temperature variation upon removal, which contrasts the behavior of commercial PSAs (FIG. 26e).

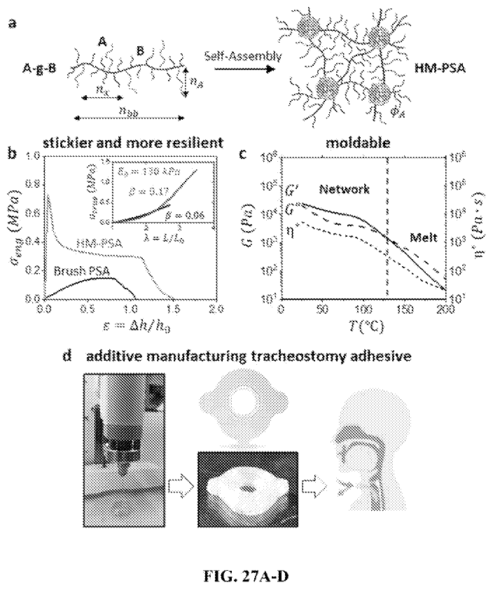

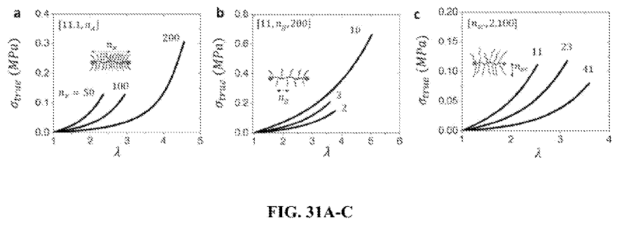

To demonstrate ubiquity in other systems, the brush platform was extended to the design of moldable PSAs, so called hot-melt pressure sensitive adhesives (HM-PSAs), with brush-like graft block copolymers denoted as A-g-B, where a controlled fraction of long A blocks were grafted along a bottlebrush B block of a different chemical composition (FIG. 27a). Specifically, A-g-B's with PIB side chains (n_{sc}) and polystyrene (PS) grafts (A blocks) of DP n_{A} undergo microphase separation to produce a physical network linked by A-block domains. The architectural control over adhesion through [n_{sc}, n_{g}, nₓ] is maintained, while the additional levers of n_{bb}, n_{A}, and ϕ_{A} are used to improve bulk firmness and cohesive strength (FIG. 27b inset, Table 2A). Even at higher modulus, E₀≅130 kPa, brush HM-PSAs demonstrate viscoelastic debonding at \dot{ε}=1 s⁻¹, where both tack and fibrillation are witnessed, suggesting their potential implementation as high shear adhesives (FIG. 27b, FIG. 31). This contrasts with brush elastomers, where greater stiffness results in a Rouse time shift constituting elastic debonding at the same strain rate. Lastly, characteristic of HM-PSAs, A-g-B network disassembly to a polymer melt at a relatively low temperature of ˜126° C. (FIG. 27c) enables molding and additive manufacturing of biomedical devices (FIG. 27d).

In embodiments, disclosed herein is a PSA design platform utilizing additive-free brush elastomers that empowers control over adhesive properties by encoding material relaxation. This architectural blueprint enables the programming of W_{adh} and debonding mechanisms by varying side chain length, grafting density, and length of the network strand in brush networks. Unveiling the fundamental structure-properties correlations between brush architecture and adhesive performance is a pivotal step toward universal design of PSAs.

### IV. Hot-Melt Pressure Sensitive Adhesives

Hot-melt pressure sensitive adhesives (HMPSAs) are used in applications from office supplies to biomedical adhesives. The major component in HMPSA formulations is thermoplastic elastomers, such as styrenic block copolymers, that provide both mechanical integrity and moldability. Since neat polymer networks are unable to establish an adhesive bond, large quantities of plasticizers and tackifiers are added. These additives enhance the adhesive performance but complicate phase behavior and property stability of the PSA. Herein, we introduce an alternative additive-free approach to HMPSA design based on self-assembly of bottlebrush graft-copolymers, where side chains behave as softness, strength, and viscoelasticity mediators. These systems maintain moldability of conventional thermoplastic elastomers, while architecturally disentangled bottlebrush network strands empower several benefits such as extreme softness for substrate wetting, low melt viscosity for molding and 3D-printing, and a broader frequency range of viscoelastic response. The brush graft-copolymers implement at least five independently controlled architectural parameters to regulate the Rouse time, work of adhesion, and debonding mechanisms.

Pressure sensitive adhesives (PSAs) are mechanically distinct materials prepared for a variety of applications such as high performance tapes, transdermal drug delivery systems, and soft robotics. A typical PSA is derived from a linear olefin, acrylate, or silicone network that can be either covalently or physically crosslinked. Physical networks, such as thermoplastic elastomers of styrenic block copolymers (SBCs), are vital in so-called hot-melt pressure sensitive adhesives (HMPSAs) as they permit processing and fabrication in melt state. Though single-component SBC networks exhibit fluidity at moderate temperatures (˜100° C.), their viscoelastic behavior does not satisfy requirements for pressure sensitive adhesion.

A primary condition for pressure sensitive adhesion is establishing large contact area to maximize the number of molecular interactions with a substrate. For an elastic material to spontaneously wet a substrate with roughness of ˜1 μm, the equilibrium modulus of the material should be below the Dahlquist criterion as G<G_{c}=0.1 MPa. Typical PSAs have modulus ranging from 10³-10⁵ Pa. Such low modulus values are difficult to achieve in conventional linear polymer systems due to chain entanglements that set a lower limit G>Gₑ, where the entanglement plateau modulus of conventional polymers ranges from Gₑ≅0.1 MPa to 1 MPa. Along with softness for bonding, an adhesive material should be stiff during debonding to transmit the bulk pull-off strain to the adhesive bonds at the interface, thus maximizing the local strain rate and tack stress. Stiffness also helps to prevent cohesive rupture of the PSA upon removal. The softness-stiffness dualism is met by configuring a particular viscoelastic response such that a soft PSA material exhibits an increase in modulus with frequency and maintains a high damping factor of tan (δ)˜1. This enables the material to be soft enough to contour rough substrates at a low bonding rate (˜0.01 s⁻¹), stiff to enhance tack stress at higher debonding rates (˜100 s⁻¹), and dissipative to increase the work of adhesion during debonding.

The prescribed viscoelastic response for HMPSAs is difficult to achieve in conventional linear polymer systems due to inherent chain entanglements that (i) set a lower limit for modulus as G>Gₑ≅ρRT/(M₀nₑ) and (ii) confine the Rouse time as

$${τ}_{R} < {τ}_{0} {n}_{e}^{2} ,$$

where ρ is mass density, and M₀—molar mass of a monomeric unit, nₑ≅100 is a typical entanglement degree of polymerization (DP), and τ₀ is the characteristic relaxation time defined by repeat unit chemistry. To overcome these barriers, large quantities (˜50 wt %) of plasticizer and tackifier are loaded into linear thermoplastic elastomers (Figure. 27a). Both types of additives dilute chain entanglements to lower the Gₑ below the Dahlquist criterion, while concurrently imposing frequency shifts on the relaxation modulus spectra. Specifically, plasticizer causes a high frequency shift and tackifier compensates for this shift by inducing the opposite effect to obtain the desired viscoelastic profile in the PSA frequency range. The resulting blends are prone to chemical migration resulting in property variation over time, interfacial leaching, and residue left on substrates after debonding (FIG. 27b, c). In addition, multicomponent systems suffer from selective miscibility of the constituting polymer blocks and additives. For example, SIS-based adhesives may become opaque due to temperature-dependent segregation of terpene, petroleum, or rosin tackifiers. Moreover, the abundance of commercial HMPSA formulations convolutes structure-property correlations making design and property control of adhesive materials a trial-and-error process.

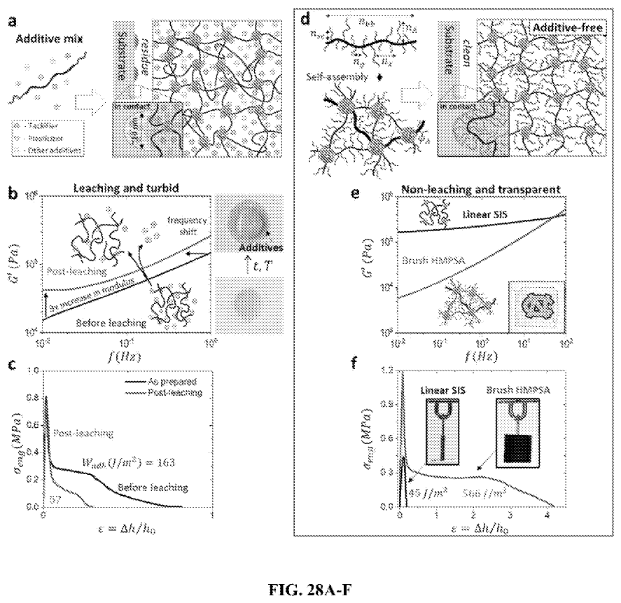

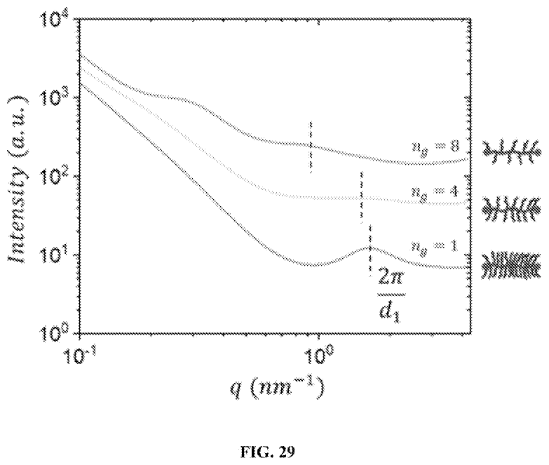

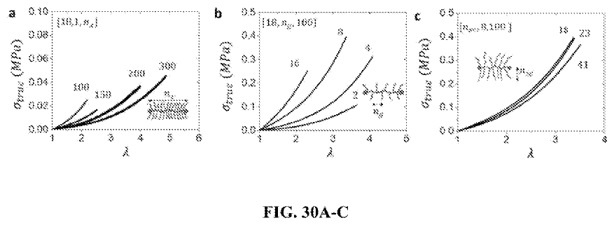

To remedy the inherent drawbacks of mixture-based HMPSA, disclosed herein is an alternative, additive-free approach that harnesses the viscoelastic demands of moldable PSAs into a single molecule composition via A-g-B bottlebrush graft copolymers, where a controlled fraction of linear A-blocks is dispersed along a bottlebrush B-block (FIG. 28d). The polymer network is formed by self-assembly of the A-g-B macromolecules due to microphase separation of the chemically and architecturally dissimilar blocks such that the glassy domains of linear A blocks play a role of network nodes, while the bottlebrush network strands regulate the viscoelastic response. The lack of macrophase separation in the single molecule A-g-B materials allows preparation of optically transparent films (FIG. 28e, inset) Depending on side chain length (˜n_{sc}) and grafting density

$$( \sim {n}_{g}^{- 1} ) ,$$

the entanglement DP may increase up to nₑ≅2000, which effectively disentangles the network strands allowing softness of G˜10³ Pa (Table B1).

TABLE B1
Mechanical Properties and Rouse time of brush HMPSAs

| | | | | | | | | | | | |
|---|---|---|---|---|---|---|---|---|---|---|---|
| n_{g}¹⁾ | n_{sc}²⁾ | nₓ³⁾ | n_{A}⁴⁾ | ϕ_{A}⁵⁾ | n_{bb}⁶⁾ | G⁷⁾ (kPa) | β⁸⁾ | ${E}_{0}^{9 )} ( kPa )$ | λₘₐₓ¹⁰⁾ | σₘₐₓ¹¹⁾ (kPa) | τ_{R}(s)¹²⁾ |

PS-g-PIB (n_{g} = 1), longer backbone (n_{bb} = 2000)

| | | | | | | | | | | | |
|---|---|---|---|---|---|---|---|---|---|---|---|
| 1 | 18 | 180 | 96 | 0.047 | 2000 | 1.8 | 0.54 | 18.1 | 2.6 | 267 | 83.0 |
| 1 | 18 | 180 | 278 | 0.126 | 2000 | 2.7 | 0.70 | 61.8 | 2.0 | 479 | 7.6 |
| 1 | 18 | 180 | 414 | 0.177 | 2000 | 2.9 | 0.72 | 76.1 | 1.9 | 480 | 4.1 |
| 1 | 18 | 180 | 504 | 0.208 | 2000 | 3.4 | 0.74 | 104 | 2.3 | 1383 | 1.6 |

PS-g-PIB (n_{g} = 1), shorter backbone (n_{bb} = 900)

| | | | | | | | | | | | |
|---|---|---|---|---|---|---|---|---|---|---|---|
| 1 | 18 | 163 | 54 | 0.030 | 900 | 1.7 | 0.56 | 19.3 | 2.0 | 46 | 95.6 |
| 1 | 18 | 163 | 76 | 0.042 | 900 | 1.8 | 0.59 | 23.3 | 2.0 | 98 | 46.0 |
| 1 | 18 | 163 | 125 | 0.067 | 900 | 3.2 | 0.68 | 66.5 | 1.8 | 216 | 10.2 |
| 1 | 18 | 163 | 468 | 0.212 | 900 | 3.4 | 0.80 | 176 | 1.6 | 427 | 3.3 |

PS-g-PIB (n_{g} = 8), nₓ variation

| | | | | | | | | | | | |
|---|---|---|---|---|---|---|---|---|---|---|---|
| 8 | 18 | 218 | 60 | 0.106 | 938 | 44.3 | 0.23 | 193 | 3.5 | 2040 | 0.83 |
| 8 | 18 | 332 | 60 | 0.075 | 1237 | 32.4 | 0.17 | 127 | 3.9 | 1540 | 3.4 |
| 8 | 18 | 503 | 60 | 0.048 | 1265 | 15.6 | 0.16 | 59.9 | 3.9 | 740 | 12.5 |
| 8 | 18 | 906 | 60 | 0.030 | 805 | 2.6 | 0.03 | 8.00 | 5.3 | 110 | 600 |

PS-g-PIB (n_{g} = 8), n_{sc} variation

| | | | | | | | | | | | |
|---|---|---|---|---|---|---|---|---|---|---|---|
| 8 | 18 | 216 | 60 | 0.108 | 1319 | 56.7 | 0.20 | 232 | 4.7 | 3520 | 0.83 |
| 8 | 23 | 165 | 60 | 0.10 | 764 | 36.3 | 0.21 | 154 | 2.9 | 1030 | 1.8 |
| 8 | 41 | 135 | 60 | 0.10 | 465 | 8.7 | 0.25 | 39.3 | 3.09 | 410 | 15.6 |

PS-g-PIB (n_{g} = 8), longer A block n_{A} = 120

| | | | | | | | | | | | |
|---|---|---|---|---|---|---|---|---|---|---|---|
| 8 | 18 | 450 | 120 | 0.10 | 854 | 24.3 | 0.24 | 94.9 | 3.84 | 1560 | 2.5 |
| 8 | 18 | 803 | 120 | 0.05 | — | 6.7 | 0.16 | 25.6 | 4.75 | 980 | 26.9 |

PS-g-PIB (n_{g} = 4)

| | | | | | | | | | | | |
|---|---|---|---|---|---|---|---|---|---|---|---|
| 4 | 18 | 149 | 60 | 0.10 | 1134 | 28.2 | 0.37 | 17 | 2.88 | 1820 | 0.8 |
| 4 | 18 | 360 | 60 | 0.05 | 1259 | 11.9 | 0.22 | 51.0 | 3.63 | 790 | 4.1 |
| 4 | 41 | 112 | 60 | 0.10 | 251 | 9.9 | 0.47 | 79.6 | 2.19 | 370 | 3.98 |

¹⁾Grafting density of side chains on the backbone with BA spacer.
²⁾Degree of polymerization of PIB side chains in the B-block.
³⁾Number average degree polymerization of brush backbone between glassy block side chains that physical crosslink.
⁴⁾Number average degree polymerization of each glassy block side chain as determined by ¹H-NMR.
⁵⁾Volume fraction glassy block, ρ_{PMMA} = 1.15 g/mL, ρ_{PIB} = 0.92 g/mL, ρ_{PS} =1.02 g/mL, ρ_{PDMS} = 0.96 g/mL,
ρ_{PEG} = 0.94 g/mL, ρ_{PBA} = 1.08 g /mL.
⁶⁾Number average degree polymerization of the total brush strand.
⁷⁾Structural shear modulus and
⁸⁾strain-stiffening parameter are fitting parameters in eq S1.
⁹⁾Apparent Young’s modulus which can be determined either as tangent of a stress-strain curve at λ → 1 or calculated from eq S2.
¹⁰⁾Maximum elongation at sample rupture.
¹¹⁾Maximum stress-at-break (strength) of brush HMPSAs.
¹²⁾Experimentally determined Rouse time of brush HMPSAs.

The disentanglement of network strands expands the Rouse relaxation regime as τ_{R}=τ₀n_{sc} (nₓ/n_{g})² to allow the brush PSA to satisfy the Dahlquist criterion by reducing the modulus at bonding frequencies (FIG. 28e), while side chains exhibit limited entropic penalty to wet nanoscale pores (FIG. 28d, inset). In addition, steric repulsion between densely grafted side chains extends the backbone into the finite extensibility range, resulting in modulus increase with deformation, which prevents cohesive rupture of soft HMPSAs. The strain-stiffening behavior is quantified by the parameter.

$$β ≡ 〈 {R}_{i n}^{2} 〉 / {R}_{max}^{2}$$

describing the ratio of the mean square end-to-end distance to square of contour length of a network strand. Additional strength enhancement is provided by mesh interconnectivity in A-g-B networks given multiple A-blocks per network strand. The combination of the intrinsic softness, firmness, and interfacial wetting results in a dramatic enhancement of the adhesive performance for brush HMPSAs (FIG. 28f). It is important to emphasize that the architectural control over thermomechanical properties is performed without using additives, which allows formulating HMPSA materials for a wide range of applications without detrimental effects of uncontrolled leaching and phase transformations.

### V. Methods of Preparation

In certain embodiments, the subject matter described herein is directed to a method of preparing a hybrid brush-like graft copolymer, the method comprising: introducing a brush architecture into network strands of a copolymer to encode a predetermined viscoelastic or elastic property.

In certain embodiments, the brush architecture is programmably predetermined to modulate the Rouse time τ_{R} and/or modulate the entanglement plateau modulus Gₑ. In aspects of these embodiments, the modulation of the Rouse time τ_{R} and the modulation of the entanglement plateau modulus Gₑ is independent of each other.

In certain embodiments, the subject matter described herein is directed to a method of preparing a hybrid brush-like graft copolymer that is a pressure sensitive adhesive, the method comprising: introducing a brush architecture into network strands of a copolymer to facilitate the bonding of the pressure sensitive adhesive at different length and time than the debonding of the pressure sensitive adhesive.

In aspects of all of these embodiments, the method does not comprise additives that effect viscoelasticity.

In aspects of all of these embodiments, the method results in modulating, i.e., increasing the range or magnitude of W_{adh} for copolymers that comprise chemically identical components. In aspects of these embodiments, the hybrid brush-like graft copolymer does not contain any additives that substantially modulate a viscoelastic property or that may leach from the copolymer.

In certain embodiments, the subject matter described herein is directed to a method of preparing a hybrid brush-like graft copolymer, the method comprising:
i. determining a target value for one, or two, or three, or four, or five, or one or more, or two or more, or three or more, or four or more, or five or more, or each of of the copolymer;

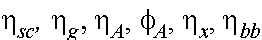

ii. forming a mixture by contacting a first macromonomer that is a mechanical regulator with two or more additional macromonomers that are each different from the first macromonomer;
   and,
iii. subjecting the mixture to polymerization selected from the group consisting of free radical polymerization (FRP), atom transfer radical polymerization (ATRP), SARA ATRP, anionic polymerization, and reversible addition-fragmentation chain-transfer polymerization (RAFT),
wherein, a hybrid brush-like copolymer is prepared having the target value(s).

In certain embodiments, the target value is attained without the addition of any additives that materially alter the viscoelastic and/or adhesive properties of the copolymer. As used herein, materially alter refers to a measurable change in such a property that can be linked to the addition of an additive added for a different purpose, such as a dye. Such additives that do not materially alter viscoelastic and/or adhesive properties are known in the art.

In certain embodiments, the value of n_{sc} is from about 10 to about 100.

In certain embodiments, the value of n_{g} is from about 1 to about 16.

In certain embodiments, the value of n_{A} is from about 20 to about 500.

In certain embodiments, the value of ϕ_{A} is from about 0.01 to about 0.40.

In certain embodiments, the value of nₓ is from about 50 to about 2000.

In certain embodiments, the value of n_{bb} is from about 100 to about 5000.

In certain embodiments, the subject matter described herein is directed to a method of modulating the W_{adh} of a copolymer by determining a target value for one, or two, or three, or four, or five, or one or more, or two or more, or three or more, or four or more, or five or more, or each of

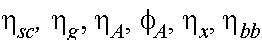

of the copolymer, and preparing the copolymer as described herein.

The subject matter described herein includes, but is not limited to, the following embodiments:

In certain embodiments, the subject matter described herein is directed to a hybrid brush-like graft copolymer wherein the Geis below the Dahlquist criterion. In certain aspects of these embodiments, the hybrid brush-like graft copolymer is a single molecule composition.

In certain embodiments, the subject matter described herein is directed to a hybrid brush-like graft copolymer, single-molecule composition that is additive-free, wherein the hybrid brush-like graft copolymer is an:

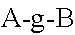

bottlebrush graft copolymer, wherein a controlled amount of linear A blocks are dispersed along a bottlebrush B-block. In aspects of these embodiments, the hybrid brush-like graft copolymer, single-molecule composition that is additive-free can be a component in an article, wherein the article does not provide such an additive. In aspects of these embodiments, the hybrid brush-like graft copolymer, single-molecule composition that is additive-free can be a component in a composition, wherein the composition does not provide such an additive.

In certain embodiments, the hybrid brush-like graft copolymer is a single molecule composition that does not undergo phase separation. In certain aspects of these embodiments, the hybrid brush-like graft copolymer is transparent. In certain aspects of these embodiments, the hybrid brush-like graft copolymer is a transparent film.

In certain embodiments, the subject matter described herein is directed to a hybrid brush-like graft copolymer, wherein the copolymer has:
a n_{g} value from about 1 to about 16; and/or,
a n_{A} value from about 20 to about 500; and/or,
a ϕ_{A} value from about 0.01 to about 0.40; and/or,
a nₓ value from about 50 to about 2000; and/or,
a n_{bb} value from about 100 to about 5000;
   wherein each value is programmably predetermined but is not limited to the ranges above.

In certain embodiments, the subject matter described herein is directed to a hybrid brush-like graft copolymer, wherein:
from about 1% to about 70% of the copolymer is programmably predetermined to tune n_{g} to a desired value; and/or,
from about 1% to about 70% of the copolymer is programmably predetermined to tune n_{A} to a desired value; and/or,
from about 1% to about 70% of the copolymer is programmably predetermined to tune ϕ_{A} to a desired value; and/or,
from about 1% to about 70% of the copolymer is programmably predetermined to tune nₓ to a desired value; and/or,
from about 1% to about 70% of the copolymer is programmably predetermined to tune n_{bb} to a desired value;
   wherein each value is programmably predetermined to result in the hybrid brush-like graft copolymer. In certain embodiments, the hybrid brush-like graft copolymer is non-leachable. In certain embodiments, the hybrid brush-like graft copolymer consists essentially of polymer components that are programmably predetermined to tune one, two, three, four, five or six of n_{sc}, n_{g}, n_{A}, ϕ_{A}, nₓ, n_{bb}. In certain embodiments, the hybrid brush-like graft copolymer is prepared by a method described herein for programmably predetermining the types and amounts of copolymers components.

In certain embodiments, the subject matter described herein is directed to an adhesive article for mounting objects, the article comprising:
a peel release adhesive layer; and,
a hybrid brush-like graft copolymer, comprising:
a residue of a first macromonomer (side chain) as a mechanical regulator that controls the mechanical properties of the copolymer,
a residue of a glassy (A-block) macromonomer (or backbone copolymer) to initiate phase separation into a thermoplastic elastomer,
residues of two or more additional macromonomers that are each different from the first macromonomer to facilitate application specific controls (such as, but not limited to, PEG for absorption),
wherein, the n_{sc}, n_{g}, n_{A}, ϕ_{A}, nₓ, n_{bb} of the copolymer are programmably pre-determined.

In aspects of these embodiments, the hybrid brush-like graft copolymer does not contain any additives that substantially modulate a viscoelastic property or that may leach from the copolymer. In aspects of these embodiments, the hybrid brush-like graft copolymer consists essentially of or consists of a residue of a first macromonomer (side chain) as a mechanical regulator that controls the mechanical properties of the copolymer, a residue of a glassy (A-block) macromonomer (or backbone copolymer) to initiate phase separation into a thermoplastic elastomer, residues of two or more additional macromonomers that are each different from the first macromonomer to facilitate application specific controls (such as, but not limited to, PEG for absorption), wherein, the n_{sc}, n_{g}, n_{A}, ϕ_{A}, nₓ, n_{bb} of the copolymer are programmably pre-determined. In aspects of these embodiments, because the hybrid brush-like graft copolymer does not contain any additives and is a single molecule composition, the viscoelastic properties do not appreciably vary over time, for example 6 months to 10 years, or 2 years to 10 years, or 3 years to 10 years, or 4 years to 10 years, or 5 years to 10 years, or longer.

TABLE A-2
Architectural parameters and mechanical properties of exemplary A-g-B brush copolymers.

| | | | | | | | | | | | | |
|---|---|---|---|---|---|---|---|---|---|---|---|---|
| Sample | n_{g}¹⁾ | n_{sc} | nₓ²⁾ | n_{A}³⁾ | ϕ_{A}⁴⁾ | n_{bb}⁵⁾ | E⁶⁾ (kPa) | β⁶⁾ | ${E}_{0}^{7 )} ( kPa )$ | λ_{fit}⁸⁾ | λₘₐₓ⁹⁾ | σₘₐₓ¹⁰⁾ (kPa) |

poly[MMA-g-(PDMS/PMMA)]

| | | | | | | | | | | | | |
|---|---|---|---|---|---|---|---|---|---|---|---|---|
| 090320_2 | 1 | 14 | 149 | 27 | 0.015 | 1935 | 5.65 | 0.31 | 9.8 | 2.10 | 2.81 | 104 |
| 090320_1 | 1 | 14 | 149 | 62 | 0.034 | 1935 | 14.4 | 0.40 | 31.4 | 1.90 | 2.92 | 605 |
| 090320_4 | 1 | 14 | 149 | 81 | 0.044 | 1935 | 20.5 | 0.46 | 53.1 | 1.70 | 2.98 | 898 |
| 091720_2 | 1 | 14 | 149 | 46 | 0.025 | 607 | 12.2 | 0.26 | 18.9 | 1.57 | 2.34 | 51.2 |
| 091720_3 | 1 | 14 | 149 | 63 | 0.034 | 607 | 10.5 | 0.45 | 26.6 | 1.65 | 2.07 | 94.3 |
| 111620_2 | 1 | 14 | 149 | 82 | 0.044 | 607 | 14.2 | 0.52 | 45.8 | 1.44 | 1.87 | 122 |
| 111620_1 | 1 | 14 | 149 | 148 | 0.077 | 607 | 15.1 | 0.52 | 48.6 | 1.64 | 1.84 | 144 |
| 090420_3 | 1 | 14 | 149 | 53 | 0.029 | 210 | 7.30 | 0.42 | 16.9 | 1.80 | 2.04 | — |
| 090420_2 | 1 | 14 | 149 | 66 | 0.036 | 210 | 4.38 | 0.51 | 13.6 | 1.45 | 1.52 | 10.6 |
| 090420_1 | 1 | 14 | 149 | 99 | 0.053 | 210 | 11.7 | 0.54 | 40.7 | 1.28 | 1.69 | 36.8 |
| 090420_4 | 1 | 14 | 149 | 152 | 0.079 | 210 | 13.6 | 0.57 | 53.5 | 1.54 | 1.63 | 84.4 |

poly[nBA-ran-MMA-g-(PDMS/PMMA)]

| | | | | | | | | | | | | |
|---|---|---|---|---|---|---|---|---|---|---|---|---|
| 100920-2 | 4 | 14 | 139 | 85 | 0.131 | 1923 | 36.3 | 0.18 | 47.9 | 2.50 | 3.40 | 606 |
| 100920_1 | 4 | 14 | 139 | 178 | 0.241 | 1923 | 61.6 | 0.29 | 103 | 2.20 | 2.83 | 1223 |
| 100920_5 | 4 | 14 | 139 | 205 | 0.268 | 1923 | 77.3 | 0.33 | 142 | 1.96 | 2.96 | 2572 |
| 100820_3 | 8 | 14 | 142 | 48 | 0.112 | 1959 | 15.8 | 0.09 | 18.0 | 3.32 | 4.95 | 558 |
| 100820_2 | 8 | 14 | 142 | 147 | 0.278 | 1959 | 50.4 | 0.13 | 60.9 | 3.25 | 5.21 | 2653 |
| 100820_1 | 8 | 14 | 142 | 187 | 0.329 | 1959 | 68.6 | 0.15 | 86.1 | 3.00 | 4.62 | 2674 |

poly[nBA-ran-MMA-g-(PDMS/PS)]

| | | | | | | | | | | | | |
|---|---|---|---|---|---|---|---|---|---|---|---|---|
| 062022_1* | 8 | 14 | 844 | 60 | 0.03 | 1021 | 11.4 | 0.08 | 18.5 | 2.91 | 3.46 | 81.0 |
| 030822_1** | 8 | 14 | 502 | 60 | 0.05 | 1061 | 47.4 | 0.18 | 78.1 | 2.37 | 2.78 | 256 |
| 030822_2 | 8 | 14 | 315 | 60 | 0.08 | 2807 | 77.1 | 0.22 | 110 | 2.13 | 2.71 | 610 |
| 030822_3 | 8 | 14 | 155 | 60 | 0.15 | 2854 | 209 | 0.44 | 528 | 1.64 | 2.23 | 2588 |
| 030822_4 | 8 | 14 | 86 | 60 | 0.24 | 4425 | 210 | 0.72 | 1853 | 1.24 | 2.09 | 5430 |
| 030822_5 | 10 | 14 | 178 | 60 | 0.15 | 5573 | 286 | 0.50 | 858 | 1.52 | 2.57 | 6000 |

poly[nBA-ran-MMA-g-(PIB/PS)]

| | | | | | | | | | | | | |
|---|---|---|---|---|---|---|---|---|---|---|---|---|
| 030722_1 | 8 | 18 | 503 | 60 | 0.048 | 940 | 46.8 | 0.16 | 59.9 | 2.49 | 3.85 | 740 |
| 030722_2 | 8 | 18 | 216 | 60 | 0.108 | 1425 | 170 | 0.20 | 232 | 2.32 | 4.67 | 3520 |
| 030722_3 | 8 | 18 | 218 | 60 | 0.106 | 938 | 133 | 0.23 | 193 | 2.35 | 3.46 | 2040 |

¹⁾Grafting density of side chains on the backbone with BA spacer.
²⁾Number average degree polymerization of brush backbone between glassy block side chains that physical crosslink.
³⁾Number average degree polymerization of each glassy block side chain as determined by ¹H-NMR.
⁴⁾Volume fraction glassy block, ρ_{PMMA} = 1.15 g /mL, ρ_{PIB} = 0.92 g /mL, ρ_{PS} = 1.02 g/mL, ρ_{PDMS} = 0.96 g/mL, ρ_{PEG} = 0.94 g/mL, ρ_{PBA} = 1.08 g/mL.
⁵⁾Number average degree polymerization of the total brush strand.
${}^{6 )} Structural modulus E ∼ 1 / ( {n}_{bb} ( {n}_{sc} + 1 ) ) and strain ‐ stiffening parameter β = 〈 {R}_{in}^{2} 〉 / {R}_{max}^{2} are fitting parameters in equation S 1.$ ⁷⁾Apparent Young’s modulus which can be determined either as tangent of a stress-strain curve at λ → 1 or from the fitting equation S2.
⁸⁾Elongation range used for fitting equation S1 before deviation from the theory.
⁹⁾Maximum true stress and elongation at sample rupture.
¹⁰⁾Maximum stress-at-break (strength) of A-g-B brush copolymer samples.
*Gₑ = 1.9 kPa.
**Gₑ = 5.1 kPa.

TABLE B1
Mechanical Properties and Rouse time of brush HMPSAs

| | | | | | | | | | | | |
|---|---|---|---|---|---|---|---|---|---|---|---|
| n_{g}¹⁾ | n_{sc}²⁾ | nₓ³⁾ | n_{A}⁴⁾ | ϕ_{A}⁵⁾ | n_{bb}⁶⁾ | G⁷⁾ (kPa) | β⁸⁾ | ${E}_{0}^{9 )} ( kPa )$ | λₘₐₓ¹⁰⁾ | σₘₐₓ¹¹⁾ (kPa) | τ_{R}(s)¹²⁾ |

PS-g-PIB (n_{g} = 1), longer backbone (n_{bb} = 2000)

| | | | | | | | | | | | |
|---|---|---|---|---|---|---|---|---|---|---|---|
| 1 | 18 | 180 | 96 | 0.047 | 2000 | 1.8 | 0.54 | 18.1 | 2.6 | 267 | 83.0 |
| 1 | 18 | 180 | 278 | 0.126 | 2000 | 2.7 | 0.70 | 61.8 | 2.0 | 479 | 7.6 |
| 1 | 18 | 180 | 414 | 0.177 | 2000 | 2.9 | 0.72 | 76.1 | 1.9 | 480 | 4.1 |
| 1 | 18 | 180 | 504 | 0.208 | 2000 | 3.4 | 0.74 | 104 | 2.3 | 1383 | 1.6 |

PS-g-PIB (n_{g} = 1), shorter backbone (n_{bb} = 900)

| | | | | | | | | | | | |
|---|---|---|---|---|---|---|---|---|---|---|---|
| 1 | 18 | 163 | 54 | 0.030 | 900 | 1.7 | 0.56 | 19.3 | 2.0 | 46 | 95.6 |
| 1 | 18 | 163 | 76 | 0.042 | 900 | 1.8 | 0.59 | 23.3 | 2.0 | 98 | 46.0 |
| 1 | 18 | 163 | 125 | 0.067 | 900 | 3.2 | 0.68 | 66.5 | 1.8 | 216 | 10.2 |
| 1 | 18 | 163 | 468 | 0.212 | 900 | 3.4 | 0.80 | 176 | 1.6 | 427 | 3.3 |

PS-g-PIB (n_{g} = 8), nₓ variation

| | | | | | | | | | | | |
|---|---|---|---|---|---|---|---|---|---|---|---|
| 8 | 18 | 218 | 60 | 0.106 | 938 | 44.3 | 0.23 | 193 | 3.5 | 2040 | 0.83 |
| 8 | 18 | 332 | 60 | 0.075 | 1237 | 32.4 | 0.17 | 127 | 3.9 | 1540 | 3.4 |
| 8 | 18 | 503 | 60 | 0.048 | 1265 | 15.6 | 0.16 | 59.9 | 3.9 | 740 | 12.5 |
| 8 | 18 | 906 | 60 | 0.030 | 805 | 2.6 | 0.03 | 8.00 | 5.3 | 110 | 600 |

PS-g-PIB (n_{g} = 8), n_{sc} variation

| | | | | | | | | | | | |
|---|---|---|---|---|---|---|---|---|---|---|---|
| 8 | 18 | 216 | 60 | 0.108 | 1319 | 56.7 | 0.20 | 232 | 4.7 | 3520 | 0.83 |
| 8 | 23 | 165 | 60 | 0.10 | 764 | 36.3 | 0.21 | 154 | 2.9 | 1030 | 1.8 |
| 8 | 41 | 135 | 60 | 0.10 | 465 | 8.7 | 0.25 | 39.3 | 3.09 | 410 | 15.6 |

PS-g-PIB (n_{g} = 8), longer A block n_{A} = 120

| | | | | | | | | | | | |
|---|---|---|---|---|---|---|---|---|---|---|---|
| 8 | 18 | 450 | 120 | 0.10 | 854 | 24.3 | 0.24 | 94.9 | 3.84 | 1560 | 2.5 |
| 8 | 18 | 803 | 120 | 0.05 | — | 6.7 | 0.16 | 25.6 | 4.75 | 980 | 26.9 |

PS-g-PIB (n_{g} = 4)

| | | | | | | | | | | | |
|---|---|---|---|---|---|---|---|---|---|---|---|
| 4 | 18 | 149 | 60 | 0.10 | 1134 | 28.2 | 0.37 | 171 | 2.88 | 1820 | 0.8 |
| 4 | 18 | 360 | 60 | 0.05 | 1259 | 11.9 | 0.22 | 51.0 | 3.63 | 790 | 4.1 |
| 4 | 41 | 112 | 60 | 0.10 | 251 | 9.9 | 0.47 | 79.6 | 2.19 | 370 | 3.98 |

¹⁾Grafting density of side chains on the backbone with BA spacer.
²⁾Degree of polymerization of PIB side chains in the B-block.
³⁾Number average degree polymerization of brush backbone between glassy block side chains that physical crosslink.
⁴⁾Number average degree polymerization of each glassy block side chain as determined by ¹H-NMR.
⁵⁾Volume fraction glassy block, ρ_{PMMA} = 1.15 g/mL, ρ_{PIB} = 0.92 g/mL, ρ_{PS} =1.02 g/mL, ρ_{PDMS} = 0.96 g/mL,
ρ_{PEG} = 0.94 g/mL, ρ_{PBA} = 1.08 g /mL.
⁶⁾Number average degree polymerization of the total brush strand.
⁷⁾Structural shear modulus and
⁸⁾strain-stiffening parameter are fitting parameters in eq S1.
⁹⁾Apparent Young’s modulus which can be determined either as tangent of a stress-strain curve at λ → 1 or calculated from eq S2.
¹⁰⁾Maximum elongation at sample rupture.
¹¹⁾Maximum stress-at-break (strength) of brush HMPSAs.
¹²⁾Experimentally determined Rouse time of brush HMPSAs.

The subject matter described herein includes, but is not limited to, the following specific embodiments:

1. A hybrid brush-like graft copolymer, or hybrid brush-like graft copolymer, single-molecule composition thereof, wherein the hybrid brush-like graft copolymer has an:

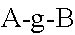

architecture, the hybrid brush-like graft copolymer comprising:
a B block that is a residue of a first macromonomer;
an A block that is a residue of a second macromonomer that is different than the first macromonomer;
a g spacer; and,
a backbone which is a polymer or copolymer;
   wherein the A block and the B block are selected to programmably predetermine the viscoelastic properties of the copolymer.

2. The hybrid brush-like graft copolymer, or hybrid brush-like graft copolymer, single molecule composition thereof of embodiment 1, wherein the hybrid brush-like graft copolymer self-assembles due to microphase separation.

3. The hybrid brush-like graft copolymer, or hybrid brush-like graft copolymer, single molecule composition thereof of embodiment 2, wherein the microphase separation forms physically distinct domains of linear polymer blocks dispersed within a matrix of the brush-like polymer blocks.

4. The hybrid brush-like graft copolymer, or hybrid brush-like graft copolymer, single molecule composition thereof of any one of embodiments 1-3, wherein the B block controls mechanical properties, and the A block controls phase separation properties.

5. The hybrid brush-like graft copolymer, or hybrid brush-like graft copolymer, single molecule composition thereof of any one of embodiments 1-4, wherein the molar fraction of the A block is 15 mol % or less.

6. The hybrid brush-like graft copolymer, or hybrid brush-like graft copolymer, single molecule composition thereof of any one of embodiments 1-5, wherein the A blocks are linear polymer blocks, and the B blocks are brush-like polymer blocks.

7. The hybrid brush-like graft copolymer, or hybrid brush-like graft copolymer, single molecule composition thereof of embodiment 6, wherein the copolymer undergoes self-assembly to form a physically crosslinked network.

8. The hybrid brush-like graft copolymer, or hybrid brush-like graft copolymer, single molecule composition thereof of any one of embodiments 1-7, wherein the viscoelastic properties are defined as one or more architectural parameters selected from the group consisting of

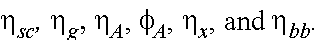

9. The hybrid brush-like graft copolymer, or hybrid brush-like graft copolymer, single molecule composition thereof of any one of embodiments 1-8, wherein the adhesion property of the hybrid brush-like graft copolymer, single molecule composition is programmably determined through one of more of n_{sc}, n_{g}, and nₓ.

10. The hybrid brush-like graft copolymer, or hybrid brush-like graft copolymer, single molecule composition thereof of any one of embodiments 1-9, wherein the firmness and cohesive strength of the hybrid brush-like graft copolymer, single molecule composition is programmably determined through one of more of n_{bb}, n_{A}, and ϕ_{A}.

11. The hybrid brush-like graft copolymer, or hybrid brush-like graft copolymer, single molecule composition thereof of any one of embodiments 1-10, wherein the backbone is a polymer of acrylate, methacrylate, styrene or copolymers thereof.

12. The hybrid brush-like graft copolymer, or hybrid brush-like graft copolymer, single molecule composition thereof of any one of embodiments 1-11, wherein the g spacer is a residue of acrylate, methacrylate, styrene or glycol.

13. The hybrid brush-like graft copolymer, or hybrid brush-like graft copolymer, single molecule composition thereof of any one of embodiments 1-12, wherein the g spacer is a residue of acrylate or methacrylate.

14. The hybrid brush-like graft copolymer, or hybrid brush-like graft copolymer, single molecule composition thereof of any one of embodiments 1-13, wherein the g spacer is a residue of n-butyl acrylate.

15. The hybrid brush-like graft copolymer, or hybrid brush-like graft copolymer, single molecule composition thereof of any one of embodiments 1-12, wherein the g spacer is an acrylate/methacrylate copolymer.

16. The hybrid brush-like graft copolymer, or hybrid brush-like graft copolymer, single molecule composition thereof of any one of embodiments 1-15, wherein the first macromonomer is selected from the group consisting of residues of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, polycaprolactams, polyoxazolines, poly(propylene fumarate), polynorbornenes, and polycarbonates and copolymers thereof.

17. The hybrid brush-like graft copolymer, or hybrid brush-like graft copolymer, single molecule composition thereof of embodiment 16, wherein the first macromonomer is functionalized with aldehyde, isocyanate, amine, diene, dienophile, epoxide, cyanoacrylate, thiol, catechol, oligonucleotide, hydrogen bond donor/acceptor group, alkyne, alkoxy, azide, vinyl, acrylate, methacrylate, carboxylic acid, alkoxy, oxime, acetoxy, amide, urea, guaiacol, furan or hydroxyl moieties.

18. The hybrid brush-like graft copolymer, or hybrid brush-like graft copolymer, single molecule composition thereof of embodiment 16, wherein the polyolefin is polyisobutylene.

19. The hybrid brush-like graft copolymer, or hybrid brush-like graft copolymer, single molecule composition thereof of embodiment 16, wherein the polysiloxane is polydimethylsiloxane.

20. The hybrid brush-like graft copolymer, or hybrid brush-like graft copolymer, single molecule composition thereof of embodiment 16, wherein the polyether is poly(ethylene glycol).

21. The hybrid brush-like graft copolymer, or hybrid brush-like graft copolymer, single molecule composition thereof of any one of embodiments 1-20, wherein the second macromonomer is selected from the group consisting of residues of, polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, polylactides, poly(lactide-co-glycolide), polyacrylonitriles, polylactones, polylactams such as polycaprolactams, polyoxazolines, poly(propylene fumarate), polynorbornenes, and polycarbonates including any potential copolymers of the aforementioned chemistries; or is selected from the group consisting of vinyl polymers (e.g., polystyrene, poly(vinyl acetate), poly(acrylo nitrile), and poly(vinyl alcohol)), alkyl acrylate derivatives, alkyl methacrylate derivatives (e.g., poly(methyl methacrylate) and poly(benzyl methacrylate), ether acrylate derivatives, ether methacrylate derivatives (e.g., poly(oligo (ethylene glycol) monomethyl ether methacrylate), olefin acrylate derivatives, olefin methacrylate derivatives, and olefin norbomene derivatives, and copolymers thereof.

22. The hybrid brush-like graft copolymer, or hybrid brush-like graft copolymer, single molecule composition thereof of any one of embodiments 1-21, wherein the B block has a melting temperature of about 21° C. or below.

23. The hybrid brush-like graft copolymer, or hybrid brush-like graft copolymer, single molecule composition thereof of any one of embodiments 1-22, wherein the first macromonomer is selected from the group consisting of residues of polyacrylates, polyolefins and polysiloxanes.

24. The hybrid brush-like graft copolymer, or hybrid brush-like graft copolymer, single molecule composition thereof of any one of embodiments 1-23, wherein the second macromonomer is glassy or crystalline at a temperature of about 21° C.

25. The hybrid brush-like graft copolymer, or hybrid brush-like graft copolymer, single molecule composition thereof of any one of embodiments 1-24, wherein the second macromonomer is selected from the group consisting of residues of polystyrene, PMMA, PLA and PVC.

26. The hybrid brush-like graft copolymer, or hybrid brush-like graft copolymer, single molecule composition thereof of any one of embodiments 1-25, wherein the hybrid brush-like graft copolymer is selected from the group consisting of poly[MMA-g-(PDMS/PMMA)], poly[MMA-g-(PnBA/PMMA)], poly[MMA-g-(PIB/PMMA)], poly[MMA-g-(PDMS/PS)], poly[MMA-g-(PnBA/PS)], poly[MMA-g-(PIB/PS)], poly[nBA-ran-MMA-g-(PDMS/PS)], poly[nBA-ran-MMA-g-(PnBA/PS)], poly[nBA-ran-MMA-g-(PIB/PS)], poly[nBA-ran-MMA-g-(PDMS/PMMA)], poly[nBA-ran-MMA-g-(PnBA/PMMA)] poly[nBA-ran-MMA-g-(PIB/PMMA)], poly[MMA-g-(PDMS/PLA)], poly[MMA-g-(PnBA/PLA)], poly[MMA-g-(PIB/PLA)], poly[MMA-g-(PDMS/PLGA)], poly[MMA-g-(PnBA/PLGA)], poly[MMA-g-(PIB/PLGA)], poly[MMA-g-(PDMS/PCL)], poly[MMA-g-(PnBA/PCL)], and poly[MMA-g-(PIB/PCL)].

27. The hybrid brush-like graft copolymer, or hybrid brush-like graft copolymer, single molecule composition thereof of any one of embodiments 1-26, wherein the composition has been formed as a pressure sensitive adhesive.

27. The hybrid brush-like graft copolymer, or hybrid brush-like graft copolymer, single molecule composition thereof of any one of embodiments 1-26, wherein the composition has been formed for pressure sensitive adhesive formulations (resins).

28. The hybrid brush-like graft copolymer, or hybrid brush-like graft copolymer, single molecule composition thereof of any one of embodiments 1-26, wherein the composition has been formed as tackifier, plasticizer, or other additive for pressure sensitive adhesive formulations (resins).

29. The hybrid brush-like graft copolymer, or hybrid brush-like graft copolymer, single molecule composition thereof of any one of embodiments 1-26, wherein the composition has been formed as pressure sensitive adhesive tapes.

30. The hybrid brush-like graft copolymer, or hybrid brush-like graft copolymer, single molecule composition thereof of any one of embodiments 1-29, wherein the composition is in the form of a three-dimensional shape.

31. The hybrid brush-like graft copolymer, or hybrid brush-like graft copolymer, single molecule composition thereof of embodiment 30, wherein the three-dimensional shape is molded.

32. The hybrid brush-like graft copolymer, or hybrid brush-like graft copolymer, single molecule composition thereof of any one of embodiments 1-31, wherein the composition is essentially free of solvents.

33. The hybrid brush-like graft copolymer, or hybrid brush-like graft copolymer, single molecule composition thereof of any one of embodiments 1-32, wherein the composition is essentially non-leachable.

34. The hybrid brush-like graft copolymer, or hybrid brush-like graft copolymer, single molecule composition thereof of any one of embodiments 1-32, wherein the composition does not comprise additional additive components.

35. The hybrid brush-like graft copolymer, or hybrid brush-like graft copolymer, single molecule composition thereof of any one of embodiments 1-34, wherein the A blocks are a controlled fraction of linear blocks dispersed among a controlled amount of B blocks that are bottlebrush blocks.

36. A medical device comprising the hybrid brush-like graft copolymer, or hybrid brush-like graft copolymer, single molecule composition thereof of any one of embodiments 1-35.

37. The medical device of embodiment 36 selected from an implant, a tissue adhesive, a wound dressing pad, a tissue sealant, a vascular graft, a transdermal drug delivery composition, or a catheter.

38. The medical device of embodiment 36, wherein the hybrid brush-like graft copolymer, or hybrid brush-like graft copolymer, single molecule composition thereof is a pressure sensitive adhesive for ostomy pouching systems.

39. A method of programmably predetermining the viscoelastic properties of a hybrid brush-like graft copolymer, the method comprising:
i. preparing a mixture comprising a B block first macromonomer and an A block second macromonomer, wherein the first and second macromonomer are different from each other;
   and,
ii. subjecting the mixture to polymerization selected from the group consisting of free radical polymerization (FRP), atom transfer radical polymerization (ATRP), SARA ATRP, anionic polymerization, and reversible addition-fragmentation chain-transfer polymerization (RAFT), ring opening polymerization, ring opening metathesis polymerization, metallocene polymerization, and coordination polymerization,
wherein, a hybrid brush-like copolymer having an

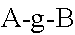

architecture and programmably predetermined viscoelastic properties is prepared.

40. The method of embodiment 39, wherein the viscoelastic properties are defined as one or more architectural parameters selected from the group consisting of

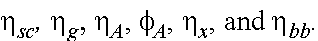

41. The method of embodiment 39 or 40, wherein a target range or value for one or more of the architectural parameters is predetermined.

42. The method of any one of embodiments 39-41, further comprising:

prior to said preparing, determining the architectural parameter contribution of the B block first macromonomer and the A block second macromonomer.

43. The method of embodiment 42, wherein the B block controls mechanical properties, and the A block controls phase separation properties.

44. The method of any one of embodiments 39-43, wherein the first macromonomer is selected from the group consisting of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, polycaprolactams, polyoxazolines, poly(propylene fumarate), polyoxazolines, polynorbornenes and polycarbonates and copolymers thereof.

45. The method of any one of embodiments 39-44, wherein the second macromonomer is selected from the group consisting of residues of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, polylactides, poly(lactide-co-glycolide), polyacrylonitriles, polylactones, such as polycaprolactone and poly(valerolactone), polylactams, polyoxazolines, poly(propylene fumarate), polynorbornenes, and polycarbonates including any potential copolymers of the aforementioned chemistries; or is selected from the group consisting of vinyl polymers (e.g., polystyrene, poly(vinyl acetate), poly(acrylo nitrile), and poly(vinyl alcohol), alkyl acrylate derivatives, alkyl methacrylate derivatives (e.g., poly(methyl methacrylate) and poly(benzyl methacrylate)), ether acrylate derivatives, ether methacrylate derivatives (e.g., poly(oligo (ethylene glycol) monomethyl ether methacrylate), olefin acrylate derivatives, olefin methacrylate derivatives, and olefin norbomene derivatives.

46. The method of embodiment 39, wherein the polymerization comprises ATRP.

47. The method of any one of embodiments 39-46, wherein the hybrid brush-like copolymer does not comprise a leachable additive.

48. The method of any one of embodiments 39-47, wherein the mixture further comprises a backbone polymer or copolymer.

49. The method of any one of embodiments 39-48, wherein the mixture further comprises a g spacer.

50. A method of preparing a hybrid brush-like graft copolymer or hybrid brush-like graft copolymer, single molecule composition thereof comprising,
i. selecting a target value or range for one or more architectural parameters selected from the group consisting of

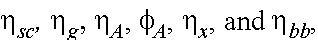

ii. selecting each of a B block, an A block, and a g spacer having known properties that contributes to the target value or range of the one or more architectural parameters in the hybrid brush-like graft copolymer,
iii. preparing the hybrid brush-like graft copolymer by polymerizing the B block, A block and g spacer, wherein a hybrid brush-like graft copolymer having a target value or range for each of the one or more architectural parameters is prepared.

51. A hybrid brush-like graft copolymer or hybrid brush-like graft copolymer, single molecule composition thereof prepared by a method of, i. selecting a target value or range for one or more architectural parameters selected from the group consisting of

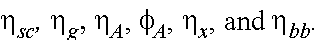

ii. selecting each of a B block, an A block, and a g spacer that contributes to the target value or range of the one or more architectural in the hybrid brush-like graft copolymer,
iii. preparing the hybrid brush-like graft copolymer by polymerizing the B block, A block and g spacer, wherein a hybrid brush-like graft copolymer having a target value or range for each of the one or more architectural parameters is prepared.

52. In any above embodiment, the B block (first macromonomer) has a melting or glass transition temperature of about 21° C. or below, and the A block (second macromonomer) is glassy or crystalline at a temperature of about 21° C.

Non-limiting embodiments also include:
A1. A hybrid brush-like graft copolymer of any of the above embodiments, wherein the copolymer has:
   a n_{g} value from about 1 to about 16; and/or,
   a n_{A} value from about 20 to about 500; and/or,
   a ϕ_{A} value from about 0.01 to about 0.4; and/or,
   a nₓ value from about 50 to about 2000; and/or,
   a n_{bb} value from about 100 to about 5000;
      wherein each value is programmably predetermined.
A2. A hybrid brush-like graft copolymer of any of the above embodiments, wherein:
   from about 1% to about 70% of the copolymer is programmably predetermined to tune n_{g} to a desired value; and/or,
   from about 1% to about 70% of the copolymer is programmably predetermined to tune n_{A} to a desired value; and/or,
   from about 1% to about 70% of the copolymer is programmably predetermined to tune ϕ_{A} to a desired value; and/or,
   from about 1% to about 70% of the copolymer is programmably predetermined to tune nₓ to a desired value; and/or,
   from about 1% to about 70% of the copolymer is programmably predetermined to tune n_{bb} to a desired value;
wherein the hybrid brush-like graft copolymer each value is programmably predetermined.

1. An engineered hybrid brush-like graft copolymer, comprising:
a residue of a first macromonomer (side chain) as a mechanical regulator that controls the mechanical properties of the copolymer,
a residue of a glassy (A-block) macromonomer (or backbone copolymer) to initiate phase separation into a thermoplastic elastomer,
residues of two or more additional macromonomers that are each different from the first macromonomer to facilitate application specific controls (such as, but not limited to, PEG for absorption),
wherein, the [n_{sc}, n_{g}, n_{A}, ϕ_{A}, nₓ, n_{bb}] of the copolymer are programmably pre-determined.

2. The copolymer of embodiment 1, wherein the first macromonomer is selected from the group consisting of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, such as polycaproclactone and poly(valerolactone), polylactams, polyoxazolines, poly(propylene fumarate), polynorbornenes, and polycarbonates including any potential copolymers of the aforementioned chemistries; or,
the group consisting of acrylates, methacrylates, olefins, siloxanes, polyesters, polyethers, polyureas, polyurethanes, and polycarbonates.

3. The copolymer of any above embodiment, wherein the two or more additional macromonomers are independently selected from the group consisting of tackifiers, plasticizers, diluents, crosslinkers, water sorption agents, macromonomers, elastomers, and chain-end functionalized macromonomers.

4. The copolymer of any above embodiment, wherein the two or more additional macromonomers are independently selected from the group consisting of:
i. polyolefins, polysiloxanes, polyurethanes, polyacrylates, and polydioxanone;
ii. polyethers, polyglycolide, polyoxazolines;
iii. polystyrene, polymethacrylates, polycaprolactone, polylactides, poly(propylene fumarate), polycarbonate, poly(lactide-co-glycolides), poly(tetrafluoroethylene); and
iv. functionalized (macro)monomers having aldehyde, isocyanate, amine, diene, dienophile, epoxide, cyanoacrylate, thiol, catechol, oligonucleotide, hydrogen bond donor/acceptor group, alkyne, alkoxy, azide, vinyl, acrylate, methacrylate, or hydroxyl moieties.

4a. The copolymer of any above embodiment, wherein the two or more additional macromonomers are independently selected from the group consisting of:
i. polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, polycaprolactams, polyoxazolines, poly(propylene fumarate), polynorbornenes and polycarbonates, and copolymers thereof;
ii. functionalized (macro)monomers having aldehyde, isocyanate, amine, diene, dienophile, epoxide, cyanoacrylate, thiol, catechol, oligonucleotide, hydrogen bond donor/acceptor group, alkyne, alkoxy, azide, vinyl, acrylate, methacrylate, carboxylic acid, alkoxy, oxime, acetoxy, amide, urea, guaiacol, furan or hydroxyl moieties.

5. The copolymer of any above embodiment, wherein the polyolefin is polyisobutylene.

6. The copolymer of any above embodiment, wherein the polysiloxane is polydimethylsiloxane.

7. The copolymer of any above embodiment, wherein the polyether is poly(ethylene glycol).

8. The copolymer of any above embodiment, wherein the amounts present of additional monomers from i, from ii., from iii., and from iv. are engineered to conform with the pre-determined [n_{sc}, n_{g}, n_{A}, ϕ_{A}, ϕ_{A}, n_{bb}] of the copolymer.

9. A polymer network comprising a plurality of the copolymer blocks of claim 1.

10. The polymer network of any above embodiment, wherein the copolymer blocks undergo microphase separation to form physically distinct domains composed of linear polymer blocks dispersed within a matrix of the brush-like polymer blocks.

11. The polymer network of any above embodiment, wherein the copolymer undergo self-assembly to form a physically crosslinked network.

12. The polymer network of any above embodiment, wherein the polymer network has been formed as a medical device.

13. The polymer network of any above embodiment, wherein the medical device is selected from an implant, a tissue adhesive, a wound dressing pad, a tissue sealant, a vascular graft, or a catheter.

14. The polymer network of any above embodiment, wherein the medical device is a pressure sensitive adhesive for ostomy pouching systems.

15. The polymer network of any above embodiment, wherein the polymer network has been formed as a pressure sensitive adhesive.

16. The polymer network of any above embodiment, wherein the polymer network has been formed for pressure sensitive adhesive formulations (resins).

17. The polymer network of any above embodiment, wherein the polymer network has been formed as tackifier, plasticizer, or other additive for pressure sensitive adhesive formulations (resins).

18. The polymer network of any above embodiment, wherein the polymer network has been formed as pressure sensitive adhesive tapes.

19. The polymer network of any above embodiment, wherein the polymer network is in the form of a three-dimensional shape.

20. The polymer network of any above embodiment, wherein the three-dimensional shape is molded.

21. The polymer network of any above embodiment, wherein the polymer network is essentially free of solvents.

22. The polymer network of any above embodiment, wherein the polymer network is essentially non-leachable.

23. The polymer network of any above embodiment, wherein the polymer network does not comprise additional additive components.

24. A method of preparing a hybrid brush-like graft copolymer, the method comprising:
i. forming a mixture by contacting a first macromonomer that is a mechanical regulator with two or more additional macromonomers that are each different from the first macromonomer;
   and,
ii. subjecting the mixture to polymerization selected from the group consisting of free radical polymerization (FRP), atom transfer radical polymerization (ATRP), SARA ATRP, anionic polymerization, reversible addition-fragmentation chain-transfer polymerization (RAFT), ring opening polymerization, ring opening metathesis polymerization, metallocene polymerization, and coordination polymerization,
wherein, a hybrid brush-like copolymer is prepared.

25. The method of any above embodiment, wherein the first macromonomer is selected from the group consisting of acrylates, methacrylates, olefins, siloxanes, polyesters, polyethers, polyureas, polyurethanes, and polycarbonates.

25a. The method of any above embodiment, wherein the first macromonomer is selected from the group consisting of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, polycaprolactams, polyoxazolines, poly(propylene fumarate), polyoxazolines, polynorbornenes and polycarbonates including any potential copolymers of the aforementioned chemistries.

26. The method of any above embodiment, wherein said two or more additional macromonomers are independently selected from the group consisting of tackifiers, plasticizers, diluents, crosslinkers, water sorption agents, macromonomers, elastomers, and chain-end functionalized macromonomers.

27. The method of any above embodiment, wherein said two or more additional macromonomers are independently selected from the group consisting of:
i. polyolefins, polysiloxanes, polyurethanes, polyacrylates, and polydioxanone;
ii. polyethers, polyglycolide, polyoxazolines;
iii. polystyrene, polymethacrylates, polycaprolactone, polylactides, poly(propylene fumarate), polycarbonate, poly(lactide-co-glycolides), poly(tetrafluoroethylene); and
iv. functionalized (macro)monomers having aldehyde, isocyanate, amine, diene, dienophile, epoxide, cyanoacrylate, thiol, catechol, oligonucleotide, hydrogen bond donor/acceptor group, alkyne, alkoxy, azide, vinyl, acrylate, methacrylate, or hydroxyl moieties.

27a. The method of any above embodiment, wherein said two or more additional macromonomers are independently selected from the group consisting of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, polycaprolactams, polyoxazolines, poly(propylene fumarate), polyoxazolines, polynorbornenes and polycarbonates including any potential copolymers of the aforementioned chemistries, functionalized (macro)monomers having aldehyde, isocyanate, amine, diene, dienophile, epoxide, cyanoacrylate, thiol, catechol, oligonucleotide, hydrogen bond donor/acceptor group, alkyne, alkoxy, azide, vinyl, acrylate, methacrylate, carboxylic acid, alkoxy, oxime, acetoxy, amide, urea, guaiacol, furan or hydroxyl moieties.

28 The method of any above embodiment, wherein the polymerization comprises ATRP.

29. A method of preparing a copolymer as described in any above embodiment, wherein the values of E₀ and β, and the value of W_{adh} of the copolymer are independently programed.

30. A method of preparing a copolymer as described in any above embodiment, wherein the (macro)monomers are selected for control over adhesion through [n_{sc}, n_{g}, nₓ] and/or for control of bulk firmness and cohesive strength through n_{bb}, n_{A}, and ϕ_{A}.

31. A method of 3-D printing an object, comprising printing using a copolymer as described herein, and subjecting the printed copolymer to one or more curing processes, wherein a three-dimensional object is formed.

The General Procedures and Examples provide exemplary methods for preparing compounds. Those skilled in the art will appreciate that other synthetic routes may be used to synthesize the compounds. Although specific starting materials and reagents are depicted and discussed in the Schemes, General Procedures, and Examples, other starting materials and reagents can be easily substituted to provide a variety of derivatives and/or reaction conditions. In addition, many of the exemplary compounds prepared by the described methods can be further modified in light of this disclosure using conventional chemistry well known to those skilled in the art.

The following examples are offered by way of illustration and not by way of limitation.

### EXAMPLES

Synthesis: A-g-B brush-like graft copolymers are defined by a set of six architectural parameters [n_{sc}, n_{g}, n_{A}, ϕ_{A}, n_{bb}, nₓ], where n_{sc} is the degree of polymerization (DP) of the side-chains in the brush B block, n_{g} is the DP of backbone spacer between side chains, n_{A} and ϕ_{A} are respectively the DP and volume fraction of linear A-blocks, n_{bb} is the DP of a brush backbone, and nₓ corresponds to the backbone DP between A-blocks equivalent to the DP of network strand (FIG. 15). For convenience of discussion, we also introduce parameter z=n_{bb}/nₓ, which approximately corresponds to an average number of A-blocks per bottlebrush macromolecule. To study the effect of mesh interconnectivity on elastomer strength, we synthesized a series of A-g-B graft copolymers (similar to “Janus graft block copolymers”) with different z=2-13 using a combination of reversible addition-fragmentation chain transfer (RAFT) co-polymerization of polydimethylsiloxane (PDMS) and Br-terminated poly(ethylene glycol) (PEG) macromonomers with consecutive atom transfer radical polymerization (ATRP) of poly(methyl methacrylate) (PMMA) A-block grafted from the terminal bromine, yielding poly[MMA-g-(PDMS/PMMA)] bottlebrush graft copolymers with n_{g}=1 (FIG. 15, Table A2). To vary side chain grafting density

$$( ∼ {n}_{g}^{- 1} ) ,$$

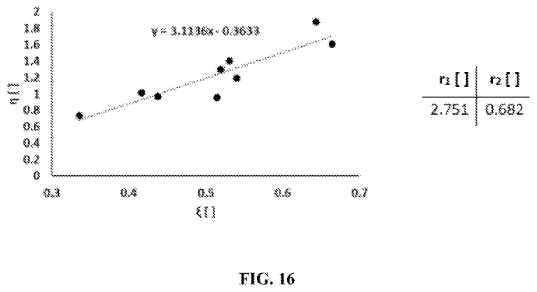

PDMS macromonomers were co-polymerized with n-butyl acrylate (BA) as backbone spacers between PDMS side chains yielding poly[nBA-ran-MMA-g-(PDMS/PMMA)] graft copolymers with n_{g}=4-8 (FIG. 15a). For convenience, bottlebrush (densely grafted) samples will be referred to as PMMA-g-PDMS (n_{g}-1), while the loosely grafted structures are named as PMMA-g-PDMS (n_{g}=4,8). Due to the difference in size and chemistry, gradient distribution of side chain and spacer is assumed (FIG. 16). Synthesized samples are summarized in the Table A2, while representative A-g-B networks are in Table 1-X.

TABLE 1-X

| | | | | | | | | | | | | |
|---|---|---|---|---|---|---|---|---|---|---|---|---|
| | | | | | Eₒ | | | | | | Sᵢₙ, | S₀, |
| n_{A}⁽¹⁾ | ϕ_{A}⁽²⁾ | n_{g}⁽³⁾ | nₓ⁽⁴⁾ | n_{bb}⁽⁵⁾ | kPa⁽⁶⁾ | β⁽⁷⁾ | d₁, nm | d₂, nm | d₃, nm | Q⁽⁸⁾ | nm²⁽⁹⁾ | nm²⁽¹⁰⁾ |

n_{bb} effect: poly[MMA-g-(PDMS/PMMA)]

| | | | | | | | | | | | | |
|---|---|---|---|---|---|---|---|---|---|---|---|---|
| 53 | 0.029 | 1 | 149 | 210 | 16.9 | 0.42 | 3.4 | 11.6 | 28.5 | 107 | 2.0 | 9.9 |
| 63 | 0.034 | 1 | 149 | 607 | 26.6 | 0.45 | 3.4 | 14.5 | 31.1 | 175 | 1.9 | 9.9 |
| 62 | 0.034 | 1 | 149 | 1935 | 31.4 | 0.40 | 3.4 | 14.9 | 32.0 | 193 | 1.8 | 9.9 |

n_{A} effect: poly[MMA-g-(PDMS/PMMA)]

| | | | | | | | | | | | | |
|---|---|---|---|---|---|---|---|---|---|---|---|---|
| 27 | 0.015 | 1 | 149 | 1935 | 9.8 | 0.31 | 3.4 | 13.3 | 36.1 | 316 | 0.9 | 9.9 |
| 62 | 0.034 | 1 | 149 | 1935 | 31.4 | 0.40 | 3.4 | 14.9 | 32.0 | 193 | 1.8 | 9.9 |
| 81 | 0.044 | 1 | 149 | 1935 | 53.1 | 0.46 | 3.4 | 13.6 | 27.6 | 125 | 2.5 | 9.9 |

n_{g} effect: poly[nBA-ran-MIMA-g-(PDMS/PMMA)]

| | | | | | | | | | | | | |
|---|---|---|---|---|---|---|---|---|---|---|---|---|
| 81 | 0.044 | 1 | 149 | 1935 | 53.1 | 0.46 | 3.4 | 13.6 | 27.6 | 125 | 2.5 | 10.0 |
| 178 | 0.241 | 4 | 139 | 1923 | 103 | 0.29 | 3.5 | 16.9 | 29.1 | 98 | 4.6 | 10.6 |
| 147 | 0.278 | 8 | 142 | 1959 | 60.9 | 0.13 | 3.9 | 16.7 | 31.2 | 115 | 3.8 | 13.2 |

nₓ effect: poly[mBA-ran-MMA-g-(PDMS/PS)]

| | | | | | | | | | | | | |
|---|---|---|---|---|---|---|---|---|---|---|---|---|
| 60 | 0.05 | 8 | 502 | 1061 | 78 | 0.18 | 3.7 | 12.7 | 20.3 | 106 | 2.4 | 11.7 |
| 60 | 0.08 | 8 | 315 | 2807 | 110 | 0.22 | 3.8 | 14.3 | 20.1 | 151 | 2.1 | 12.8 |
| 60 | 0.15 | 8 | 155 | 2854 | 528 | 0.44 | 4.0 | 16.1 | 18.9 | 215 | 1.9 | 13.9 |
| 60 | 0.24 | 8 | 86 | 4425 | 1853 | 0.72 | 3.6 | 15.6 | 18.4 | 196 | 2.0 | 10.9 |

⁽¹⁾Number average DP of PS or PMMA side chains as determined by ¹H-NMR.
⁽²⁾Volume fraction of PS or PMMA, ρ_{PS} = 1.02 g/mL, ρ_{PMMA} = 1.15 g/mL, ρρ = 0.96 g /mL.
⁽³⁾Number of spacer repeat units between A blocks.
⁽⁴⁾Number average DP of brush backbone between PS or PMMA side chains.
⁽⁵⁾DP of total brush backbone in the A-g-B macromolecule.
⁽⁶⁾Young’s modulus determined either as tangent of a stress-strain curve at λ → 1 or from the fitting equation S2 at λ = 1 as E₀ = E(1 + 2(1 − β)⁻²)/3.
${}^{( 7 )} Strain ‐ stiffening parameter β = 〈 {R}_{in}^{2} 〉 / {R}_{max}^{2} obtained by fitting stress ‐ strain curves with equation S 1.$ ⁽⁸⁾Aggregation number.
${}^{( 9 )} Area per brush strand at the A / B interface calculated from the aggregation number as {S}_{in} = π {d}_{2}^{2} / ( 2 Q ) .$ ${}^{( 10 )} Apparent cross section area of bottlebrush cylinder {S}_{0} = \sqrt{3} / 2 {d}_{1}^{2} assuming hexagonal packing .$

To demonstrate the universality of the platform and its modular nature in addressing specific applications, we prepared A-g-B graft copolymers with different chemical compositions of A-blocks and B-side chains. For example, PMMA A-blocks were replaced with polystyrene (PS) to enable elastomer fluidity at ˜100° C. for molding and 3D printing. By substituting PDMS side chains in the B-block with higher glass transition polyisobutylene (PIB), we augmented viscoelastic dissipation at room temperature and conventional strain rates, thereby enhancing adhesion and vibration damping. For scalability, the controlled radical polymerization (CRP) methods were replaced with free radical polymerization (FRP) to synthesize PS-g-PDMS (n_{g}=8) and PS-g-PIB (n_{g}=8) (FIG. 15b).

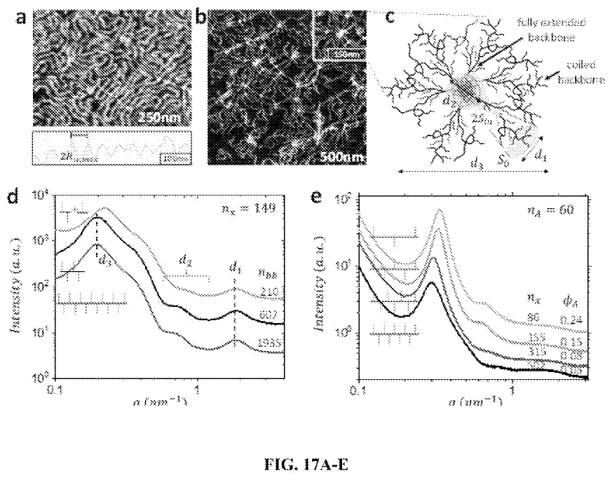

Structure: Chemically dissimilar blocks undergo microphase separation. Different techniques were employed for characterization of both molecular structure and morphology of self-assembled A-g-B networks. The copolymer composition [n_{sc}, n_{g}, n_{A}, nₓ] was monitored by ¹H-NMR spectroscopy while samples with identical compositions but different n_{bb} were verified by the number average molecular weight from gel-permeation chromatography. Atomic force microscopy (AFM) was used for molecular imaging of A-g-B macromolecules to confirm their dimensions and microphase separation. Langmuir-Blodget monolayers demonstrate densely packed worm-like PMMA-g-PDMS (n_{g}=1) macromolecules (FIG. 17a), where the intermolecular distance of 8.3±1.0 nm is consistent with two-fold the side chain contour length, 2R_{sc,max}=2n_{sc}l≅8.7 nm, using n_{sc}=14 and l=0.31 nm as a projection length of the PDMS repeat unit. The dense monolayer arrangement hinders the microphase separation of the A-blocks, yet star-like aggregates of multiple bottlebrushes are evident in loosely packed films (FIG. 17b). More insight into bulk morphology of A-g-B networks was obtained by small angle X-ray scattering (SAXS). First, A-g-B samples of near identical [n_{sc}, n_{g}, n_{A}, nₓ] yet different n_{bb}, i.e. different numbers of A-blocks per backbone (z), are shown to produce nearly identical SAXS curves (FIG. 17d), which supports the hypothesis that long A-g-B macromolecules with z>2 form topologically similar networks, differing only in mesh interconnectivity. Second, we show that the network morphology depends on the A-g-B architecture. Specifically, we studied (i) nₓ variation at a given n_{A} (FIG. 17e), (ii) n_{A} variation at a given nₓ, and (iii) variation of grafting density of B side chains (Table 1-X). SAXS curves elicit three characteristic network dimensions: the interbrush distance (d₁), A-domain diameter (d₂), and the interdomain distance (d₃) (FIG. 17c,d). For densely grafted bottlebrush blocks (n_{g}=1), d₁ corresponds to the brush diameter and the Kuhn length of the bottlebrush backbone (b_{K}≅d₁). From the domain diameter, we obtain two structural parameters: (i) aggregation number Q=ρV/M_{A} and (ii) interfacial area per brush strand

$${S}_{i n} = π {d}_{2}^{2} / ( 2 Q ) ,$$

where ρ is mass density of A polymer,

$$V = π {d}_{2}^{3} / 6$$

—domain volume, and M_{A}—molecular mass of A-block (Table 1-X). Unlike the previously studied ABA linear-brush-linear copolymers, each A block in an A-g-B macromolecule anchors two bottlebrush strands to a network node (FIG. 17c), which is accounted by the factor of 2 in the denominator of the Sᵢₙ equation. As a result, the footprint of bottlebrush strands at the domain surface, Sᵢₙ, is considerably smaller than the bottlebrush packing area in the bulk as

$${S}_{0} ≅ \sqrt{3} / 2 {d}_{1}^{2} .$$

This suggests strong extension of bottlebrush backbone at the interface, causing additional enhancement of the strain-stiffening response of A-g-B elastomers as discussed below.

Mechanical Properties: Systematic studies of backbone dilution on mechanical properties of brush networks by increasing n_{sc},

$${n}_{g}^{- 1} ,$$

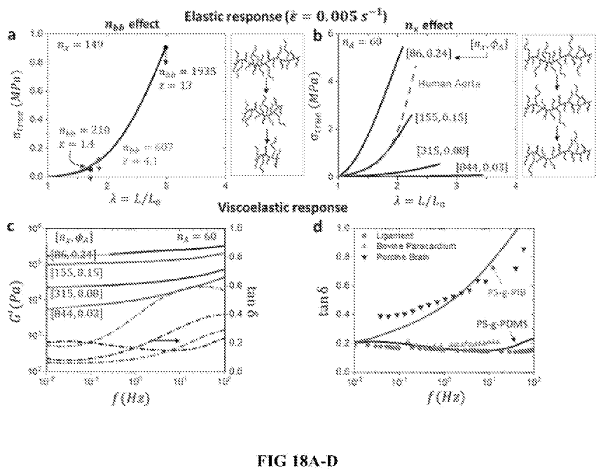

and nₓ have been established previously, therefore, our main focus here is twofold: (i) strengthening the network through enhancement of mesh interconnectivity by increasing the number of A-blocks per brush macromolecules (z) and (ii) architecturally tuning the viscoelastic response. We conducted uniaxial tensile tests of A-g-B brush networks with n_{bb} varying from ˜200 to 2000 and z ranging from ˜1.4 to 13 accordingly, while keeping the other architectural parameters (n_{sc}, n_{g}, nₓ, n_{A}, ϕ_{A}) constant. All samples demonstrate similar softness, E₀≈50 kPa, and firmness, β˜0.46-0.54 yet the σₘₐₓ increases 15-fold from 0.04 MPa to 0.9 MPa (FIG. 18a). This trend is corroborated by coarse-grained molecular dynamics simulations due to a direct increase in energy cost for A-block withdrawal in samples with a higher z-parameter. Although the achieved strengthening is substantial, the absolute values of σₘₐₓ <1 MPa are relatively low. Additional strengthening was facilitated by concurrently decreasing grafting density of the side chains,

$${n}_{g}^{- 1} ,$$

and increasing volume fraction of A blocks, ϕ_{A} (FIG. 18c). The decrease of grafting density reinforces the network by increasing volume fraction of the backbones. However, decreasing

$${n}_{g}^{- 1}$$

alone leads to firmness decline as observed in covalent brush networks, To reverse the trend, A-g-B's with greater volume fraction of A-blocks, ϕ_{A}, were synthesized. These elastomers witness a dual effect on network structure: (i) higher aggregation number of network nodes (Q), hence higher crosslink functionality and (ii) stronger strand extension, hence higher firmness (β) evidenced by the decreasing strand footprint (Sᵢₙ) (Table 1-X). The series of PS-g-PDMS (n_{g}=8) brush-like copolymers with ϕ_{A} ranging from 0.03 to 0.24 demonstrated steady increase of stress-at-break up to 6 MPa (FIG. 18c) which is comparable and even exceeds the strength of many soft tissues such as aorta, blood vessel, skeletal muscle, and even some cartilage tissues (Table A-1).

Concurrent with the elastic response measured a low strain rate of \dot{ε}=0.005 s⁻¹ (FIG. 18a,b), which corresponds to the rubber-elastic plateau for the PS-g-PDMS samples, the A-g-B architecture allows tuning the viscoelastic response. The frequency dependence of the storage modulus and damping factor was measured for samples varying (i) nₓ at a given n_{A} (FIG. 18c), (ii) n_{A} at a given nₓ, and (iii) grafting density,

$$\sim {n}_{g}^{- 1} .$$

The lowering of the crosslink density at a given n_{A}=60 results in two effects (FIG. 18c): (i) decrease of the storage modulus (G′), which is consistent with the stress-elongation curves in FIG. 18b, and (ii) lower frequency shift of the elastic plateau onset, which is evidenced by the corresponding increase of the damping (tanδ). Other structural levers, such as grafting density, may be utilized as well to regulate viscoelastic behavior. However, nearly full replication of tissues viscoelastic response is achieved by leveraging both architecture and chemistry of A-g-B networks. While a PS-g-PDMS (n_{g}=8) sample shows near identical damping response to ligament, replacing PDMS with a higher glass transition PIB in PS-g-PIB (n_{g}=8) shifts the frequency spectrum demonstrating damping similar to porcine brain (FIG. 18d).

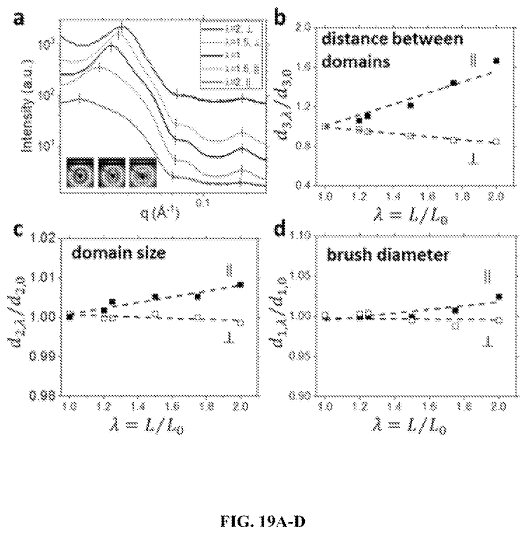

The effect of deformation on A-g-B network morphology was studied by in-situ SAXS which allows instantaneous monitoring of changes in the d₁, d₂, and d₃ spacings during uniaxial extension (FIG. 19a). The strongest effect is observed for the inter-domain distance d₃, which progressively increases along the stretching axis while decreasing in the perpendicular directions as expected for uniaxial network deformation (FIG. 19b). In a similar fashion, the A-domain exhibits anisotropic variations: increasing along the stretching direction and decreasing in the perpendicular directions (FIG. 19c), which however contrasts to the lack of domain deformation in ABA elastomer. The observed deformation of PMMA domains suggests a higher stress exerted on the nanospheres through two bottlebrush blocks attached to one A-block, which is consistent with the smaller bottlebrush footprint (Sᵢₙ) (Table 1-X). However, the domains deformation does not lead to any detectable decrease of their average volume, which supports the hypothesis of re-association of dislodged A-blocks with neighboring domains in the course of the deformation process. Stretching also affects the brush diameter corresponding to the d₁ peak position (FIG. 18d), which is ascribed to unravelling of the backbone inside bottlebrush envelopes which contributes to strain-stiffening.

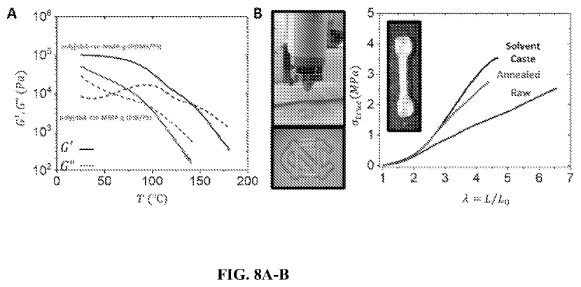

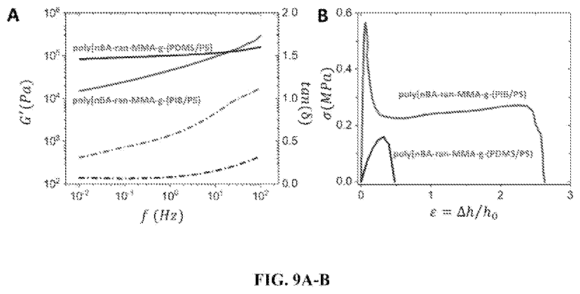

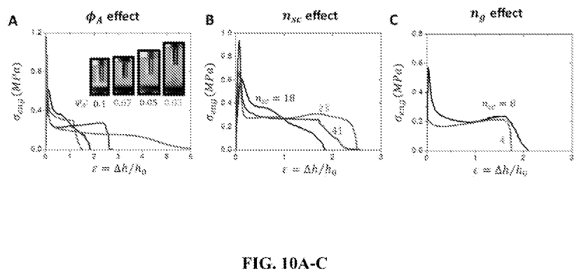

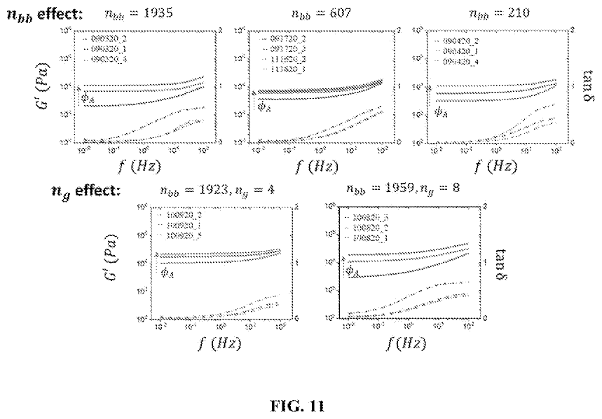

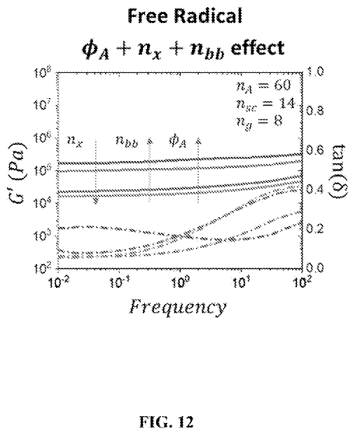

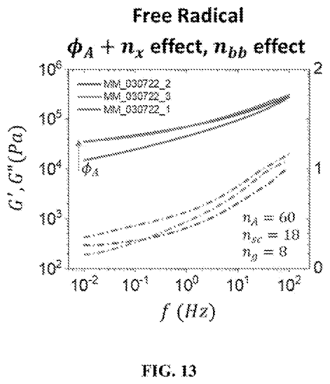

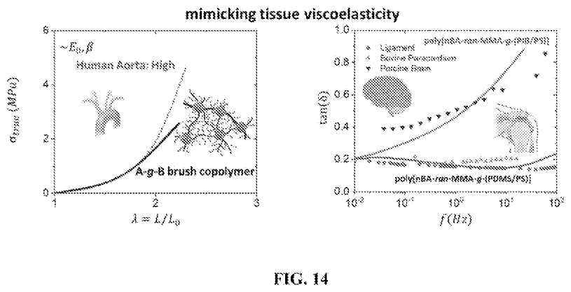

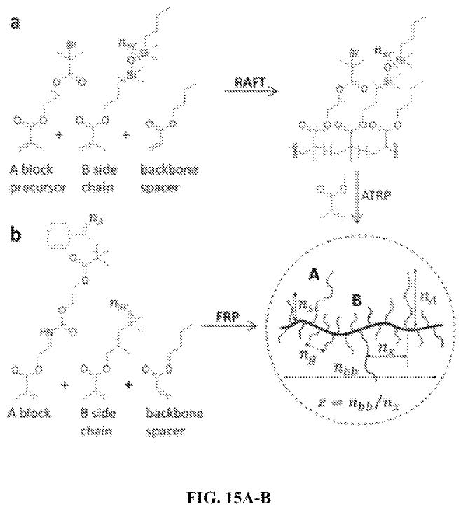

In addition to controlling mechanical properties of thermoplastic elastomers, the modular nature of the A-g-B platform allows a broad range of chemical compositions for A and B blocks. The chemical variability accommodates specific functions such as thermal stability, adhesion, and molding (FIG. 2), while their mechanical properties (softness, firmness, and strength) are regulated by network architecture. To that end, we report exemplary A-g-B chemical structures that target specific application needs. (FIG. 20a). First, using PDMS side chains and PMMA A-blocks in the above discussed PMMA-g-PDMS system (FIG. 20b) is beneficial for thermal stability of mechanical properties. The combination of a low glass transition temperature of PDMS (T_{g}=−124° C.) and highly cohesive PMMA domains maintains nearly constant storage and loss moduli within broad temperature (<100° C.) and frequency ranges (10⁻²-10² Hz), which is valuable for devices subjected to considerable thermal fluctuations. However, other applications, e.g., injection molding and 3D-printing, require fluidity at moderate temperatures. This was achieved by replacing PMMA with less cohesive PS as A-block, resulting in a storage modulus, G′, decrease above the PS glass transition temperature of 105° C. and demonstrating an elastomer-to-melt transition at 150° C. (FIG. 20b). The enhanced fluidity of the PS block enables injection molding and 3D printing of various shapes (FIG. 20c) that match the deformation response (modulus, strength, and elongation-at-break) of solution cast samples (FIGS. 8 and 21).

Materials: Tetrahydrofuran (THF), toluene, acetone, hexane, acetonitrile, and p-xylene were purchased from Fisher Scientific and used as received. Styrene and n-butyl acrylate (BA) were purchased from Fisher Scientific and were passed twice through basic alumina column to remove inhibitor. 2,2′-Azobis(2-methylpropionitrile) (AIBN, 98%), Methyl 2-(dodecylthiocarbonothioylthio)-2-methylpropionate (CTA, 97%), α-bromoisobutyryl bromide (BiBB, 98%), 2-Hydroxyethyl 2-bromoisobutyrate (HEBIB, 95%), methacryloyl chloride (MACI, 97%), triethylamine (TEA), copper (I) bromide (CuBr, 99.999%), tris [2-(dimethylamino)ethyl]amine (Me₆TREN), N,N,N′,N″,N″-Pentamethyldiethylenetriamine (PMDETA), dibutyltin dilaurate (DBTDL, 95%), 2-isocyanatoehtyl methacrylate (IEM, 98%), tetrabutylammonium bromide (TBAB, 98%), 33 wt. % hydrobromic acid solution in acetic acid (HBr), aluminum oxide (activated, basic, Brockmann I), silica gel (230-400 mesh) were purchased from Sigma Aldrich and used as received. Poly(ethylene glycol) methacrylate (PEGMA, Mₙ=500 g/mol) was obtained from Sigma Aldrich and purified by passing (twice) through basic alumina column to remove inhibitor. Monomethacryloxypropyl terminated polydimethylsiloxane (PDMSMA, MCR-M11, Mₙ=1000 g/mol) and potassium methacrylate (KOMA, 95-100%) were obtained from Gelest. The former was purified using a basic alumina column to remove inhibitor and the latter was used as received. RB HR-PIB-1000 was obtained from RB Products and used as received. Methyl methacrylate (MMA, 99%) and styrene (Sty, 99%) was obtained from Fisher Scientific and purified using a basic alumina column to remove inhibitor. Teflon petri dishes were purchased from Welch Flourocarbon.

Atomic force microscopy. Monolayers of A-g-B brush copolymers were prepared by Langmuir-Blodget using a KSV 5000 onto a muscovite sheet (FIG. 2a,b). The monolayer was formed by diluting the polymer in dichloromethane to 0.3 mg/mL and dispersing 75 μL onto the water reservoir. The muscovite sheet was removed from the water reservoir at a 5 mm/min once the surface tension had reached 0.5 mN/m, forming a polymer monolayer on the muscovite sheet. Obtaining an image with clustered domains was achieved by forming a less dense layer of polymers on the surface of the water with a surface tension ˜0.4 mN/m. Imaging was performed in PeakForce QNM mode using a multimode AFM (Brüker) with a nanoscope V controller and silicon nitride (Scanasyst-Air by Brüker, resonance frequency of 50-90 HZ and spring constant of 0.4 N/m). Inter-brush distance was calculated by the mean of 50 individual measurements between brush peaks on the AFM height micrograph on the Nanoscope Analysis software (Brüker).

Small angle X-ray scattering (SAXS). SAXS measurements were performed on the ID02 and BM26 beamlines of the ESRF (grenoble, France). The experiments at ID02 were conducted in transmittance geometry with a photon energy of 12.46 KeV. The total phototon flux on the sample is estimated to 9.1 photons persecond with the monochromatic incident X-ray beam collimated to a footprint of 100×200 μm² (V x H) allowing an acquisition time of less than 100 ms per frame. The q values (q=4π sin (θ)/λ range from 7.5×10⁻³ nm⁻¹ to 3 nm⁻¹ at a sample detector distance of 2 m. Optimization of the signal-noise ratio through a Rayonix MX-170HS in a 35 m long vacuum flight tube was achieved through the binning of 2×2 pixel leading to an effective pixel size of 89 μm in both directions. SAXS images at BM26 were collected using a Pilatus 1M detector (169 mm×179 mm active area). The experiments were performed in transmission geometry using a photon energy of 12.99 keV and sample-to-detector distance of 2.8 m. Mechanical stretching of the samples was carried out using tensile cell from Linkam (LINKAM TST 350). The data correction, calibration, and integration was performed using the fast azimuthal integration Python library. (reference to insert: G. Ashiotis, A. Deschildre, Z. Nawaz, J. P. Wright, D. Karkoulis, F. E. Picca and J. Kieffer Journal of Applied Crystallography, 2015, 48, 510-519). To compute form factor parameters 1 D SAXS curves were fit to a scattering for a polydisperse population of spheres with uniform scattering length density. The distribution of radii is a Gaussian distribution. The data modelling and analysis were performed using the SANS & USANS data reduction and analysis package provided by NIST5 for Igor Pro 6.7.3.2 environment from WaveMetrics Ltd.

Uniaxial tensile stress strain measurements. Dog bone shaped samples with bridge dimensions of 12 mm×2 mm×1 mm were loaded into an RSA-G2 DMA (TA Instruments) and subjected to uniaxial extension at 20° C. and constant strain rate of 0.005 s⁻¹ for PDMS samples and 0.001 s⁻¹ for PIB samples. Samples were stretched until rupture, revealing the entire mechanical profile. In each case, mechanical tests were conducted in triplicate to ensure accuracy of the data. The elongation ratio A for uniaxial network deformation is defined as the ratio of the sample's instantaneous size L to its initial size L₀, λ=L/L₀. At small and intermediate deformation range, all stress-deformation curves, σₜᵣᵤₑ (λ), follow non-linear equation of network elasticity and switch to a linear scaling, σₜᵣᵤₑ (λ)˜λ, at large deformations (see FIG. S2). Network elastic parameters (E, E₀, β) obtained from the fitting of stress-deformation curves were averaged over sample triplicates, while reported λₘₐₓ and σₘₐₓ are given for the largest of each triplicate.

Fitting structural modulus (E) and strain stiffening (β). In the elastic deformation regime, raw stress strain curves for uniaxial deformation were fitted to the following non-linear equation

$${σ}_{true} ( λ ) = \frac{E}{9} ( {λ}^{2} - {λ}^{- 1} ) ( 1 + 2 {( 1 - \frac{β ( {λ}^{2} + 2 {λ}^{- 1} )}{3} )}^{- 2} ) . \qquad ( S1 )$$

with E and β being fitting parameters as illustrated in FIG. S2. The corresponding Young's modulus, E₀, at small deformations, 2->1, is given by

$${E}_{0} = \frac{E}{3} ( 1 + 2 {( 1 - β )}^{- 2} ) . \qquad ( S2 )$$

Rheology. Frequency and temperature sweeps were performed on the ARES-G2 Rheomoeter (TA instruments) with 8 mm compression plate geometries. Samples were prepared by cutting 8 mm diameter disks with approzimate height of 1 mm (exact height was specified in the rheometer for each sample). The frequency sweep was performed from 0.01 to 100 Hz (within the viscoelastic PSA range) at 22° C. at with ε=0.05 to ensure adequate contact area between the compression plate and sample. The temperature sweep was performed from 20° C. to 200° C. with \dot{ε}=0.05 oscillating at 1 Hz. Noisy data in melt state at high temperatures as a consequence to the infacial contact area between the compression plate and sample decreasing were removed.

Fused-filament fabrication 3D printing. Fused-filament fabrication 3D printing was performed with poly[nBA-ran-MMA-g-(PIB/PS)] sample 030722_2 using a Cellink BioX 3D printer where shape stl. files were created with Tinkercad (for dogbones) and Photoshop (for UNC logo) (FIG. 4c). The polymer reservoir was heated to 150° C. to ensure adequate flow and extruded at a pressure of 120 kPa. Multiple dog-bone shape samples were printed with one left raw and the other annealed at 100° C. for 5 minutes (FIG. 21).

Modified probe tack testing. The W_{adh} was measured using a modified version of the probe tack test using a G2-RSA DMA. The top arm contained a 2 mm diameter probe and the bottom arm was a 25 mm plate both with roughness of 0.5 microns (TA instruments). Segments of sample were placed on the bottom compression plate and allowed to wet the surface over time. In addition, a rubber roller was used to apply light pressure ensuring the adhesive bond between the elastomer and bottom plate (acting as carrier) remained intact during measurement.

Gel-permeation chromatography (GPC). The molecular weight of the A-g-B brush copolymers synthesized by grafting through free-radical polymerization was determined by GPC using a Tosoh EcoSEC Elite GPC system equipped with a TSKgel Super HM-M (17392) column maintained at 40° C. with an RI detector and Tosoh LENS™ 3 multiangle light scattering detector. Tetraydrofuran was used as the mobile phase at a flow rate of 0.5 mL/min. Molecular weight and and dispersity is reported based on polystyrene standards. Note that molecular weight readings are not very reliable from the RI detection, so molecular weights were reported from light scattering detection.

### Example 1. CRP of Synthesis of poly[MMA-g-(PDMS/PMMA)] AND poly[nBA-ran-MMA-g-(PDMS/PMMA)]

Functionalization of PEGMA-OH. PEGMA (40 g, 40 mmol), TEA (4.04 g, 40 mmol), THF (40 mL) and a stir bar were added to a round bottom flask and left to stir at 0° C. for 30 minutes. BiBB (9.16 g, 4.92 mL, 40 mmol) was added dropwise over 15 minutes to the reaction mixture. The solution was brought to room temperature and left to stir for an additional 2 hours. The mixture was centrifuged and the organic layer decanted and concentrated under vacuum. The reaction mixture was then passed through a silica column and dried overnight resulting in a functionalized PEGMA-Br ATRP initiator as a functional site for future polymerization.

Grafting Through RAFT copolymerization. For a graft copolymer macroinitiator with architectural parameters of n_{g}=8, n_{sc}=14, nₓ=100, PDMSMA (20 g, 20 mmol), BA (17.9 g, 0.14 mol), PEGMA-Br (1.04 g, 1.6 mmol), CTA (21.8 μL, 57.6 μmol), AIBN (2.3 mg, 14.4 μmol), toluene (20 mL), and a stir bar were added to a Schlenk flask. The solution was bubbled with dry nitrogen for 1 hour, then submerged into an oil bath at 70° C., and left to polymerize overnight. The polymerization was quenched by opening the flask, the reaction mixture dried, and the conversion determined by ¹H-NMR to be 88% of a random PDMSMA, PEGMA-Br and PBA copolymer with n_{bb} =1935. The polymer mixture was precipitated from methanol 2-3 times to remove residual PDMSMA and dried under vacuum until a constant mass was reached.

Grafting From to synthesize poly[MMA-g-(PDMS/PMMA)] via ATRP. The resulting polymer brushes polymerized by RAFT were then used as macroinitiators for ATRP growth of linear MMA. For a typical graft copolymer plastomer, graft copolymer initiator (2 g), excess MMA (2 g), M₆TREN (5 μL, 18.7 μmol), toluene (50 mL) and a stir bar were added to a Schlenk flask. The solution was bubbled with dry nitrogen for 1 hr then Cu(I)Br (2.8 mg, 18.7 μmol) was quickly added to the reaction mixture under nitrogen atmosphere. The flask was sealed, purged for an additional 15 minutes, and then immersed in an oil bath at 45° C. The polymerization was visually monitored to avoid gelation of the growing chains. The polymerization was quenched at various times to afford to afford a series of graft copolymers with increasing PMMA ratio. Note, reaction times were relatively short (0.5-1.5 hr) using 20 mL of toluene before observed gelation similarly documented in the literature, however excess toluene (>80 mL) allowed for larger growth time (2 hr) of PMMA chains before gelation. All resulting graft copolymer plastomers were swelled and washed two-three times with acetone to remove PMMA homopolymer, and then swelled and washed two-three times with hexanes to remove unreacted brushes. These impurities typically represent <10% of the total yield. Finally, the n_{A} and ϕ_{A} of the PMMA side chains were measured by ¹H-NMR as summarized in Table 1, PEG appendage excluded. Samples were then dissolved in THF (75 wt % solvent) and poured into Teflon petri-dishes and left to dry overnight to yield films for further mechanical testing. Note that the grafting from approached exhibited synthetic limitations where ϕ_{A} did not exceed 0.07 due to insolubility between the growing A-g-B brush strand in residual monomer/solvent solution. Another factor may be the polarity/functionality of the RAFT end groups during ATRP. Further experimentation is needed to greater understand the interplay between attainable ϕ_{A} and x of monomers and synthesized polymer. Note: higher PA was attained by increasing n_{g} in poly[nBA-ran-MMA-g-(PDMS/PMMA)] brush copolymers.

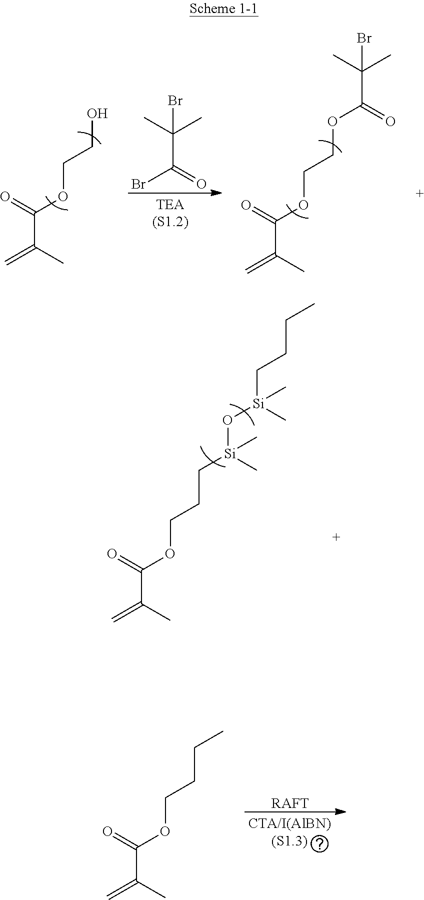

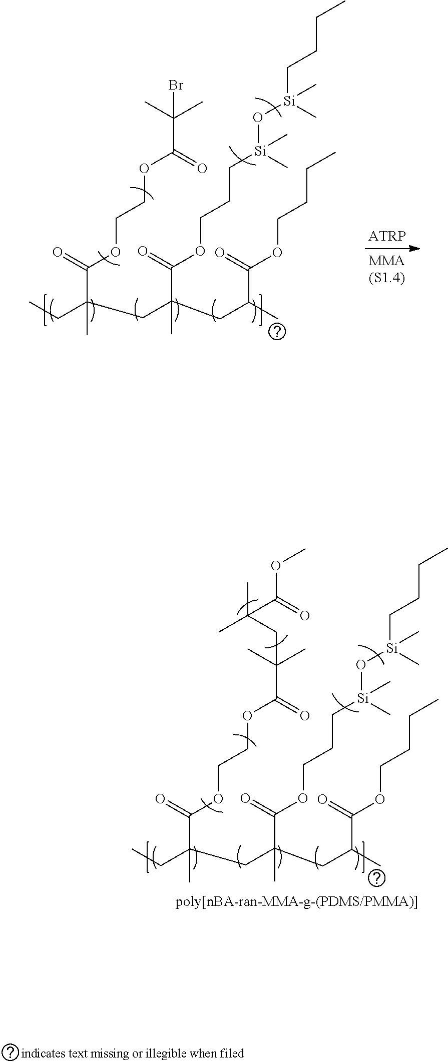

A-g-B brush graft copolymer synthesis by CRP methods. Note: omitted RAFT end groups correspond with methyl 2-(dodecylthiocarbonothioylthio)-2-methylpropionate, CTA. (at brackets)

### Example 2. Free-Radical Polymerization of poly[nBA-ran-MMA-g-(PDMS/PS)] and poly[nBA-ran-MMA-g-(PIB/PS)]]

[(PMMA)-g-(PDMS)] and [(PMMA)-g-(PDMS)-PBA] brush graft copolymers synthesized by CRP are inefficient temporally and require comprehensive purification of substantial quantities of metal-ligand complex. For more efficient polymerization, A-g-B brush graft copolymers can also be polymerized by UV initiated free-radical (FR) polymerization, though at a detriment to precise determination of n_{bb} (Ð˜2). Turning to free-radical polymerization of A-g-B brush copolymers, both brush side chain and A-block chain must be pre-synthesized into side chain macromonomers and subsequently grafted through. Grafting through the oligomeric reagents introduces other synthetic consideration including interaction energy between side-chain macromonomers, A-block macromonomers, and solubility.

Anti-Markovnikov bromination of HR-PIB 1000, n_{sc}=18. To a 250 mL round bottom flask equipped with a stir bar, 50 g (0.05 mmol) RB HR-PIB (Mₙ=1000 g/mol, Ð˜1.9) and hexane (150 mL) was added and placed in an ice bath. The solution was bubbled with oxygen for 30 minutes at 0° C. and 24.3 g of 33 w/w % HBr (0.1 mol) in EtOAc was added dropwise to the flask with vigorous stirring. The reaction stirred for 2 hrs at 0° C. and brought up to room temperature where it was left to stir overnight. Stirring was ceased and the resultant anti-Markovnikov bromine functionalized PIB oligomer was washed with H₂O/Na₂CO₃ twice, dried with anhydrous MgSO₄, and passed through a short SiO₂ column. The hexanes were evaporated by bubbling with air yielding 98% functionalized polymer (determined by ¹H-NMR, FIG. S15). No residual olefin residue was present suggesting higher conversion.

Synthesis of PIB macromonomer, n_{sc}=18. The functionalized oligomer (45 g, 0.042 mol) was dissolved in THF (350 mL) and transferred to an oven dried 500 mL round bottom flask equipped with a stir bar. The solution was charged with 26.0 g KOMA (0.21 mol) and 67.6 g TBAB (0.25 mol) and stirred for 36 hrs at 45° C. The solution was centrifuged to remove residual salt and unreacted reagent. Subsequently, the solution was condensed by bubbling with air and washed with H₂O/hexane twice. The organic layer was separated, dried with anhydrous MgSO₄, and ran through a SiO₂ column twice yielding PIB (n_{sc}=18) macromonomer product (99% conversion, ˜ 90% yield). Again, no residual peaks were present from the α-hydrogens suggesting higher yield.

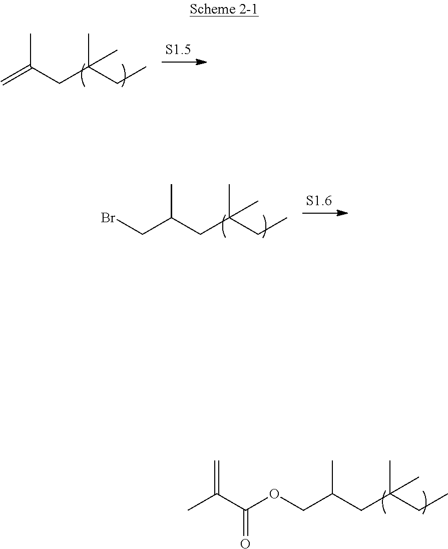

### Scheme 2-1. PIB Macromonomer Synthesis

Bromine functionalization of PEGMA-OH. PEGMA (40 g, 40 mmol), TEA (4.04 g, 40 mmol), THF (40 mL) and a stir bar were added to a round bottom flask and left to stir at 0° C. for 30 minutes. BiBB (9.16 g, 4.92 mL, 40 mmol) was added dropwise over 15 minutes to the reaction mixture. The solution was brought to room temperature and left to stir for an additional 2 hours. The mixture was centrifuged, and the organic layer decanted and concentrated under vacuum. The reaction mixture was then passed through a silica column and dried overnight resulting in a functionalized PEGMA-Br ATRP initiator as a functional site for future polymerization.

Grafting through RAFT copolymerization of PIB side chains. For a graft copolymer macroinitiator with architectural parameters of n_{g}=1, n_{sc}=18, nₓ=163, n_{bb} =900, PIB macromonomer (20 g, 20 mmol), PEGMA-Br (0.066 g, 0.13 mmol), CTA (2.4 μL, 0.61 μmol), AIBN (0.26 mg, 0.16 μmol), toluene (30 mL), and a stir bar were added to a Schlenk flask. The solution was bubbled with dry nitrogen for 1 hour, then submerged into an oil bath at 80° C., and left to polymerize for 36 hr. The polymerization was quenched by opening the flask, the reaction mixture was dried, and the conversion determined by ¹H-NMR was 70% of a random PIB and PEGMA-Br and with n_{bb} =900. The polymer mixture was precipitated from 2:1 ratio of toluene: acetone 2-3 times to remove residual PIB macromonomer and dried under vacuum until a constant mass was reached.

Grafting from to synthesize poly[M_{A}-g-(PIB/PS)] via ATRP. The resulting polymer brushes polymerized by RAFT were then used as macroinitiators for ATRP growth of linear polystyrene (PS). For a typical brush backbone copolymer, graft copolymer initiator (3 g), excess styrene (2 g), M₆TREN (7.6 μL, 33 μmol), toluene (50 mL) and a stir bar were added to a Schlenk flask. The solution was bubbled with dry nitrogen for 1 hr then Cu(I)Br (4.7 mg, 33 μmol) was quickly added to the reaction mixture under nitrogen atmosphere. The flask was sealed, purged for an additional 15 minutes, and then immersed in an oil bath at 90° C. The polymerization was quenched at various times to afford a series of graft copolymers with increasing PS ratio. Note, reaction times were relatively short (2-6 hr). All resulting solutions were washed 2-3 times with 2:1 ratio of toluene: acetone to remove PS homopolymer. Finally, the n_{A} and ϕ_{A} of the PS side chains were analyzed by ¹H-NMR, PEG appendage excluded. Samples were then dissolved in toluene (75 wt % solvent) and poured into Teflon petri-dishes and left to dry overnight under reduced pressure to yield films for further mechanical testing.

Synthesis of PS oligomers. ATRP of polystyrene homopolymer was performed with a target n_{A}=60 at 34% conversion to avoid large viscosities at higher conversion. Styrene (100 g, 0.96 mol), HEBIB (1.16 g, 5.5 mmol), PMDETA (0.095 g, 0.114 mL, 0.55 mmol), and a stir bar were added to a Schlenk flask. The solution was bubbled with dry nitrogen for 1 hour then Cu(I)Br (0.079 g, 0.55 mmol) was quickly added to the reaction mixture under nitrogen atmosphere. The flask was sealed, purged for an additional 15 minutes, and then immersed in an oil bath at 90° C. The reaction mixture was left to polymerize for 14 hrs to receive a 34% conversion (n_{sc}=60) and the reaction was quenched by exposing the mixture to oxygen. The mixture was centrifuged and gravity filtered to remove residual Cu-ligand complex. Residual styrene monomer was evaporated and the remaining PS oligomer was dissolved in minimal THF and crashed in excess methanol (1:10, THF: Methanol by volume) 3 times. The washed PS oligomer was dried overnight at room temperature under reduced pressure to remove any residual solvent.

Synthesis of PS (DP=60) macromonomer. The PS oligomer (30 g, 4.8 mmol, DP =60) was transferred to a round bottom flask sealed by rubber septum and parafilm and dissolved in 60 ml of THF. Once the PS was fully dissolved, 0.05 g (47 μL, 80 μmol) dibutyltin dilaurate was added to the solution, it was subsequently purged of oxygen by bubbling the solution with nitrogen for 10 minutes. IEM (0.82 g, 0.75 mL, 5.3 mmol) was added dropwise to the round bottom flask under constant stirring. Nitrogen was removed from the flask, and the solution was set to stir for 18 hr. The subsequent solution was further diluted with THF (5-10x) and passed through silica column twice. The purified mixture was dried under reduced pressure and characterized by ¹H-NMR. H¹-NMR reveals 80% conversion so subsequent calculations for ϕ_{A} for performed considering an 80% ratio of macromonomers.

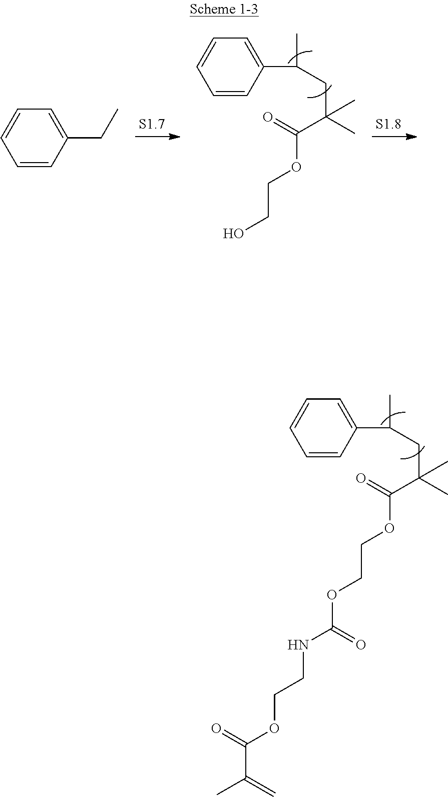

### Scheme 1-3. PS Macromonomer Synthesis

FR polymerization of A-g-B brush copolymers by grafting through. A Schlenk flask was charged with appropriate molar quantities of side-chain macromonomer (PDMS, PIB), spacer (n-BA), A-block macromonomer (PS), 1:1 volume of p-xylene, and 0.15 mol % initiator (BAPO). The flask was shielded from light and purged with nitrogen for 30 minutes. Subsequently, the solution was removed from nitrogen and allowed to polymerize under UV-light for 18 hr. The solution exhibits a light-yellow color upon introduction to the UV-light but returns to transparent after polymerization. The unwashed polymer solution was caste in a Teflon mold at 60° C. and dried overnight. The resultant polymer was washed according to chemistry. poly[nBA-ran-MMA-g-(PIB/PS)]: the unwashed polymer was dissolved in THF and crashed with acetonitrile (1:1.2, THF: acetonitrile) 3 times. The washed polymer was dissolved in p-xylene once more and caste into a Teflon petri-dishes (Welch Fluorocarbon) at 60° C. and dried overnight to be characterized by ¹H-NMR where no macromonomer peaks remained. poly[nBA-ran-MMA-g-(PDMS/PS)]: the unwashed polymer was dissolved in acetone and crashed out in acetonitrile (2:1, acetone: acetonitrile). This wash was repeated three times. The washed polymer was dissolved in p-xylene once more and caste into a Teflon petri-dishes and dried overnight to be characterized by ¹H-NMR where no macromonomer peaks remained. Note that unreacted reagents act as diluent and decrease the modulus of the network. Comparing washed and unwashed A-g-B network stress-strain curves exhibit this behavior. The number average molecular weight (Mₙ) of the A-g-B brush polymer stand was determined by light scattering detection during gel-permeation chromatography: Ex. synthetic calculations. poly[nBA-ran-MMA-g-(PIB/PS)]. Sample: 030722_1. 2.00 g n-butyl acrylate (15.6 mmol), 2.41 g PIB macromonomer (2.23 mmol), 0.27 g PS macromonomer (43 μmol, 80% conversion PS mixture, total mass 0.34 g), 7 mg BAPO (17 μmol, 0.15 w/w %), and 4.5 mL of p-xylene.

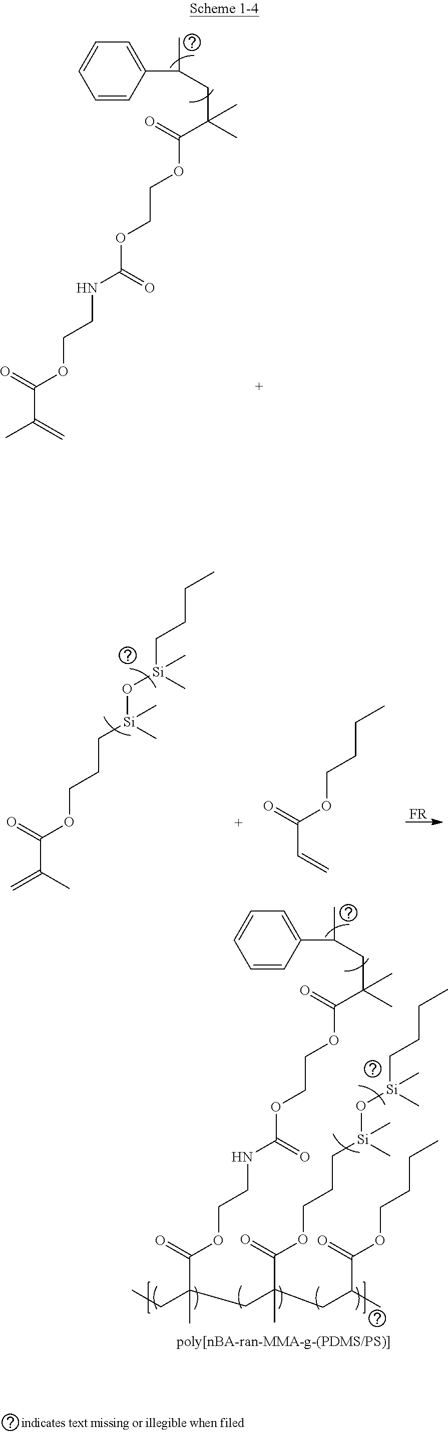

### Scheme 1-4 Depicts Polymerization of poly[nBA-ran-MMA-g-(PDMS/PS)] Brush Graft Copolymers

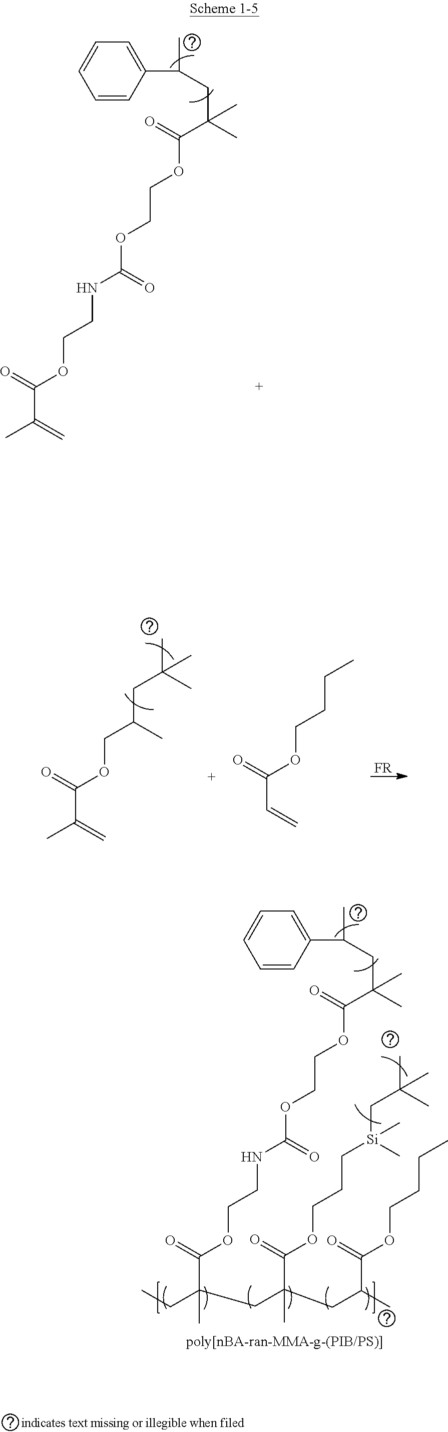

### Scheme 1-5 Depicts Polymerization of poly[nBA-ran-MMA-g-(PIB/PS)] Brush Graft Copolymers

### Example 2. Synthesis of macromonomers (FIG. 1a) and hybrid brush-like graft copolymers (FIG. 1b)

Specific non-limiting (macro)monomers and monomers for the disclosed brush-like graft copolymer formulations area provided below. It should be noticed that in all synthetic procedures, “brush” is interchangeable with “comb”, which means spacing between neighboring side chains on the graft copolymer backbone.

Examples of the synthesis of macromonomers to form hybrid brush-like graft copolymer elastomers are described below. It should be noted that the synthetic procedures are exemplary and readily expandable to macromonomers of any chemistry. Furthermore, in some aspects, macromonomers possess brush-like chemical structure, which results in brush-on-brush or brush-on-comb brush-like graft copolymer elastomers, as shown in Scheme 2. Brush-like networks are classically defined by three independent structural parameters-side chain length (n_{sc}), side chain grafting density (n_{g}), and brush length between crosslink junctions (nₓ), but are complemented with total strand length (n_{bb}) and number of elastic repeat units (z=n_{bb}/nₓ). The [n_{sc}, n_{g}, n_{A}, ϕ_{A}, nₓ, n_{bb}] quintuplet can be varied within a broad range [1-150, 1-100, 50-2000, 300-3000, 1-100], respectively.

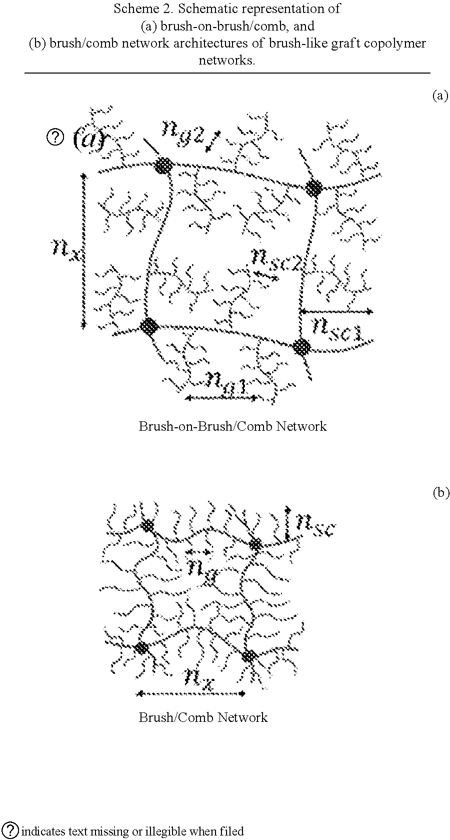

### a) Preparation of Macromonomers B-F in FIG. 1a for Grafting-Trough Copolymerization

Macromonomers included into hybrid brush-like graft copolymer materials can be sourced from ready-to-use commercially available sources, commercially available sources that require additional functionalization or total synthesis from starting monomers as summarized below (a.1-3) for use in various polymerization methods including atom transfer radical polymerization (ATRP), free radical polymerization (FRP) and reversible addition-fragmentation chain-transfer (RAFT) polymerization. a.1) Synthesis of macromonomers by atom transfer radical polymerization (ATRP). Various monomers can be polymerized into macromonomers by ATRP including styrene, methacrylates and acrylates. As an example, a Schlenk flask equipped with a magnetic stir bar was charged with ethyl α-bromoisobutyrate (EBiB), monomer (styrene, methacrylates or acrylates), N,N,N′,N″,N″-pentamethyldiethylenetriamine (PMDETA), and anisole (Scheme 3). The solution was bubbled with dry nitrogen for 1 hr. Then, CuBr was added to the reaction mixture under nitrogen atmosphere. The flask was closed, purged for 5 min with nitrogen, and immersed in an oil bath set at 90° C. The polymerization was stopped after predetermined time when monomer conversion reached 70 mol % (determined using 1H NMR). The polymer solution was passed through a neutral aluminum oxide column and the unreacted monomers were evaporated. The remaining polymer was dissolved in dimethyl acetamide (DMA) or anisole and transferred to a flask. Potassium acrylate was synthesized by reaction of acrylic acid (AA) and Potassium tert-butoxide (KOtBu) and added to the solution, which was stirred for 72 hrs at room temperature (Scheme 4). The solution was filtered, diluted with methylene chloride (DCM), then washed with deionized (DI) water three times. The macromonomer solution was dried by adding magnesium sulfate (MgSO₄) and then by overnight evaporation in air.

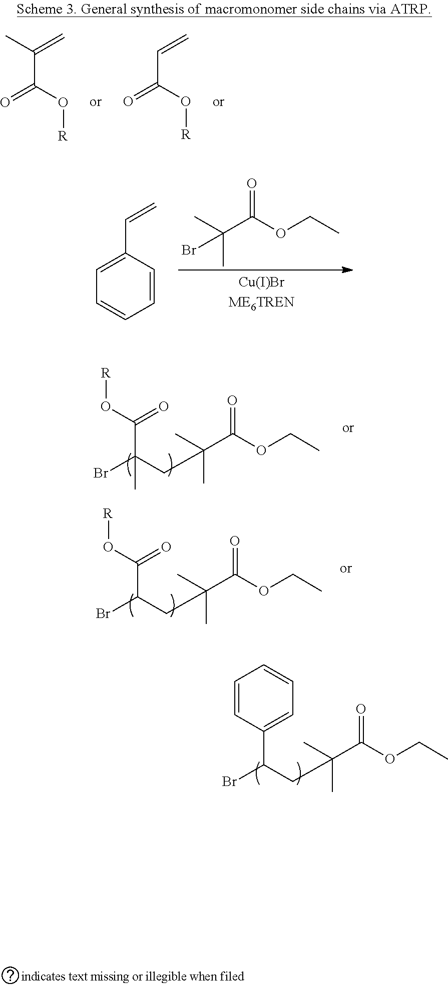

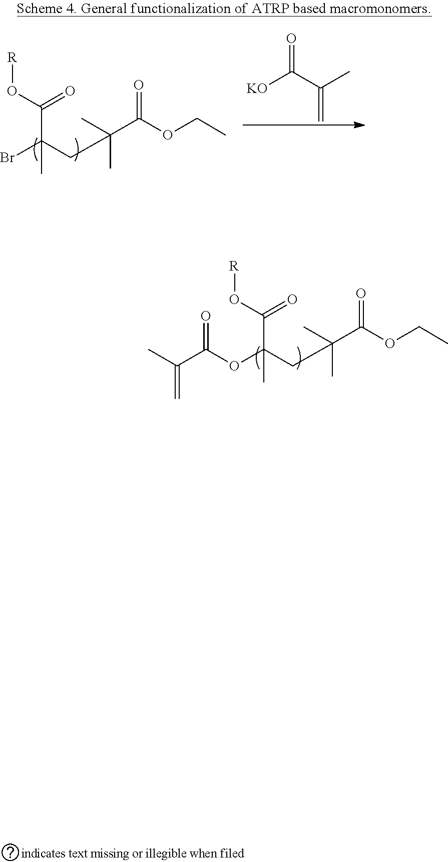

a. 2) Synthesis of macromonomers by ring opening polymerization (ROP). Various monomers can be polymerized into macromonomers by ROP including, but not limited to, lactones, lactides, glycolides and epoxys to give corresponding polyesters and polyethers. As an example, dried ethanol, ε-caprolactone, anhydrous toluene was added in an oven-dried flask (Scheme 5). To the solution was added 3 Å molecular sieves and the mixture was dried for 48 h. The solution was filtered and dibutyltin dilaurate was added. The reaction mixture was heated to 120° C. Between 6 and 8 h, the reaction became viscous and magnetic stirring became hard. After reaching to the degree of polymerization equal 10, the reaction was cooled to room temperature. The polymer was precipitated in chilled methanol 3× and left to dry. The resulting polymer was dissolved DCM and dried with anhydrous MgSO₄ overnight. The polymer solution was filtered and transferred to a flask and triethylamine was added and cooled to 5° C. using an ice bath. Methacryloyl chloride in anhydrous DCM was added dropwise to the mixture, the ice bath was removed and the temperature was increased to room temperature. The reaction was continued overnight. The mixture was filtered and filtrates were washed with water 3×. The contents were then concentrated and precipitated into chilled methanol 3× and left to dry overnight.

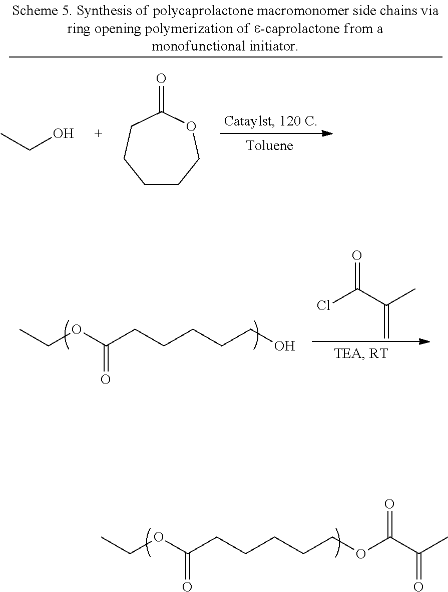

a.3) Functionalization of commercial macromonomers. Various commercially available macromonomers can be functionalized to be compatible with selected polymerization methods. As an example, but not limited to, commercially available vinyl terminated polyolefins i.e. polyisobutylene (PIB) macromonomers can be converted to methacrylates for compatibility with atom transfer radical polymerization (ATRP). In addition, vinyl terminated polyolefins can be used without further functionalization using free radical polymerizations (FRP) and reversible addition fragmentation chain transfer (RAFT) polymerizations. As example synthesis for functionalization for ATRP: PIB with various molecular weight in the range of 100-10,000 Da were synthesized according to the following procedure (Scheme 6). To a 250 mL round bottom flask equipped with a stir bar, 50 g (0.05 mmol) RB HR-PIB (Mₙ=1000 g/mol, Ð˜ 1.9) and hexane (150 mL) was added and placed in an ice bath. The solution was bubbled with oxygen for 30 minutes at 0° C. and 24.3 g of 33 w/w % HBr (0.1 mol) in EtOAc was added dropwise to the flask with vigorous stirring. The reaction stirred for 2 hrs at 0° C. and brought up to room temperature where it was left to stir overnight. Stirring was ceased and the resultant anti-Markovnikov bromine functionalized PIB oligomer was washed with H₂O/Na₂CO₃ twice, dried with anhydrous MgSO₄, and passed through a short SiO₂ column.

The functionalized oligomer (45 g, 0.042 mol) was dissolved in THF (350 mL) and transferred to an oven dried 500 mL round bottom flask equipped with a stir bar. The solution was charged with 26.0 g KOMA (0.21 mol) and 67.6 g TBAB (0.25 mol) and stirred for 36 hrs at 45° C. The solution was centrifuged to remove residual salt and unreacted reagent. Subsequently, the solution was condensed by bubbling with air and washed with H₂O/hexane twice. The organic layer was separated, dried with anhydrous MgSO₄, and ran through a SiO₂ column twice yielding PIB (n_{sc}=18) macromonomer product (99% conversion, ˜ 90% yield). Again, no residual peaks were present from the α-hydrogens suggesting higher yield.

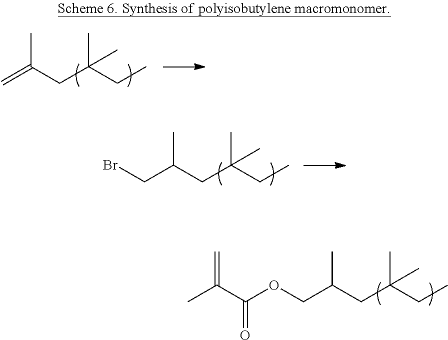

### b) Hybrid Brush-Like Graft Copolymers (FIG. 1b) Via Grafting-Through Copolymerization of Assorted Macromonomers (FIG. 1a)

Macromonomers described in section a.1-3 can be used to synthesize hybrid brush-like graft copolymer networks via a grafting-through approach using polymerization methods such as, but not limited to, atom transfer radical polymerization (ATRP), free radical polymerization (FRP) and reversible addition-fragmentation chain-transfer (RAFT) polymerization as described exemplary in sections b.1-3. Examples of either commercially available macromonomers, post-functionalized commercially available macromonomers and macromonomers synthesized from starting monomers included, but not limited to, in Scheme 7, with a general grafting through polymerization scheme shown in Scheme 8.

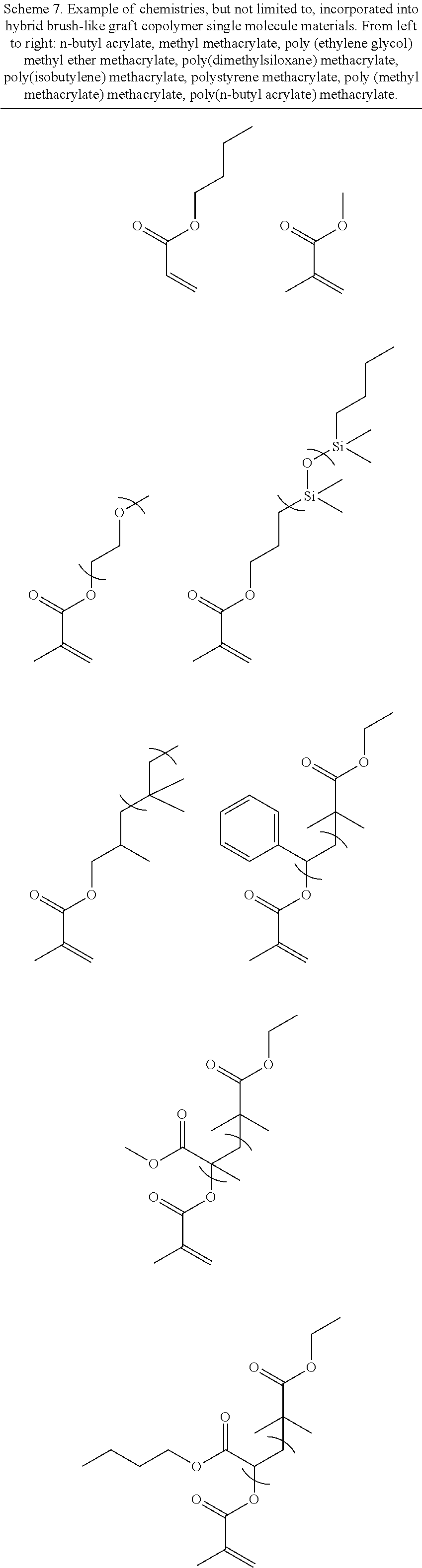

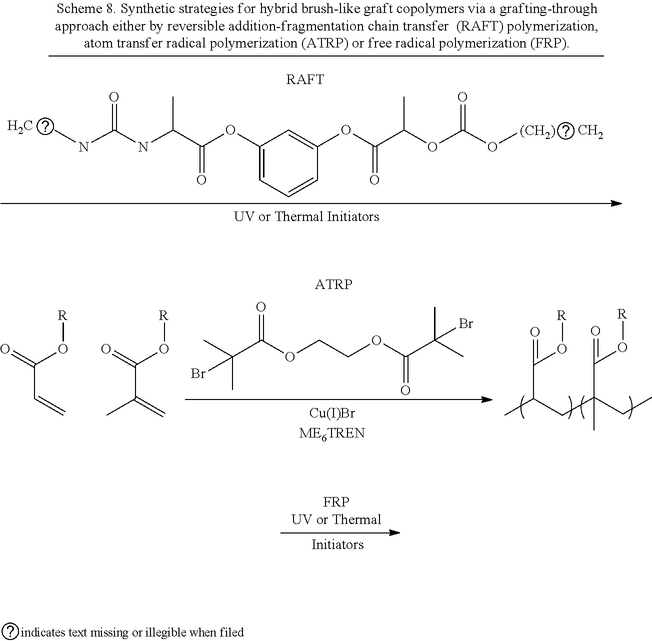

b.1) Grafting-through hybrid brush-like graft copolymers using ATRP. As an example, a Schlenk flask equipped with a magnetic stir bar was charged with ethylene bis(2-bromoisobutyrate) (2-bib), a mixture of macromonomer methacrylate terminated poly(dimethylsiloxane) and monomer methyl methacrylate, tris [2-(dimethylamino)ethyl]amine (Me₆TREN), and toluene (Scheme 9). The solution was bubbled with dry nitrogen for 1 hr. Then, CuBr was added to the reaction mixture under nitrogen atmosphere. The flask was closed, purged for 5 min with nitrogen, and immersed in an oil bath set at 50° C. The polymerization was stopped after predetermined time, the polymer solution was passed through a neutral aluminum oxide column and the unreacted monomers were removed by methanol washed 3× and the sample dried overnight. Rheology of the resulting hybrid brush-like graft copolymer is shown in FIG. 2.

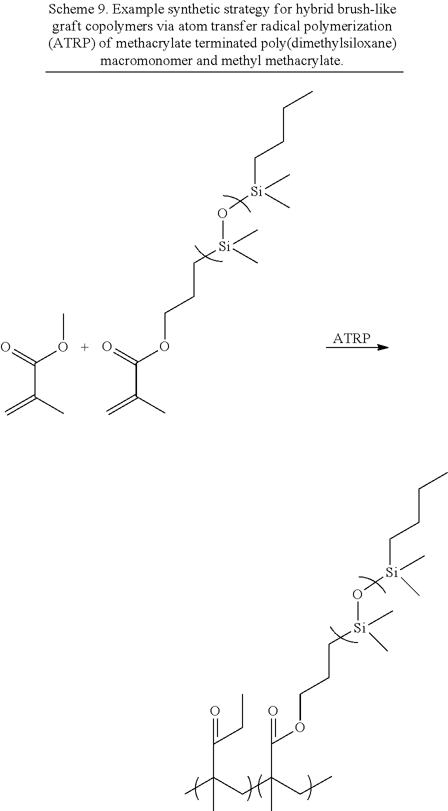

b.2) Grafting-through hybrid brush-like graft copolymers using FRP. As an example, a Schlenk flask equipped with a magnetic stir bar was charged with either thermal initiator such as, but not limited to, 2,2′-Azobis(2-methylpropionitrile) (AIBN) or UV initiator such as Phenylbis(2,4,6-trimethylbenzoyl) phosphine oxide (BAPOs), a mixture of macromonomers methacrylate terminated poly(dimethylsiloxane), methacrylate terminated poly(ethylene glycol), methacrylate terminated poly(styrene) and monomer butyl acrylate, and toluene (Scheme 10). The solution was bubbled with dry nitrogen for 1 hr. Then, the solution was either set at 70° C. or exposed to UV light. The polymerization was stopped after predetermined time, unreacted monomers were removed by methanol washed 3× and acetone washes 3× and the sample dried overnight. Rheology, mechanics and water uptake of the resulting hybrid brush-like graft copolymer is shown in FIG. 3,4,6 respectively.

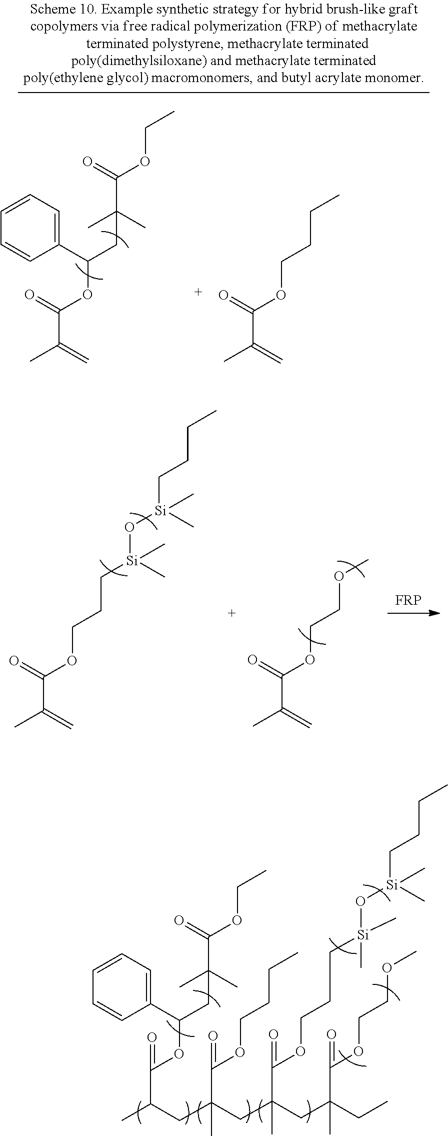

b.3) Grafting-through hybrid brush-like graft copolymers using RAFT. As an example, a Schlenk flask equipped with a magnetic stir bar was charged with either thermal initiator such as, but not limited to, 2,2′-Azobis(2-methylpropionitrile) (AIBN) or UV initiator such as Phenylbis(2,4,6-trimethylbenzoyl) phosphine oxide (BAPOs), chain transfer agent such as, but not limited to, 3,5-Bis(2-dodecylthiocarbonothioylthio-1-oxopropoxy)benzoic acid, a mixture of macromonomers vinyl terminated poly(isobutylene), methacrylate terminated poly(styrene) and monomer butyl acrylate, and toluene (Scheme 11). The solution was bubbled with dry nitrogen for 1 hr. Then, the solution was either set at 70C or exposed to UV light. The polymerization was stopped after predetermined time, unreacted monomers were removed by methanol washed 3× and acetone washes 3× and the sample dried overnight.

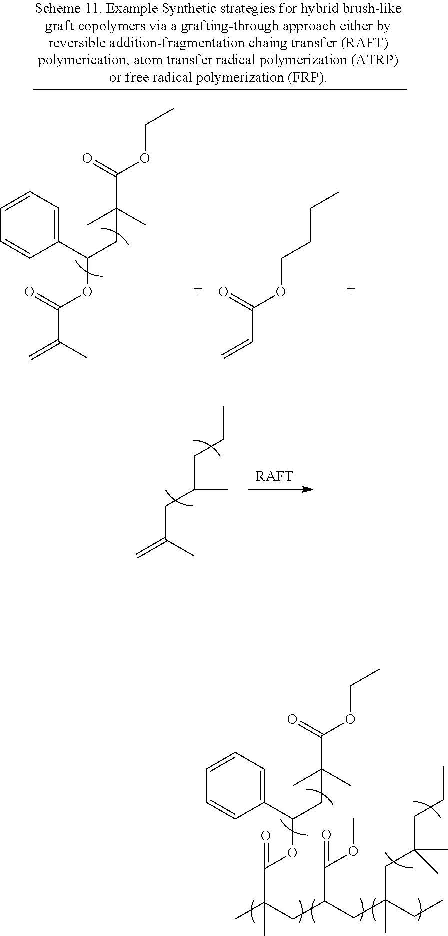

c) Hybrid Brush-Like Graft Copolymer Networks Via Sequential Grafting-Through and Grafting from Approaches and with Functional Side Chain End Groups.

Sequential orthogonal polymerization methods or functionalizations may be exploited to either grow hybrid copolymer grafts from the brush or functionalize side chain end groups with desired chemistry. Orthogonal polymerization methods can include, but not limited to, atom transfer radical polymerization (ATRP), free radical polymerization (FRP), reversible addition-fragmentation chain-transfer (RAFT) polymerization and ring opening polymerization (ROP) using various macromonomers described in, but not limited to, sections a.1-3. Exemplary sequential orthogonal polymerizations or functionalizations are described in sections d. 1-3.

c.1) Hybrid brush-like graft copolymers from sequential grafting-through via RAFT and grafting from via ATRP. As an example, a Schlenk flask equipped with a magnetic stir bar was charged with either thermal initiator such as, but not limited to, 2,2′-Azobis(2-methylpropionitrile) (AIBN) or UV initiator such as Phenylbis(2,4,6-trimethylbenzoyl) phosphine oxide (BAPOs), chain transfer agent such as, but not limited to, 3,5-Bis(2-dodecylthiocarbonothioylthio-1-oxopropoxy)benzoic acid, a mixture of macromonomers methacrylate terminated poly(dimethylsiloxane) and α,ω methacrylate, bromoisobutyrate terminated poly(ethylene glycol) and toluene (Scheme 12). The solution was bubbled with dry nitrogen for 1 hr. Then, the solution was either set at 70C or exposed to UV light. The polymerization was stopped after predetermined time, unreacted monomers were removed by methanol washed 3× and the sample dried overnight. Then a Schlenk flask equipped with a magnetic stir bar was charged with the resulting hybrid brush-like graft copolymer initiator, methyl methacrylate monomer, Tris[2-(dimethylamino)ethyl]amine (Me₆TREN), and toluene (Scheme 12). The solution was bubbled with dry nitrogen for 1 hr. Then, CuBr was added to the reaction mixture under nitrogen atmosphere. The flask was closed, purged for 5 min with nitrogen, and immersed in an oil bath set at 50° C. The polymerization was stopped after predetermined time. The polymer solution was passed through a neutral aluminum oxide column and the unreacted monomers were left to evaporate.

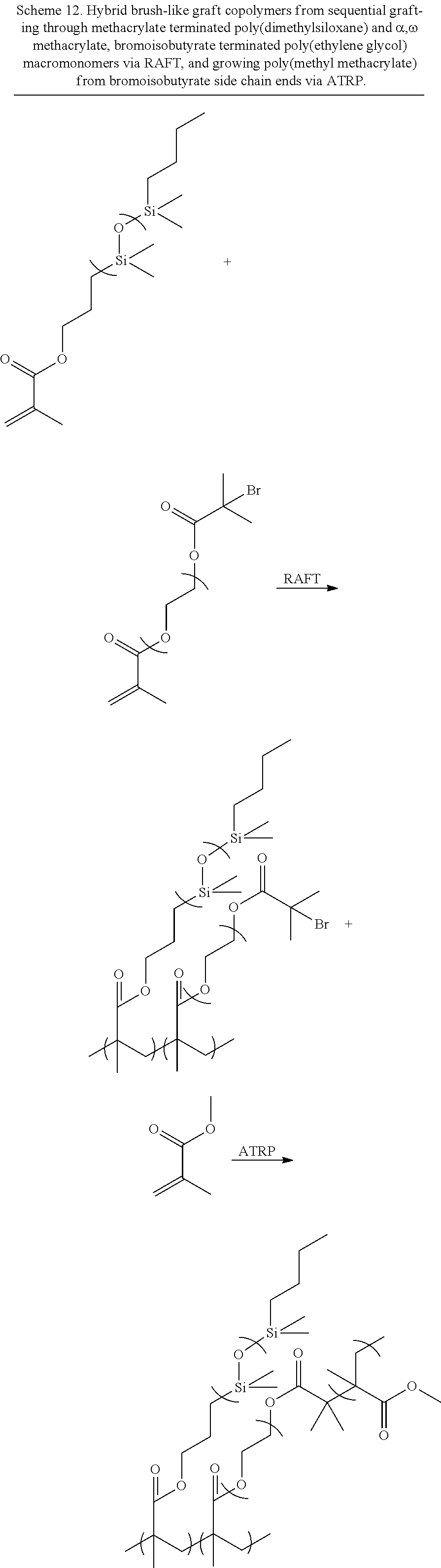

c.2) Hybrid brush-like graft copolymers from sequential grafting-through via ATRP and grafting from via ROP. As an example, a Schlenk flask equipped with a magnetic stir bar was charged with ethylene bis(2-bromoisobutyrate) (2-bib), a mixture of macromonomers methacrylate terminated poly(dimehtylsiloxane) and methacrylate terminated poly(ethylene glycol), tris [2-(dimethylamino)ethyl]amine (Me₆TREN), and toluene (Scheme 13). The solution was bubbled with dry nitrogen for 1 hr. Then, CuBr was added to the reaction mixture under nitrogen atmosphere. The flask was closed, purged for 5 min with nitrogen, and immersed in an oil bath set at 50° C. The polymerization was stopped after predetermined time, the polymer solution was passed through a neutral aluminum oxide column and the unreacted monomers were removed by methanol washed 3× and left to dry overnight. Then a Schlenk flask equipped with a magnetic stir bar was charged with the resulting hybrid brush-like graft copolymer initiator, ε-caprolactone, anhydrous toluene and dibutyltin dilaurate was added and the reaction mixture was heated 120° C. (Scheme 13). The polymerization was stopped after predetermined time, the solution was then precipitated into chilled methanol 3× and dried overnight.

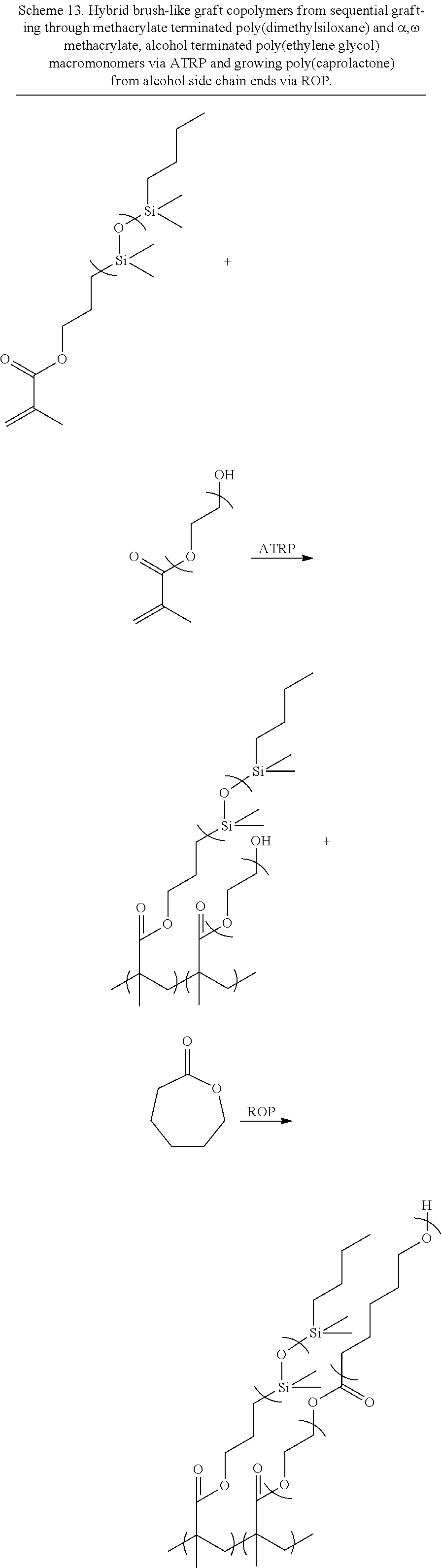

c.3) Hybrid brush-like graft copolymers with functional side chains from sequential grafting-through via ATRP and post functionalization. As an example, a Schlenk flask equipped with a magnetic stir bar was charged with ethylene bis(2-bromoisobutyrate) (2-bib), a mixture of macromonomers methacrylate terminated poly(dimehtylsiloxane) and methacrylate terminated poly(ethylene glycol), tris [2-(dimethylamino)ethyl]amine (Me₆TREN), and toluene. The solution was bubbled with dry nitrogen for 1 hr. Then, CuBr was added to the reaction mixture under nitrogen atmosphere. The flask was closed, purged for 5 min with nitrogen, and immersed in an oil bath set at 50° C. The polymerization was stopped after predetermined time, the polymer solution was passed through a neutral aluminum oxide column and the unreacted monomers were removed by methanol washed 3× and left to dry overnight. The resulting copolymer can be synthesized with predetermined fraction of functionalizable end-groups on the side chains (0.1-100 mol. %) (Scheme 14) and enables various other post-functionalizable reactions including, but not limited to, aldehyde/amines, photocurable moieties and diene/dienophile groups.

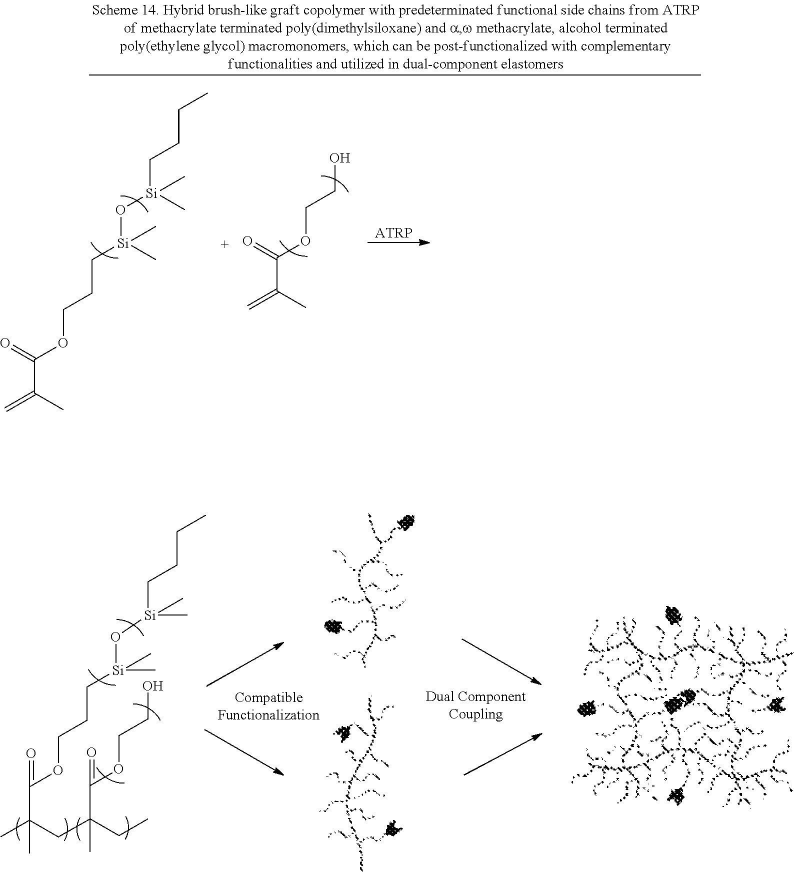

### d) Hybrid Brush-Like Graft Copolymer Networks Via Sequential Grafting-Through and Grafting to Approaches.

Polymerizations followed by sequential grafting onto may be exploited to grow grafts separate from the brush-like structure. Grafting-through polymerization methods can include, but not limited to, atom transfer radical polymerization (ATRP), free radical polymerization (FRP), reversible addition-fragmentation chain-transfer (RAFT) using various macromonomers described in, but not limited to, section a.1-3. Exemplary grafting onto methods and polymerizations are described in sections e. 1,2.

d.1) Synthesis of functionalized macromonomers for grafting onto via ATRP. Various monomers can be polymerized into macromonomers for grafting onto by ATRP including styrene, methacrylates and acrylates. As an example, a Schlenk flask equipped with a magnetic stir bar was charged with ethyl α-bromoisobutyrate (eBiB), methyl methacrylate monomer, N,N,N′,N″,N″-pentamethyldiethylenetriamine (PMDETA), and anisole (Scheme 15). The solution was bubbled with dry nitrogen for 1 hr. Then, CuBr was added to the reaction mixture under nitrogen atmosphere. The flask was closed, purged for 5 min with nitrogen, and immersed in an oil bath set at 50° C. The polymerization was stopped after predetermined time, the polymer solution was passed through a neutral aluminum oxide column and the unreacted monomers were evaporated. The remaining polymer was dissolved in anisole and sodium azide was added to the solution at room temperature (Scheme 15). The reaction was left to react and the polymer was precipitated into methanol 3×. The resulting functionalized macromonomer for grafting onto was left to dry overnight.

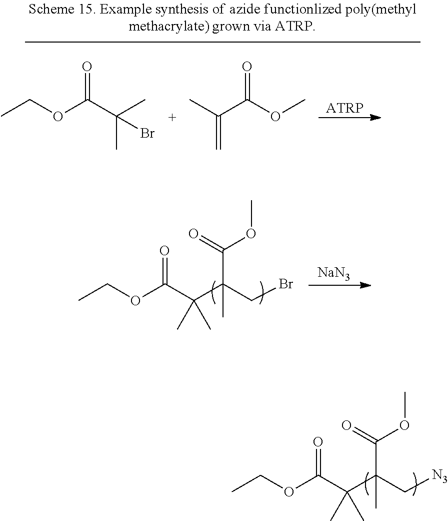

d.2) Hybrid brush-like graft copolymers from sequential grafting-through via ATRP and grafting side chains onto brush backbones. As an example, a Schlenk flask equipped with a magnetic stir bar was charged with ethylene bis(2-bromoisobutyrate) (2-bib), a mixture of macromonomer methacrylate terminated poly(dimethylsiloxane) and monomer propargyl methacrylate, tris [2-(dimethylamino)ethyl]amine (Me₆TREN), and toluene (Scheme 16). The solution was bubbled with dry nitrogen for 1 hr. Then, CuBr was added to the reaction mixture under nitrogen atmosphere. The flask was closed, purged for 5 min with nitrogen, and immersed in an oil bath set at 50° C. The polymerization was stopped after predetermined time, the polymer solution was passed through a neutral aluminum oxide column and the unreacted monomers were removed by methanol washed 3× and left to dry overnight. The resulting copolymer was dissolved in toluene, azide functionalized poly(methyl methacrylate) and clicked via copper catalyzed azide-alkyne cycloaddition to yield a hybrid brush-like graft copolymer (Scheme 16). The resulting copolymer was washed 3× in acetone and left to dry overnight.

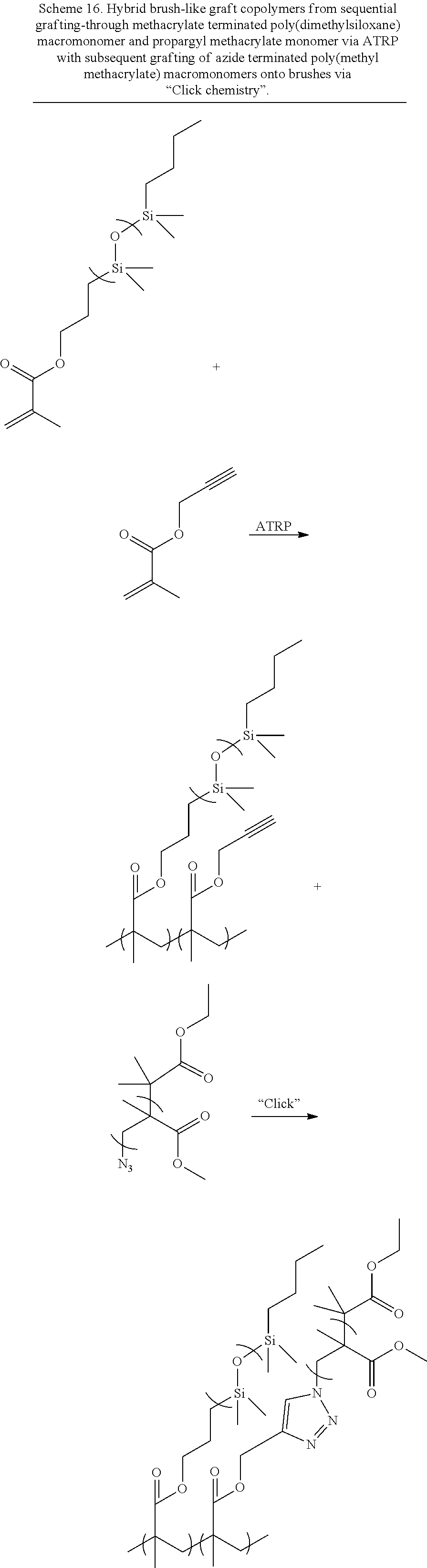

### Example 3. Synthesis of PSAs and HMPSAs

### Materials and Methods:

Materials. Hexanes, tetrahydrofuran (THF), toluene, methanol, and N,N dimethylacrylamide were purchased from Fischer Scientific and used as received. Methyl-vinylidene terminated polyisobutylene (RB HR-PIB) oligomers with average molar mass of 1000, 1300, and 2300 (Ð˜1.9) were obtained from RB products and used as received. N-butyl acrylate (nBA, 99%) was obtained from Sigma Aldrich and purified via basic alumina column to remove inhibitor. In addition, α,ω methacryloxypropyl-terminated poly(dimethylsiloxane) (DMS-R18, average molar mass of 5000 g/mol, Ð=1.15) was obtained from Gelest and purified using basic alumina columns to remove inhibitor. Hydrogen bromide (HBr, 33% in ethyl acetate), tetrabutylammonium bromide (TBAB, 98%), phenylbis(2.4.6-trimethyl-benzoyl) phosphine oxide (BAPO), ethyl α-boromoisobutyrate (EBiB, 98%), ethylene bis(2-bromoisobutyrate) (2-BiB, 97%), methacrylic acid (99%), potassium tert-butoxide (potassium t-butoxide, 98%), tetrabutylammonium bromide (TBAB, 98%), basic alumina, neutral silica, and copper (I) bromide (Cu(I)Br) were obtained from Sigma Aldrich and used as received. Synthesis of potassium methacrylate (KOMA) was reported previously. Linear polyisobutylene (average Mₙ˜600,000 g/mol by GPC) was purchased from Sigma Aldrich and recast in toluene to make a film.

Gel-permeation chromatography (GPC). The molecular weight of the A-g-B brush copolymers synthesized by grafting through free-radical polymerization was determined by GPC using a Tosoh EcoSEC Elite GPC system equipped with a TSKgel Super HM-M (17392) column maintained at 40° C. with an RI detector and Tosoh LENS™ 3 multiangle light scattering detector. Tetrahydrofuran was used as the mobile phase at a flow rate of 0.5 mL/min. The molecular weight and dispersity was reported based on polystyrene standards. Note that molecular weight readings are reported from light scattering detection.

Static and Dynamic Mechanics of Brush elastomer PSA's. Both elastic and viscoelastic mechanical properties (Rouse time) were determined through uniaxial tensile testing. The E₀ of each brush PSA elastomer was determined by fitting the equation of state,

$${σ}_{xx} ( λ ) = \frac{E}{9} ( {λ}^{2} - {λ}^{- 1} ) ( 1 + {2 [ 1 - \frac{β}{3} ( {λ}^{2} + 2 {λ}^{- 1} ) ]}^{- 2} ) \qquad ( S1 )$$

to the experimental stress-strain curve at a strain rate (ε) along the elastic plateau. The output structural modulus, E₀ and β were subsequently used to calculate E₀ from the derivative of Eq. S1 as λ→1,

$${E}_{0} = \frac{E}{3} ( 1 + 2 {( 1 - β )}^{- 2} ) . \qquad ( S2 )$$

Uniaxial tensile testing. Uniaxial tensile testing was preformed using the G2-RSA Dynamic Mechanical Analyzer (TA Instruments) at a strain rate of 0.0001-0.005 s⁻¹ depending on the sample (where elastic plateau began) at 20° C. A dog-bone shaped sample was cut with dimensions of 12 mm×2 mm×1 mm (exact thickness noted typically corresponding to h during probe test). Samples were stretched until catastrophic failure was reached.

Rheological data and the Chang viscoelastic window. An oscillatory frequency sweep at 5% strain in the range of the Chang viscoelastic window (10⁻² Hz-10² Hz) was performed for all samples and distinct trends were observed with independent control of the elastomer structural code (ARES-G2 rheometer, TA instruments). The G′ and G″ at the boundaries of the sweep were plotted at 20° C. and a Chang viscoelastic window was formed for each subset of PBA and PIB brush elastomer PSAs.

Rouse time determination of PIB and PBA brush PSA's. The Youngs modulus of the brush PSAs at small deformations, E₀, decays with time as,

$${E}_{0} \approx \{ \begin{matrix}3 ρ {k}_{b} {T ( \frac{{τ}_{0}}{t} )}^{\frac{1}{2}} , & for & {τ}_{0} < t < {τ}_{R} \\ \frac{3 ρ {k}_{b} T}{N} , & for & t > {τ}_{R}\end{matrix} \qquad ( S3 )$$

supporting time independent relaxation above τ_{R}.³ Utilizing the Boltzmann superposition principle, stress evolution at small deformations during tensile testing of the PSA is

$${σ}_{xx} ( t ) = \dot{ε} {\int }_{0}^{t} {E}_{0} ( Δ t ) d Δ t \qquad ( S4 )$$

at a constant \dot{ε}^{4,5} Stress relaxation for the networks follow stepwise time dependence of rate normalized stress,3

$$\begin{matrix}\frac{{σ}_{xx} ( t )}{\dot{ε}} \approx {E}_{0} {τ}_{R}^{1 / 2} {t}^{1 / 2} \sim {t}^{1 / 2} , & for t < {τ}_{R}\end{matrix} \qquad ( S5 )$$

$$and ,$$

$$\begin{matrix}\frac{{σ}_{xx} ( t )}{\dot{ε}} \approx {E}_{0} t \sim t , & for t > {τ}_{R}\end{matrix} . \qquad ( S6 )$$

Work of adhesion (W_{adh}) measurements. The W_{adh} is measured using a modified version of the probe tack test using a G2-RSA DMA.⁶ The top arm contained a 2 mm diameter probe and the bottom a 25 mm plate with roughness of 0.5 microns (TA instruments). Segments of sample were placed on the bottom compression plate and allowed to wet the surface over time. In addition, a rubber roller was used to apply light pressure to ensure the adhesive bond between the elastomer and bottom plate (acting as carrier) remained intact during measurement. The run consisted of compression at 0.01 mm/s until a contact pressure, P=1 MPa, was attained. The probe was held at a dwell time, t=100 s and removed at 1 mm/s for debonding.

Tensile hanging weight test. The hanging apparatus contained a curved steel loop attached to a level steel plane. A hook attached to a bottom pan was used to hold 10 g weights and the hook was linked to the aforementioned steel bar. A 2 mm sample was prepared by wiping down the surface with acetone, allowing any solvent to evaporate, and forming the adhesive bond by wetting one side of the adhesive to a steel horizontal wall and the other side of the PSA apparatus via the level steel plane. The sample was allowed to wet the surface for 100 seconds under pressure. The apparatus without any weight was inverted so the pan was hanging and being upheld by the adhesive alone. The 10 g weights were added sequentially until failure of the adhesive bond. The Tensile hanging stress was determined at the point of last weight addition.

Fused filament fabrication 3D printing. Fused-filament fabrication 3D printing was performed with a poly[nBA-ran-MMA-g-(PIB/PS)] thermoplastic elastomer sample using a Cellink BioX 3D printer where shape stl. files were created with Tinkercad in the shapes of biomedical adhesives (FIG. 5d). The polymer reservoir was heated to 150° C. to ensure adequate flow and extruded at a pressure of 120 kPa.

Structural verification of brush structure by small-angle X-ray scattering (SAXS). The SAXS measurements were carried out at the ID02 and BM26 beamlines of the European Synchrotron Radiation Facility (ESRF) in Grenoble, France. The experiments at ID02 were conducted in transmission geometry using a photon energy of 12.46 keV. The recorded 2D data were centered, calibrated, regrouped and reduced to 1 D using the SAXS utilities platform described elsewhere. The analysis of the SAXS data was performed using the SANS data reduction and analysis package provided by NIST for the Igor Pro environment (WaveMetrics Ltd.).

The monochromatic incident X-ray beam was collimated on the sample to a footprint of 100×200 μm² (V×H). The total photon flux was estimated to be 9.10¹¹ ph/s allowing for acquisition times of less than 100 ms. The accessed q values, with |q|=4π.sin (θ)/λ, where θ is the Bragg angle and λ—wavelength, cover a range from 7.5×10⁻³ nm⁻¹ to 3.0 nm⁻¹. A Rayonix MX-170HS implemented in a 35 m long vacuum flight tube was applied for recording of SAXS intensities at two different sample-to-detector distances of 1.5 and 10.0 m, respectively. For optimization of the scattering signal, a binning of 2×2 pixels was applied resulting in an effective pixel size of 89 μm in both directions.

SAXS images at BM26 were collected using a Pilatus 1M detector (169 mm×179 mm active area). The experiments were performed in transmission geometry using a photon energy of 12.99 keV and sample-to-detector distance of 2.8 m. Mechanical stretching of the samples was carried out using tensile cell from Linkam (LINKAM TST 350). The data correction, calibration, and integration was performed using the fast azimuthal integration Python library ¹⁰. To compute form factor parameters 1 D SAXS curves were fit to a scattering for a polydisperse population of spheres with uniform scattering length density. The distribution of radii is a Gaussian distribution. The data modelling and analysis were performed using the SANS & USANS data reduction and analysis package provided by NIST6 for Igor Pro 6.7.3.2 environment from WaveMetrics Ltd.

### Synthesis and Characterization

Anti-markovnikov bromination of HR-PIB 1000. A 250 mL round bottom flask was prepared with a stir bar and 50 g (0.05 mmol) RB HR-PIB (Mₙ=1000 g/mol, Ð˜1.9) dissolved in hexane (150 mL) and placed in an ice bath. The solution was bubbled with air for 30 minutes at 0° C. and 24.3 g of 33 w/w % HBr (0.1 mol) in EtOAc was added dropwise to the flask with vigorous stirring. The solution reacted for 2 hrs at 0° C. followed by RT o/n. Stirring was ceased and the resultant anti-Markovnikov bromine functionalized PIB oligomer was washed with H₂O/Na₂CO₃ twice (dried with anhydrous MgSO₄) and extracted with a SiO₂ column. The hexanes were evaporated by bubbling with air yielding 88% functionalized polymer (determined by H¹-NMR). No residual olefin residue was present suggesting higher yield.

Synthesis of PIB (n_{sc}=18) macromonomer. The functionalized oligomer was dissolved in THF (100 mL) and transferred to a clean 250 mL round bottom flask equipped with a stir bar. The solution was charged with 18.6 g KOMA (0.15 mol) and 48.3 g TBAB (0.15 mol) and ran 24 hrs at 45° C. The solution was centrifuged to remove residual salt and unreacted reagent. Subsequently, the solution was condensed by bubbling with air and washed with H₂O/hexane twice. The organic layer was separated and ran through a SiO₂ column revealing PIB (n_{sc}=18) macromonomer product (96% yield). Again, no residual peaks were present from the α-hydrogens suggesting higher yield. ¹H-NMR of the synthetic progression was determined. This synthesis applies to RB HR PIB-1300 (n_{sc}=23) and RB HR PIB-2300 (n_{sc}=41) with molar ratios respectively applied.

Synthesis of butyl acrylate by SARA ATRP. Poly(n-butyl acrylate) with different degree of polymerization were synthesized by supplemental activation reducing agent (SARA) atom transfer radical polymerization (ATRP) followed by a post polymerization functionalization displacing the bromine end group with potassium methacrylate. To a 500 mL air free Schlenk flask 120 g (0.94 mol) of butyl acrylate was combined with Me₆TREN (10 μL, 37 μmol), CuBr₂ (8 mg, 36 μmol), and EBiB, 15.2, 7.3, or 3.7 g (0.078, 0.037, or 0.019 mol) depending on desired n_{sc}, and diluted with an equal volume of acetonitrile. The reaction mixture was then cooled with an ice bath and oxygen was removed by bubbling nitrogen gas for 1 hour. The polymerization was initiated by adding a stir bar equipped with a clean Cu⁰ wire and transferring to 45 C mineral oil bath. The reaction was monitored by 1H NMR and stopped near 80% conversion with the addition of chloroform. Excess catalyst was removed by washing in water ˜11 times and excess solvent was removed by rotary evaporation at 45 C under reduced pressure.

Synthesis of poly(n-butyl acrylate) macromonomers. The previously synthesized poly(n-butyl acrylate) was dissolved in 7 parts N,N-dimethylacetamide. Potassium methacrylate was added in large excess (>3 molar equivalents) and the reaction was left to stir for 3 days and turning a faint yellow color. To purify, the mixture was 1 part chloroform and 1 part water were added separating the mixture into two separate phases. The aqueous phase was discarded and the remaining organic component was an addition 11 times with water until clear. Solvent was removed by rotary evaporation.

Synthesis of poly(n-butyl acrylate) macro-crosslinker by SARA ATRP. Poly(n-butyl acrylate) macro-crosslinkers were synthesized using an equivalent procedure to the poly(n-butyl acrylate) macromonomers. The one exception is that a difunctional 2-BiB ATRP initiator was used to polymerize n-BA such that the corresponding macromonomer was functionalized at both ends of the polymer chain. This difunctional poly(butyl acrylate) macro-crosslinker was also synthesized on a much smaller scale due to relatively small amount of it used during synthesis. The n_{sc}=80 crosslinker was synthesized by combining 24 g (0.19 mol) of butyl acrylate, Me₆ TREN (2 μL, 7.4 μmol), CuBr₂ (1.6 mg, 7.2 μmol), and 2-BiB (0.67 g, 1.9 μmol) and diluting the mixture to 50% with acetonitrile. The reaction was then cooled in an ice bath and degassed for 1 hour with bubbling nitrogen gas. The polymerization was initiated by the addition of a Cu⁰ wire and transferred to a 45° C. oil bath until the reaction reached ˜80% conversion. The reaction was then terminated by the addition of 50 mL of chloroform and washed 11 times in water. Solvent was removed by rotary evaporation at 45° C. under reduced pressure. The cleaned polymer was then functionalized by the addition of 7 parts N,N-dimethylacetamide and a large excess of potassium methacrylate and left stirring for 72 hours.

50 mL of chloroform and 100 mL of water were then added separating the polymer into the organic phase. The organic phase was then washed in water 11 times until it became clear. Solvent was again removed by rotary evaporation at 45° C. under reduced pressure.

Synthesis of PIB brush elastomer PSAs (Scheme 1). A scintillation vial was charged with 5 g of PIB (n_{sc}=18) macromonomer (5 mmol), THF (5 mL), and R18 according to nₓ (ex. for n_{g}=1, nₓ=100, R18=0.125 g). The vial was covered in aluminum foil and placed in an ice bath to prevent auto-initiation of R18. Furthermore, 7.0 mg (0.14 mol %) of BAPO was added to the vial. The vial was rapidly fixed with a rubber septum and was bubbled with nitrogen for 30 min. The deoxygenized solution was injected into a nitrogen flushed, hand-made glass mold and set to cure in a nitrogen chamber o/n (18-24 hrs). The polymers were removed from the mold, swollen in THF twice to remove unreacted macromonomer (gel fraction >90%). The PIB bottlebrush elastomers was dried o/n in fume hood followed by 2 hrs in in the oven at 60° C.

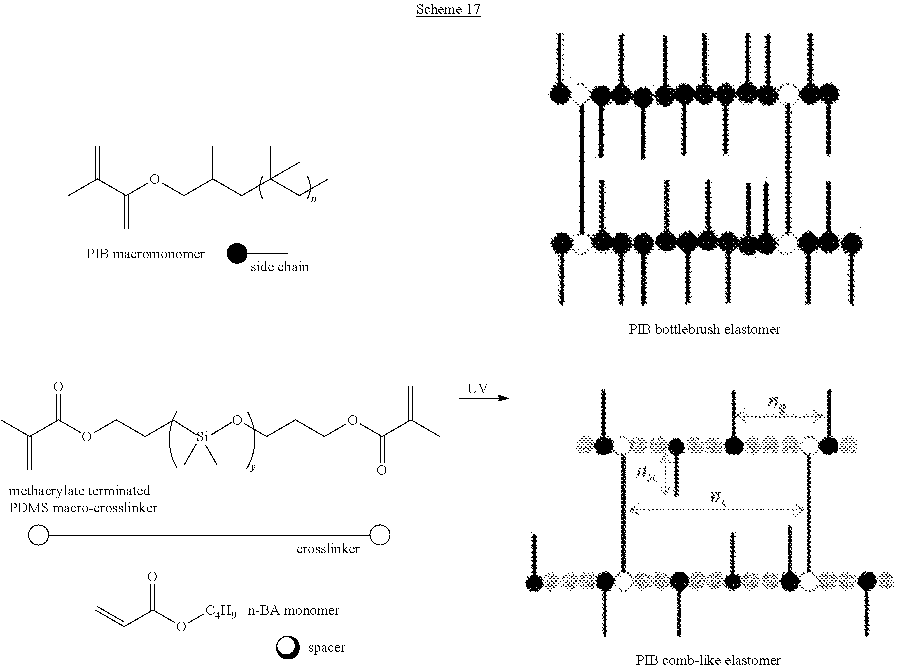

Synthesis of bottlebrush poly(n-butyl acrylate) elastomers (Scheme 18). Bottlebrush poly(n-butyl acrylate) elastomers were synthesized by combining macromonomer (4 g), macro-crosslinker (1, 0.5, and 0.25 mol %), and BAPO (1.5 wt. %) were diluted to 50% in anisole. Nitrogen gas was used to purged with oxygen for 1 hour and then the mixture was injected into 1.3 mm thick elastomer molds and left to polymerize overnight in nitrogen atmosphere. The corresponding film was separated from its mold and a small portion was set aside to measure the samples corresponding gel fraction. The larger bulk part of the film was washed 3 times in toluene and dried prior to measurement. Gel fractions were for the most part at or above 90%. Gel fractions were measured by washing small sections of unwashed films in toluene 3 times over the course of 72 hours. The mass post washing divided by the mass of the gel fraction after washing was taken to be the gel fraction.

Synthesis of poly(butyl acrylate) comb elastomers (Scheme 18). Poly(butyl acrylate) comb elastomers were synthesized by combining macromonomer, crosslinker (1, 0.5, and 0.25 mol %), BAPO (5-10 mg), and n-BA as spacer. The mixture was purged of oxygen using bubbling nitrogen gas and injected into a 1.3 mm molds and left to polymerize under ambient light conditions under a nitrogen atmosphere. As a specific example, for an [11,10,100] sample, [n_{sc}, n_{g}, nₓ] 4 g of n_{sc}=11 macromonomer, 3 g n-BA spacer (9 molar equivalents), 0.0339 g (0.05 molar equivalents), and 5 mg of BAPO were used. A small portion of the film was removed to measure the gel fraction and the bulk part of the elastomer was washed 3 times in toluene and dried prior to sample measurement.

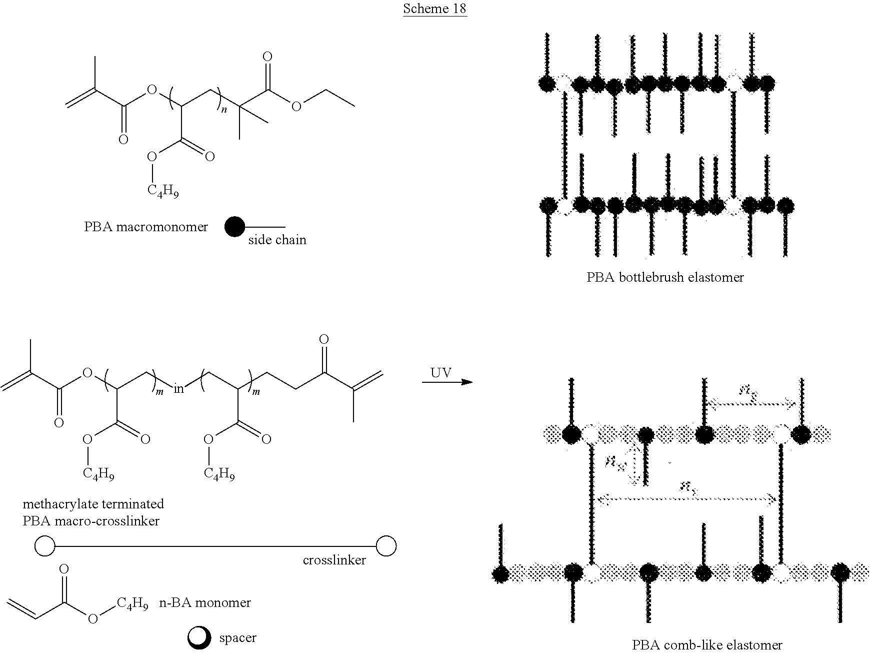

A-g-B brush copolymers (HMPSAs)

Synthesis of PS oligomers. ATRP of polystyrene homopolymer was performed with a target NA=60 at 34% conversion to avoid large viscosities at higher conversion. Styrene (100 g, 0.96 mol), HEBIB (1.16 g, 5.5 mmol), PMDETA (0.095 g, 0.114 mL, 0.55 mmol), and a stir bar were added to a Schlenk flask. The solution was bubbled with dry nitrogen for 1 hour then Cu(I)Br (0.079 g, 0.55 mmol) was quickly added to the reaction mixture under nitrogen atmosphere. The flask was sealed, purged for an additional 15 minutes, and then immersed in an oil bath at 90° C. The reaction mixture was left to polymerize for 14 hrs to receive a 34% conversion (n_{sc}=60) and the reaction was quenched by exposing the mixture to oxygen. The mixture was centrifuged and gravity filtered to remove residual Cu-ligand complex. Residual styrene monomer was evaporated and the remaining PS oligomer was dissolved in minimal THF and crashed in excess methanol (1:10, THF: Methanol by volume) 3 times. The washed PS oligomer was dried overnight at room temperature under reduced pressure to remove any residual solvent. The PS oligomer (30 g, 4.8 mmol, DP=60) was transferred to a round bottom flask sealed by rubber septum and parafilm and dissolved in 60 ml of THF. Once the PS was fully dissolved, 0.05 g (47 μL, 80 μmol) dibutyltin dilaurate was added to the solution, it was subsequently purged of oxygen by bubbling the solution with nitrogen for 10 minutes. IEM (0.82 g, 0.75 mL, 5.3 mmol) was added dropwise to the round bottom flask under constant stirring. Nitrogen was removed from the flask, and the solution was set to stir for 18 hr. The subsequent solution was further diluted with THF (5-10×) and passed through silica column twice. The purified mixture was dried under reduced pressure and characterized by ¹H-NMR. H¹-NMR reveals 80% conversion so subsequent calculations for ϕ_{A} for performed considering an 80% ratio of macromonomers.

FR polymerization of A-g-B brush copolymers by grafting through. A Schlenk flask was charged with appropriate molar quantities of side-chain macromonomer (PDMS, PIB), spacer (n-BA), A-block macromonomer (PS), 1:1 volume of p-xylene, and 0.15 mol % initiator (BAPO). The flask was shielded from light and purged with nitrogen for 30 minutes. Subsequently, the solution was removed from nitrogen and allowed to polymerize under UV-light for 18 hr. The solution exhibits a light-yellow color upon introduction to the UV-light but returns to transparent after polymerization. The unwashed polymer solution was caste in a Teflon mold at 60° C. and dried overnight. The resultant polymer was washed according to chemistry. poly[nBA-ran-MMA-g-(PIB/PS)]: the unwashed polymer was dissolved in THF and crashed with acetonitrile (1:1.2, THF: acetonitrile) 3 times. The washed polymer was dissolved in p-xylene once more and caste into a Teflon petri-dishes (Welch Fluorocarbon) at 60° C. and dried overnight to be characterized by ¹H-NMR where no macromonomer peaks remained. Note that unreacted reagents act as diluent and decrease the modulus of the network. Comparing washed and unwashed A-g-B network stress-strain curves exhibit this behavior. The number average molecular weight (Mₙ) of the A-g-B brush polymer stand was determined by light scattering detection during gel-permeation chromatography.

Ex. synthetic calculations. poly[nBA-ran-MMA-g-(PIB/PS)]. Sample: 030722_2. 2.00 g n-butyl acrylate (15.6 mmol), 2.23 g PIB macromonomer (2.23 mmol), 0.46 g PS macromonomer (16.5 μmol, 80% conversion PS mixture, total mass 0.56 g), 7 mg BAPO (17 μmol, 0.15 w/w %), and 4.5 mL of p-xylene.

For polymerization of poly[nBA-ran-MMA-g-(PIB/PS)] brush graft copolymers, see scheme 1-5.

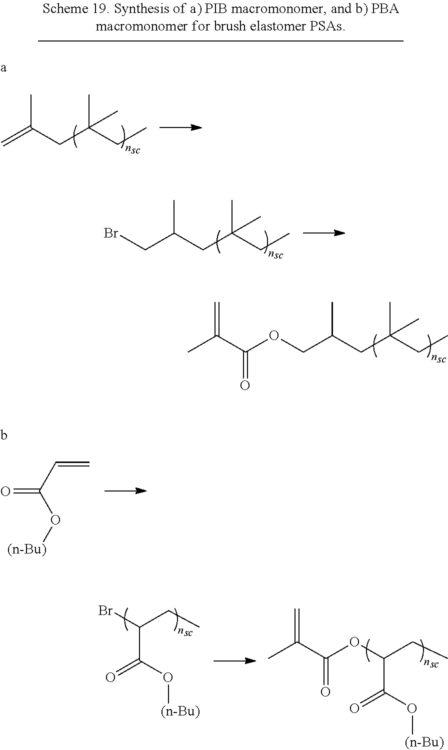

TABLE 2-A
Inter-brush distance for PIB bottlebrush and comb elastomers.

| | |
|---|---|
| [n_{sc}, n_{g}, nₓ]¹⁾ | d₁(nm) ²⁾ |

PIB Brush PSAs

| | |
|---|---|
| [18, 1, 100] | 3.85 |
| [18, 4, 100] | 4.50 |
| [18, 8, 100] | 6.71 |

¹⁾Brush architectural code.
²⁾ Inter-brush distance.

TABLE 2-B
Mechanical properties and Rouse time of brush elastomer PSAs.

| | | | | |
|---|---|---|---|---|
| [n_{sc}, n_{g}, nₓ]¹⁾ | E₀(kPa) ²⁾ | β ³⁾ | τ_{R} (s) ⁴⁾ | regime⁵⁾ |

PIB Brush PSAs

| | | | | |
|---|---|---|---|---|
| [18, 1, 100] | 13.4 | 0.151 | 31.0 | brush |
| [18, 1, 150] | 6.75 | 0.089 | 77.5 | brush |
| [18, 1, 200] | 4.42 | 0.068 | 125 | brush |
| [18, 1, 300] | 3.32 | 0.046 | 510 | brush |
| [18, 2, 100] | 13.5 | 0.100 | 7.40 | brush |
| [18, 4, 100] | 29.6 | 0.088 | 3.50 | brush |
| [18, 8, 100] | 77.6 | 0.065 | 0.60 | comb |
| [18, 16, 100] | 136 | 0.058 | 0.30 | comb |
| [23, 8, 100] | 69.3 | 0.077 | 0.82 | comb |
| [41, 8, 100] | 59.3 | 0.085 | 2.41 | comb |

PBA Brush PSAs

| | | | | |
|---|---|---|---|---|
| [11, 1, 50] | 42.6 | 0.212 | 0.90 | brush |
| [11, 1, 100] | 21.1 | 0.157 | 2.30 | brush |
| [11, 1, 200] | 8.47 | 0.098 | 15.2 | brush |
| [11, 2, 200] | 18.1 | 0.072 | 2.90 | brush |
| [11, 3, 200] | 31.6 | 0.067 | 1.40 | brush |
| [11, 10, 200] | 58.8 | 0.025 | 0.25 | comb |
| [11, 2, 100] | 37.6 | 0.132 | 0.85 | brush |
| [23, 2, 100] | 20.3 | 0.136 | 1.50 | brush |
| [41, 2, 100] | 6.69 | 0.142 | 3.21 | brush |

¹⁾Structural code of brush elastomers defined by the DP of side chains (n_{sc}), backbone spacers between side chains (n_{g}), and the backbone between crosslinks (nₓ).
²⁾ Apparent Young's modulus (Eq. S2).
³⁾ Strain stiffening parameter determined from fitting Eq. S1.
⁴⁾ Rouse time determined from uniaxial tensile tests at various strain rates within \dot{ε} = 10⁻⁴ − 10¹ s⁻¹ (FIGS. 38-40).
⁵⁾ Bottlebrush (brush) and comb regimes identified depending on side chain length and grafting density.

TABLE 2-C
Mechanical properties of A-g-B brush copolymer PSAs.

| Sample | n_{g}¹⁾ | n_{sc} | nₓ²⁾ | n_{A}³⁾ | ϕ_{A}⁴⁾ | n_{bb}⁵⁾ | E⁶⁾ (kPa) | β⁷⁾ | ${E}_{0}^{8 )} ( kPa )$ | λ_{fit}⁹⁾ | λₘₐₓ¹⁰⁾ | σₘₐₓ¹¹⁾ (kPa) |
|---|---|---|---|---|---|---|---|---|---|---|---|---|
| 030722_2 | 8 | 18 | 216 | 60 | 0.108 | 1319 | 170 | 0.197 | 232 | 2.32 | 4.67 | 3520 |
| 070622_1 | 8 | 18 | 332 | 60 | 0.070 | 1237 | 97.2 | 0.174 | 127 | 2.80 | 3.88 | 1540 |

¹⁾Grafting density of side chains on the backbone with BA spacer.
²⁾Number average degree polymerization of brush backbone between glassy block side chains that physical crosslink.
³⁾Number average degree polymerization of each glassy block side chain as determined by ¹H-NMR.
⁴⁾Volume fraction glassy block, ρ_{PIB} = 0.92 g/mL, ρ_{PS} = 1.02 g/mL, ρPBA = 1.08 g /mL.
⁵⁾Number average degree polymerization of the total brush strand.
⁶⁾Structural modulus E ~ 1/(n_{bb}(n_{sc} + 1)) and
${}^{7 )} strain ‐ stiffening parameter β = 〈 {R}_{i n}^{2} 〉 / {R}_{max}^{2} are fitting parameters in equation S 1.$ ⁸⁾Apparent Young’s modulus determined either as tangent of a stress-strain curve at λ → 1 or from the fitting equation S2.
⁹⁾Elongation range used for fitting equation S1 before deviation from the theory.
¹⁰⁾Maximum true stress and elongation at sample rupture.
¹¹⁾Maximum stress-at-break (strength) of A-g-B brush copolymer samples.

TABLE 2-D
Precision of modified probe tack test with strain rate. Error was
determined by standard deviation of triplicate measurements.

| | \dot{ε}⁽¹⁾ | W_{adh} ⁽²⁾ | |
|---|---|---|---|
| Sample | (s⁻¹) | (J/m²) | % Error⁽³⁾ |
| PBA | 10 | 1165 ± 38.9 | 3.3 |
| [11, 1, 200] | 1.0 | 537 ± 10.3 | 2.9 |
| | 0.1 | 151 ± 5.77 | 3.8 |
| | 0.01 | 37.0 ± 0.38 | 1.0 |
| | 0.001 | 11.3 ± 0.26 | 3.5 |

⁽¹⁾Strain rate of debonding during the probe tack test.
⁽²⁾ Overall average work of adhesion for a desired debonding rate with relative uncertainty of a triplet of trials determined by standard deviation.
⁽³⁾Representative present error for a given strain rate in determining W_{adh}. The percent error within the debonding strain rate range of 0.001-10 s⁻¹ remains <4% for the modified probe tack test used for all samples.

TABLE 2-E
Work of adhesion and strain rate dependence of PIB brush PSAs.

| | v | ε | W_{adh} |
|---|---|---|---|
| Sample | (mm/s) ⁽¹⁾ | (s⁻¹) ⁽²⁾ | (J/m²) ⁽³⁾ |
| [18, 1, 100] | 10⁰ | 1.053 | 638.0 |
| | 10⁻¹ | 0.105 | 282.3 |
| | 10⁻² | 0.011 | 49.8 |
| | 10⁻³ | 0.001 | 14.5 |
| [18, 1, 150] | 10¹ | 15.873 | 1035.1 |
| | 10⁰ | 1.587 | 450.5 |
| | 10⁻¹ | 0.200 | 162.9 |
| | 10⁻² | 0.020 | 51.7 |
| [18, 1, 200] | 10¹ | 16.7 | 857 |
| | 10⁰ | 1.67 | 432 |
| | 10⁻¹ | 0.167 | 43.2 |
| | 10⁻² | 0.017 | 13.2 |
| [18, 1, 300] | 10⁰ | 1.124 | 609.5 |
| | 10⁻¹ | 0.112 | 242.3 |
| | 10⁻² | 0.011 | 72.9 |
| | 10⁻³ | 0.001 | 18.6 |
| [18, 2, 100] | 10¹ | 10.417 | 706.3 |
| | 10⁰ | 1.250 | 452.9 |
| | 10⁻¹ | 0.125 | 175.8 |
| | 10⁻² | 0.013 | 53.0 |
| [18, 4, 100] | 10¹ | 8.333 | 1250.4 |
| | 10⁰ | 0.833 | 545.0 |
| | 10⁻¹ | 0.083 | 135.0 |
| | 10⁻² | 0.008 | 23.7 |
| [18, 8, 100] | 10¹ | 8.333 | 914.2 |
| | 10⁰ | 0.833 | 330.2 |
| | 10⁻¹ | 0.083 | 66.1 |
| | 10⁻² | 0.008 | 14.6 |
| [18, 16, 100] | 10⁰ | 0.870 | 242 |
| | 10⁻¹ | 0.087 | 50.7 |
| | 10⁻² | 0.009 | 5.6 |
| | 10⁻³ | 0.001 | 0.7 |
| [23, 8, 100] | 10¹ | 11.111 | 605.0 |
| | 10⁰ | 1.111 | 218.3 |
| | 10⁻¹ | 0.111 | 54.9 |
| | 10⁻² | 0.011 | 11.0 |
| [41, 8, 100] | 10⁰ | 0.769 | 1075.1 |
| | 10⁻¹ | 0.077 | 527.8 |
| | 10⁻² | 0.008 | 210.1 |
| | 10⁻³ | 0.001 | 58.0 |

⁽¹⁾ Linear velocity of debonding during the probe tack test of PIB brush elastomer PSAs.
⁽²⁾ Thickness normalized strain rate of debonding.
⁽³⁾ The overall work of adhesion determined from Eq. 2.

TABLE 2-F
Work of adhesion and strain rate dependence of PBA brush PSAs.

| | v | \dot{ε} | W_{adh} |
|---|---|---|---|
| Sample | (mm/s)⁽¹⁾ | (s⁻¹) ⁽²⁾ | (J/m²) ⁽³⁾ |
| [11, 1, 50] | 10⁰ | 0.867 | 207.7 |
| | 10⁻¹ | 0.087 | 34.6 |
| | 10⁻² | 0.009 | 7.5 |
| | 10⁻³ | 0.001 | 1.9 |
| [11, 1, 100] | 10⁰ | 0.909 | 377.5 |
| | 10⁻¹ | 0.091 | 76.5 |
| | 10⁻² | 0.009 | 16.9 |
| | 10⁻³ | 0.001 | 3.6 |
| [11, 1, 200] | 10⁰ | 1.000 | 527.3 |
| | 10⁻¹ | 0.100 | 148.4 |
| | 10⁻² | 0.010 | 37.4 |
| | 10⁻³ | 0.001 | 11.3 |
| [11, 2, 200] | 10⁰ | 0.862 | 416.1 |
| | 10⁻¹ | 0.086 | 86.0 |
| | 10⁻² | 0.009 | 16.4 |
| | 10⁻³ | 0.001 | 5.7 |
| [11, 3, 200] | 10⁰ | 0.833 | 286.4 |
| | 10⁻¹ | 0.083 | 63.5 |
| | 10⁻² | 0.008 | 11.9 |
| | 10⁻³ | 0.001 | 2.4 |
| [11, 10, 200] | 10⁰ | 0.833 | 160 |
| | 10⁻¹ | 0.083 | 36.5 |
| | 10⁻² | 0.008 | 14.6 |
| | 10⁻³ | 0.0001 | 2.3 |
| [11, 2, 100] | 10⁰ | 0.800 | 186.7 |
| | 10⁻¹ | 0.080 | 30.4 |
| | 10⁻² | 0.008 | 6.2 |
| | 10⁻³ | 0.001 | 1.7 |
| [23, 2, 100] | 10⁰ | 0.833 | 1208 |
| | 10⁻¹ | 0.083 | 34.5 |
| | 10⁻² | 0.008 | 8.5 |
| | 10⁻³ | 0.001 | 1.7 |
| [41, 2, 100] | 10⁰ | 1.052 | 296.3 |
| | 10⁻¹ | 0.105 | 61.3 |
| | 10⁻² | 0.011 | 13.2 |
| | 10⁻³ | 0.001 | 2.9 |

⁽¹⁾Linear velocity of debonding during the probe tack test of PBA brush elastomer PSAs.
⁽²⁾ Thickness normalized strain rate of debonding.
⁽³⁾ The overall work of adhesion determined from Eq. 2.

### Example 4. Synthesis of Brush HMPSAs

A comprehensive library of A-g-B bottlebrush graft copolymers (FIG. 28d) with parameters ranging from n_{sc}=18-41, n_{g}=1-8, n_{A}=60-504, ϕ_{A}=0.025-0.212, nₓ =135-906, and n_{bb} =400-2000 was synthesized to demonstrate the scope of architectural control over structural, thermodynamic, and viscoelastic properties (Table B1). Different polymerization techniques were used to prepare A-g-B brush graft copolymers depending on the grafting density of the brush block (Scheme 20). Sequential reversible addition-fragmentation chain-transfer (RAFT) and atom transfer radical polymerization (ATRP) were utilized to synthesize densely grafted poly[M_{A}-g-(PIB/PS)], hereto denoted as PS-g-PIB (n_{g}=1), where incorporation of styrene monomers aided solubility of brush blocks (Scheme 20a). For less dense backbones, one-step free-radical polymerization (FRP) of macromonomers was utilized to synthesize poly[nBA-ran-M_{A}-g-(PIB/PS)], hereto referred to as PS-g-PIB (n_{g}>1) (Scheme 20b). The architectural parameters of these A-g-B brush graft copolymer networks n_{sc}, n_{g}, n_{A}, ϕ_{A}, nₓ, and n_{bb} where determined by combination of 1H NMR and GPC. Consumption of spacer and macromonomers was investigated by 1H NMR and subsequent analysis provided information on their distribution throughout the A-g-B brush graft copolymer backbone. PIB macromonomer appears to propagate faster than BA spacer resulting in gradient distribution. At 30% conversion, the average cumulative n_{g}=4 was measured and gradually converged to the target n_{g}=8 at higher conversions.

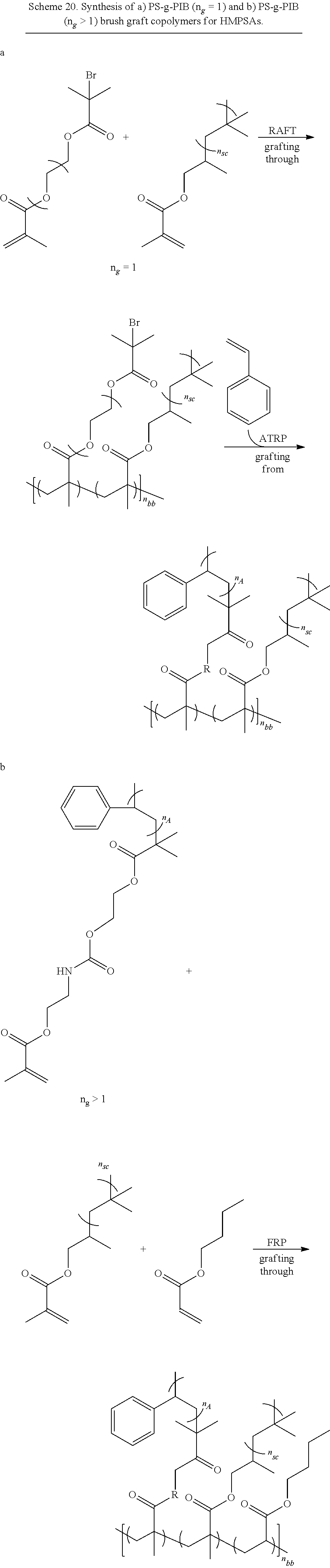

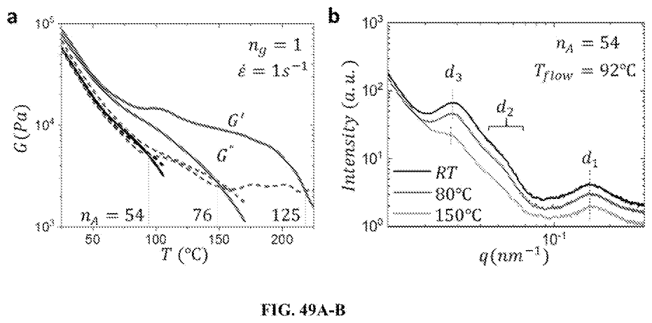

Structural and thermal analysis. The synthesized bottlebrush graft copolymers undergo microphase separation of the linear PS and brush PIB blocks to form a robust physical network with PS domains acting as physical crosslinks. Atomic force microscopy (AFM) and small angle X-ray scattering (SAXS) were performed to investigate the effect of different architectural parameters on network morphology. AFM imaging of A-g-B's with identical n_{sc} =18, n_{g}=1, nₓ=180, and n_{bb}=2000 corroborated microphase separation, where the domain size increases 29.6±3.5 nm to 59.3±5.9 nm with the DP of PS from n_{A}=96 to n_{A}=504, respectively (FIG. 48a). Since AFM measurements are generally affected by various surface effects and convolution of the AFM tip shape, SAXS was employed to acquire more accurate information about network morphology including the inter-brush distance (d₁), A-domain diameter (d₂), and interdomain distance (d₃) (FIG. 48b, Table B2). While d₁ remains constant (as expected for the same B-block), the domain diameter increases with n_{A}, showing a good agreement with the theoretical dependence d₂≅(n_{bb} NAVA)^{1/3} for microphase separated brush networks (FIG. 48c).36 The deviation at low n_{A}=96 is ascribed to kinetically hindered association of short A blocks due to steric repulsion of B-block side chains. The corresponding increase of the interdomain distance (distance between A-domain centers) is largely due to the d₂ contribution, while the distance between the domain interfaces d₃-d₂ is nearly identical for samples with the same nₓ (Table B2). Along with the n_{A} effect, variations in n_{sc}, n_{g}, and nₓ, provide additional architectural levers to vary inter-brush distance and inter-domain distance.

TABLE B2
Microphase separated morphology of A-g-B bottlebrush
graft copolymers (n_{sc} = 18, n_{g} = 1, nₓ =
180, and n_{bb} = 2000) from SAXS.

| | | d₁¹⁾ | d₂¹⁾ | d₃¹⁾ | | d₃ − d₂ |
|---|---|---|---|---|---|---|
| n_{A} | ϕ_{A} | (nm) | (nm) | (nm) | RSD₂²⁾ | (nm) |
| 96 | 0.053 | 4.1 | 16.2 | 29.0 | 0.18 | 12.8 |
| 278 | 0.121 | 4.0 | 29.8 | 44.8 | 0.18 | 15.0 |
| 414 | 0.166 | 3.9 | 34.1 | 47.6 | 0.14 | 13.5 |
| 504 | 0.202 | 4.0 | 37.1 | 48.3 | 0.12 | 11.2 |

¹⁾The inter-brush distance (d₁), A-domain diameter (d₂), and interdomain distance (d₃) (FIG. 48c).
²⁾Relative standard deviation of the domain diameter.

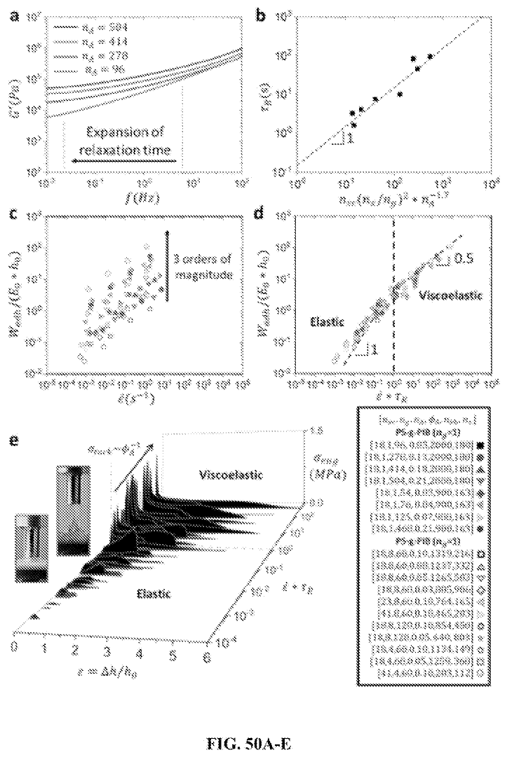

A primary trait of HMPSAs is the ability to flow at moderate temperatures to reduce risk of polymer degradation ˜300° C. during processing and fabrication. The onset of flow (T_{flow}) is identified as the temperature where loss modulus (G″) surpasses the storage modulus (G′) of the material during oscillatory shear measurements. The effect of A-g-B bottlebrush graft copolymer architecture on T_{flow} is exemplified by two series of PS-g-PIB samples with systematically varied volume fractions of the PS A-block (PA). In the first series PS-g-PIB (n_{g}=1), ϕ_{A} was varied from 0.03 to 0.07 by increasing n from 54 to 125 at constant dimensions of the B-block (n_{sc}=18, nₓ=163), which led to a T_{flow} increase within T_{flow}=91-218° C. (FIG. 49a). Disassembly of physical crosslinks at the onset of flow was corroborated by SAXS measurements during heating (FIG. 49b). In the second series PS-g-PIB (n_{g}=8), ϕ_{A} was varied from 0.03 to 0.10 by decreasing nₓ from 906 to 216 at a constant n_{A}=60, to show a relatively low T_{flow} increasing from 56-114° C., respectively. The observed T_{flow} increase is consistent with the increase in ϕ_{A} and total DP of A-g-B macromolecules N, which is corroborated in literature for linear block copolymers. However, linear and brush HMPSAs differ in the effect of n_{A} on mechanical properties. For example, increasing n_{A} at a constant nₓ for linear SIS copolymers entails a corresponding shift in ϕ_{A} so reaching large n_{A} results in a stiff material with high T_{flow}. Brush HMPSAs, however, high n_{A} values can be reached at low ϕ_{A} by increasing the volume fraction of the brush block though the n_{sc} (with side chains) at a constant nₓ to maintain low T_{flow} for molding.

TABLE B3
Flow temperature of A-g-B brush-like graft copolymers with
different architectures

| | | | | | | | |
|---|---|---|---|---|---|---|---|
| n_{g}¹⁾ | n_{sc}¹⁾ | nₓ¹⁾ | n_{A}¹⁾ | ϕ_{A}¹⁾ | n_{bb}¹⁾ | $N = {{n}_{bb} ( 1 + \frac{{n}_{A}}{{n}_{x}} )}^{2 )}$ | T_{flow}³⁾ (° C.) |

Bottlebrush (n_{g} = 1)

| | | | | | | | |
|---|---|---|---|---|---|---|---|
| 1 | 18 | 163 | 54 | 0.03 | 900 | 1198 | 92 |
| 1 | 18 | 163 | 72 | 0.04 | 900 | 1298 | 147 |
| 1 | 18 | 163 | 125 | 0.07 | 900 | 1590 | 218 |

Comb (n_{g} = 8)

| | | | | | | | |
|---|---|---|---|---|---|---|---|
| 8 | 18 | 906 | 60 | 0.03 | 805 | 858 | 56 |
| 8 | 18 | 503 | 60 | 0.05 | 1265 | 1416 | 95 |
| 8 | 18 | 332 | 60 | 0.08 | 1237 | 1461 | 112 |
| 8 | 18 | 216 | 60 | 0.10 | 1319 | 1685 | 114 |

¹⁾Architectural parameters as outlined in Table 1.
²⁾Total degree of polymerization of the A-g-B scaffold.
³⁾Flow temperature identified as the temperature where loss modulus (G″) surpasses the storage modulus (G′) of the material during oscillatory shear measurements.

### Example 5. Control of Adhesive Performance Through Viscoelastic Response

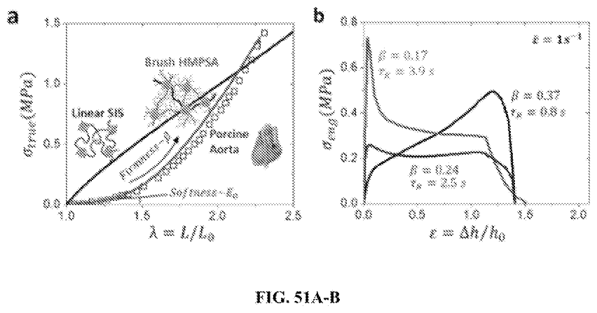

In consideration of the effect of the brush motif [n_{sc}, n_{g}, nₓ] on viscoelasticity for covalent bottlebrush networks, where an increase in n_{sc}/n_{g} and nₓ led to systematic shifts in the Rouse time denoted as the transition from time-independent to time-dependent mechanical properties, this experiment considers the effect of the A-block. Brush HMPSA systems have both n_{A} and ϕ_{A} as additional levers for tuning viscoelasticity. Frequency sweeps within the PSA frequency range for samples with n_{A} from 504 to 96 exhibit a decrease in G′ with expansion of the Rouse relaxation regime before the onset of the elastic plateau (FIG. 50a). The Rouse times of all samples were experimentally determined by uniaxial testing at various strain rates (10⁻⁴-10¹ s⁻¹). Correlations were derived by isolating the effect of n_{A} (and ϕ_{A}) on the estimated Rouse time normalized by known architectural contributions from n_{sc}, n_{g}, and nₓ (FIG. 50b. Relaxation dependence on n_{A} is revealed as,

$${τ}_{R} = {τ}_{0} {{n}_{sc} ( \frac{{n}_{x}}{{n}_{g}} )}^{2} * {n}_{A}^{- 1.7} \qquad ( 1 )$$

for PS-g-PIB (n_{g}=1). The observed

$${n}_{A}^{- 1.7}$$

power law is purely empirical and has no theoretical justification, which is encumbered by chemical heterogeneity of A-g-B networks.

The ability to tune the HMPSA viscoelasticity by regulating polymer architecture enables further programming of the work of adhesion and debonding mechanisms. The work of adhesion (W_{adh}) of the brush HMPSAs was measured by probe tack testing at strain rates (\dot{ε}) from approximately 0.001-1 s⁻¹ and further normalized by film thickness and elastic modulus (FIG. 50a). It is important to recognize that W_{adh} spans three orders of magnitude without using additives for the range of parameters in this study. By offsetting the strain rate by the experimentally determined τ_{R} of each prospective sample, all data points fall on a single line (FIG. 50b). The brush HMPSA samples experience an apparent shift in scaling for the W_{adh} and debonding mechanisms at

$$\dot{ε} ≅ {τ}_{R}^{- 1} .$$

The normalized work or adhesion scales as W_{adh}/E₀˜\dot{ε}τ_{R} while debonding at a rate below the Rouse rate

$$( {τ}_{R}^{- 1} )$$

which is dictated by cavity crack propagation along the surface of the substrate. Debonding above the Rouse rate is governed by cavity growth into the bulk followed by fibrillation which scales as W_{adh}/E₀˜(\dot{ε}τ_{R})^{1/2}. This is summarized in a plot of overlaid probe tack tests where the change in debonding mechanisms is observed at

$$\dot{ε} ≅ {τ}_{R}^{- 1}$$

(FIG. 50c). Viscoelastic debonding above

$${τ}_{R}^{- 1}$$

exhibits the characteristic tack peak (σₘₐₓ) at small deformations as a result of the transition from bulk deformation to nucleation of cavities. By utilizing the correlation between architecture and relaxation dynamics, adhesive performance can be programmed from elastic to viscoelastic deformation in the absence of additives.

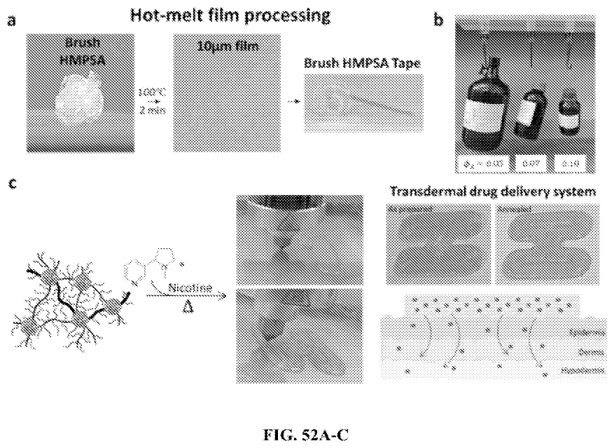

A unique feature of A-g-B brush architecture is the ability to regulate the deformation response at both small and large deformations. At small deformations specifically, we can tune modulus and Rouse time to cover a broad range work of adhesion spanning elastic to viscoelastic regimes (FIG. 50d). At larger deformations, A-g-B's demonstrate an intense strain-stiffening behavior where the initially soft sample stiffens rapidly with deformation, which mimics that of biological tissues and prevents cohesive rupture of adhesives (FIGS. S27-30). For example, the sample with n_{sc}=18, n_{g}=1, n_{A}=504, nₓ=180, n_{bb} =2000 exhibits the characteristic J-shaped curve almost identical to Aortic tissue while maintaining σ_{tack} above 1 MPa and W_{adh}˜100 J/m² (FIG. 51a). Brush HMPSAs are capable of tuning modulus, Rouse time, and strain-stiffening independent of one another, which allows generating very unusual (distinct) debonding profiles. For example, we compare samples with different combinations of Rouse time and strain-stiffening parameter that are pulled off at a near identical debonding rate of \dot{ε}˜1 s⁻¹ (FIG. 51b). The sample with τ_{R}=4.0 s undergoes the typical viscoelastic debonding (τ_{R}\dot{ε}>1) exhibited by a pronounced tack peak followed by an extended yielding plateau, which decays with deformation due to low strain-stiffening (β=0.17). In contrast, the sample with τ_{R}=0.8 de-bonds elastically (τ_{R}\dot{ε}<1) with no tack peak yet a strong increase in pull-off stress with deformation due to more intense strain-stiffening (β=0.37). A sample with intermediate values of β and τ_{R} shows an intermediate debonding behavior, exhibiting both a weak tack peak and limited strain-stiffening effect.

Brush HMPSAs also bolster their mechanical integrity with the ability to independently tune strength by architecture independent of modulus and strain-stiffening.³⁵ Brush networks with varying n_{bb} were compared to isolate the effect of strength on adhesion. Two densely grafted samples with n_{bb} =900 and n_{bb}=2000 display near identical E₀ and β but a 2-fold increase in cohesive strength. This yields a near identical adhesion response at small deformations via probe tack test while the strength directly increasing strain at break (εₘₐₓ) of cohesive fracture.

The architectural platform for the design of HMPSAs enables hot-melt processing of tapes with programmable viscoelasticity and melting temperature (FIG. 52a). Small quantities of brush HMPSAs varying ϕ_{A} were pressed into a cellulose backing at 140° C. for a short time resulting a 10 μm layer of adhesive. The films were cut and wound around a spool to produce brush HMPSA tapes with different adhesive performance. This is displayed in their ability to uphold various loads through zero-degree shear tests. (FIG. 52b). Additionally, the low viscosity of the brush HMPSA at increased temperatures enables loading of active agents in biomedical adhesives like transdermal drug delivery systems (TDDS) (FIG. 52c). For example, nicotine was added to the brush HMPSA at 120° C. and mixed until homogenously distributed. The sample may then be hot-melt pressed (like in FIG. 52a) or 3D-printed into shapes that are more beneficial to flexibility on the skin of a patient. Nicotine may then diffuse through the skin of the patient like a commercial nicotine patch.

Efforts have been made to ensure accuracy with respect to numbers used (e.g. amounts, temperature, etc.) but some experimental errors and deviations should be accounted for.

One skilled in the art will recognize many methods and materials similar or equivalent to those described herein, which could be used in the practicing the subject matter described herein. The present disclosure is in no way limited to just the methods and materials described.

Unless defined otherwise, technical and scientific terms used herein have the same meaning as commonly understood by one of ordinary skill in the art to which this subject matter belongs, and are consistent with: Singleton et al (1994) Dictionary of Microbiology and Molecular Biology, 2nd Ed., J. Wiley & Sons, New York, NY; and Janeway, C., Travers, P., Walport, M., Shlomchik (2001) Immunobiology, 5th Ed., Garland Publishing, New York.

Throughout this specification and the claims, the words “comprise,” “comprises,” and “comprising” are used in a non-exclusive sense, except where the context requires otherwise. It is understood that embodiments described herein include “consisting of” and/or “consisting essentially of” embodiments.

As used herein, the term “about,” when referring to a value is meant to encompass variations of, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

1. A hybrid brush-like graft copolymer, or hybrid brush-like graft copolymer, single-molecule composition thereof, wherein the hybrid brush-like graft copolymer has an: 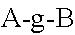
architecture, the hybrid brush-like graft copolymer comprising:
a B block that is a residue of a first macromonomer;
an A block that is a residue of a second macromonomer that is different than the first macromonomer;
a g spacer; and,
a backbone which is a polymer or copolymer;
wherein the A block and the B block are selected to programmably predetermine the viscoelastic properties of the copolymer.

2. The hybrid brush-like graft copolymer, or hybrid brush-like graft copolymer, single molecule composition thereof of claim 1, wherein the hybrid brush-like graft copolymer self-assembles due to microphase separation.

3. The hybrid brush-like graft copolymer, or hybrid brush-like graft copolymer, single molecule composition thereof of claim 2, wherein the microphase separation forms physically distinct domains of linear polymer blocks dispersed within a matrix of the brush-like polymer blocks.

4. The hybrid brush-like graft copolymer, or hybrid brush-like graft copolymer, single molecule composition thereof of claim 1, wherein the B block controls mechanical properties, and the A block controls phase separation properties.

5-7. (canceled)

8. The hybrid brush-like graft copolymer, or hybrid brush-like graft copolymer, single molecule composition thereof of claim 1, wherein the viscoelastic properties are defined as one or more architectural parameters selected from the group consisting of

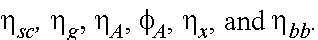

9. The hybrid brush-like graft copolymer, or hybrid brush-like graft copolymer, single molecule composition thereof of claim 1, wherein the adhesion property of the hybrid brush-like graft copolymer, single molecule composition is programmably determined through one of more of n_{sc}, n_{g}, and nₓ.

10. The hybrid brush-like graft copolymer, or hybrid brush-like graft copolymer, single molecule composition thereof of claim 1, wherein the firmness and cohesive strength of the hybrid brush-like graft copolymer, single molecule composition is programmably determined through one of more of n_{bb}, n_{A}, and ϕ_{A}.

11. The hybrid brush-like graft copolymer, or hybrid brush-like graft copolymer, single molecule composition thereof of claim 1, wherein the backbone is a polymer of acrylate, methacrylate, styrene or copolymers thereof.

12. The hybrid brush-like graft copolymer, or hybrid brush-like graft copolymer, single molecule composition thereof of claim 1, wherein the g spacer is a residue of acrylate, methacrylate, styrene or glycol.

13-14. (canceled)

15. The hybrid brush-like graft copolymer, or hybrid brush-like graft copolymer, single molecule composition thereof of claim 1, wherein the g spacer is an acrylate/methacrylate copolymer.

16. The hybrid brush-like graft copolymer, or hybrid brush-like graft copolymer, single molecule composition thereof of claim 1, wherein the first macromonomer is selected from the group consisting of residues of polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, poly(lactide-co-glycolide), polyacrylonitriles, polylactones, polycaprolactams, polyoxazolines, poly(propylene fumarate), polynorbornenes, and polycarbonates and copolymers thereof.

17. The hybrid brush-like graft copolymer, or hybrid brush-like graft copolymer, single molecule composition thereof of claim 16, wherein the first macromonomer is functionalized with aldehyde, isocyanate, amine, diene, dienophile, epoxide, cyanoacrylate, thiol, catechol, oligonucleotide, hydrogen bond donor/acceptor group, alkyne, alkoxy, azide, vinyl, acrylate, methacrylate, carboxylic acid, alkoxy, oxime, acetoxy, amide, urea, guaiacol, furan or hydroxyl moieties.

18-20. (canceled)

21. The hybrid brush-like graft copolymer, or hybrid brush-like graft copolymer, single molecule composition thereof of any one of claim 1, wherein the second macromonomer is selected from the group consisting of residues of, polyacrylates, methacrylates, polyolefins, polysiloxanes, polyesters, polyethers, polyureas, polyurethanes, polystyrene, polytetrafluoroethylene, polychlorotrifluoroethylene, polyvinyl chloride, polyethylene glycol, polylactides, polyglycolides, polylactides, poly(lactide-co-glycolide), polyacrylonitriles, polylactones, polylactams such as polycaprolactams, polyoxazolines, poly(propylene fumarate), polynorbornenes, and polycarbonates including any potential copolymers of the aforementioned chemistries; or is selected from the group consisting of vinyl polymers (e.g., polystyrene, poly(vinyl acetate), poly(acrylo nitrile), and poly(vinyl alcohol)), alkyl acrylate derivatives, alkyl methacrylate derivatives (e.g., poly(methyl methacrylate) and poly(benzyl methacrylate)), ether acrylate derivatives, ether methacrylate derivatives (e.g., poly(oligo (ethylene glycol) monomethyl ether methacrylate), olefin acrylate derivatives, olefin methacrylate derivatives, and olefin norbomene derivatives, and copolymers thereof.

22. (canceled)

23. The hybrid brush-like graft copolymer, or hybrid brush-like graft copolymer, single molecule composition thereof of claim 1, wherein the first macromonomer is selected from the group consisting of residues of polyacrylates, polyolefins and polysiloxanes.

24. (canceled)

25. The hybrid brush-like graft copolymer, or hybrid brush-like graft copolymer, single molecule composition thereof of any one of claim 1, wherein the second macromonomer is selected from the group consisting of residues of polystyrene, PMMA, PLA and PVC.

26. The hybrid brush-like graft copolymer, or hybrid brush-like graft copolymer, single molecule composition thereof of any one of claim 1, wherein the hybrid brush-like graft copolymer is selected from the group consisting of poly[MMA-g-(PDMS/PMMA)], poly[MMA-g-(PnBA/PMMA)], poly[MMA-g-(PIB/PMMA)], poly[MMA-g-(PDMS/PS)], poly[MMA-g-(PnBA/PS)], poly[MMA-g-(PIB/PS)], poly[nBA-ran-MMA-g-(PDMS/PS)], poly[nBA-ran-MMA-g-(PnBA/PS)], poly[nBA-ran-MMA-g-(PIB/PS)], poly[nBA-ran-MMA-g-(PDMS/PMMA)], poly[nBA-ran-MMA-g-(PnBA/PMMA)] poly[nBA-ran-MMA-g-(PIB/PMMA)], poly[MMA-g-(PDMS/PLA)], poly[MMA-g-(PnBA/PLA)], poly[MMA-g-(PIB/PLA)], poly[MMA-g-(PDMS/PLGA)], poly[MMA-g-(PnBA/PLGA)], poly[MMA-g-(PIB/PLGA)], poly[MMA-g-(PDMS/PCL)], poly[MMA-g-(PnBA/PCL)], and poly[MMA-g-(PIB/PCL)].

27. The hybrid brush-like graft copolymer, or hybrid brush-like graft copolymer, single molecule composition thereof of any one of claim 1, wherein the composition has been formed as a pressure sensitive adhesive; or, wherein the composition has been formed for pressure sensitive adhesive formulations.

28-29. (canceled)

30. The hybrid brush-like graft copolymer, or hybrid brush-like graft copolymer, single molecule composition thereof of claim 1, wherein the composition is in the form of a three-dimensional shape that has been molded.

31. (canceled)

32. The hybrid brush-like graft copolymer, or hybrid brush-like graft copolymer, single molecule composition thereof of claim 1, wherein the composition is essentially free of solvents.

33. The hybrid brush-like graft copolymer, or hybrid brush-like graft copolymer, single molecule composition thereof of any one of claim 1, wherein the composition is essentially non-leachable.

34. The hybrid brush-like graft copolymer, or hybrid brush-like graft copolymer, single molecule composition thereof of any one of claim 1, wherein the composition does not comprise additional additive components.

35-38. (canceled)

39. A method of programmably predetermining the viscoelastic properties of a hybrid brush-like graft copolymer, the method comprising:
i. preparing a mixture comprising a B block first macromonomer and an A block second macromonomer, wherein the first and second macromonomer are different from each other;
and,
ii. subjecting the mixture to polymerization selected from the group consisting of free radical polymerization (FRP), atom transfer radical polymerization (ATRP), SARA ATRP, anionic polymerization, and reversible addition-fragmentation chain-transfer polymerization (RAFT), ring opening polymerization, ring opening metathesis polymerization, metallocene polymerization, and coordination polymerization,
wherein, a hybrid brush-like copolymer having an 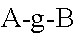
architecture and programmably predetermined viscoelastic properties is prepared.

40-51. (canceled)
